(19) United States
(12) Patent Application Publication
(10) Pub. No.: US 2013/0179142 A1
(43) Pub. Date: Jul. 11, 2013

(54) DISTRIBUTED PARALLEL SIMULATION METHOD AND RECORDING MEDIUM FOR STORING THE METHOD

(71) Applicants: Samsung Electronics Co., Ltd., Suwon-si (KR); PUSAN NATIONAL UNIVERSITY INDUSTRY- UNIVERSITY COOPERATION FOUNDATION, Geumjeong-gu (KR)

(72) Inventors: Nam Do Kim, Yongin-si (KR); Sei Yang Yang, Busan (KR)

(73) Assignees: PUSAN NATIONAL UNIVERSITY INDUSTRY- UNIVERSITY COOPERATION FOUNDATION, Gumjeong-gu (KR); Samsung Electronics co., Ltd., Suwon-si (KR)

(21) Appl. No.: 13/736,588

(22) Filed: Jan. 8, 2013

(30) Foreign Application Priority Data
Jan. 9, 2012 (KR) 1020120002259

(51) Int. Cl. G06F 17/50

(52) U.S. Cl. CPC G06F 17/5036
USPC 703/14

(57) ABSTRACT

Provided is a distributed parallel simulation method. In the method, a plurality of local simulations is executed in parallel for a plurality of local design objects, respectively. The local design objects are included in a model at a specific abstraction level and are spatially distributed. At least one actual output is generated using at least one of the local design objects in a current local simulation of the plurality of local simulations. At least one expected output and the at least one actual output in the current local simulation are compared. Values of the at least one actual output and position information of the values from the current local simulation are transmitted to at least one remaining local simulation of the plurality of local simulations in response to a determination from the comparison that a difference exists between the at least one expected output and the at least one actual output.

### CROSS-REFERENCE TO RELATED APPLICATION

This application claims priority under 35 U.S.C. §119(a) from Korean Patent Application No. 10-2012-0002259 filed on Jan. 9, 2012, the disclosure of which is hereby incorporated by reference in its entirety.

### FIELD OF THE INVENTION

Embodiments of the inventive concept relate to a communication method in a distributed parallel simulation, and more particularly, to a method of systematically verifying design from an electronic system level (ESL) to a gate level using a simulation and an apparatus for performing the method.

### BACKGROUND

Semiconductor design verification simulation includes a process of building a computer-executable model including a design under verification (DUV) or at least one design object within the DUV and test bench (TB), which drives the design object in software, translating the computer-executable model into a sequence of machine instructions of a through a simulation compilation process, and executing the sequence on the computer. Therefore, a simulation is carried out by the sequential execution of machine instructions of a computer.

There are many simulation techniques such as event-driven simulation, cycle-based simulation, compiled simulation, interpreted simulation, and co-simulation. In view of this, simulation represents a variety of processes in which an object to be designed or manifested is executed in software on a computer at a proper abstraction level through a modeling process to imitatively realize the operational functions or operational characteristics of the object. There are many abstraction levels in semiconductor design such as a gate-level (GL), register transfer level (RTL), transaction level, architecture level, behavioral level, algorithm level, and so on.

The advantage of simulation is that the operational functions or characteristics of a design object can be virtually evaluate before the design object is physically implemented and that high flexibility is provided due to the software nature of the simulation. However, since the simulation is carried out by the sequential execution of machine instructions, simulation speed is very slow when the complexity of the design object is large like a semiconductor device such as an application processor of a smart phone, which can include 100 million gates or more. For instance, when an event-driven simulation of a design including 100 million gates is executed at a speed of 1 cycle/sec for a gate, it is estimated to take 3.2 years, or more, to simulate a 100 million gate design for 100 million cycles.

### SUMMARY

According to some embodiments of the inventive concept, there is provided a distributed parallel simulation method. In the method, a plurality of local simulations is executed in parallel for a plurality of local design objects, respectively. The local design objects are included in a model at a specific abstraction level and are spatially distributed. At least one actual output is generated using at least one of the local design objects in a current local simulation of the plurality of local simulations. At least one expected output and the at least one actual output in the current local simulation are compared. Values of the at least one actual output and position information of the values from the current local simulation are transmitted to at least one remaining local simulation of the plurality of local simulations in response to a determination from the comparison that a difference exists between the at least one expected output and the at least one actual output.

In an embodiment, the method further comprising performing the local simulations by a plurality of design verification apparatuses, respectively, connected to each other through a network.

In an embodiment, each of the design verification apparatuses includes at least one of a computer, central processing unit core, and a processor.

In an embodiment, the method further comprises generating one or more inputs from the expected inputs, the values, and the position information of the values; and executing the at least one remaining local simulation using the one or more inputs.

In an embodiment, generating the at least one actual output comprises generating the at least one actual output based on expected inputs used in a run-with-expected input/output mode or actual inputs used in a run-with-actual input/output mode.

In an embodiment, the method further comprises switching the current local simulation to the run-with-actual input/output mode using the actual inputs in response to the difference being determined while the current local simulation is executed in the run-with-expected input/output mode using the expected inputs.

In an embodiment, the method further comprises rolling back the current local simulation to a specific rollback time in response to the specific rollback time for rollback being received.

In an embodiment, detecting a number of matches between the expected inputs and the actual inputs while the current local simulation executes in the run-with-actual input/output mode using the actual inputs; and switching the current local simulation to the run-with-expected input/output mode using the expected inputs based on a result generated in response to detecting the number of matches.

In an embodiment, the method further comprises transmitting a current simulation time for rollback from the current local simulation to the at least one remaining local simulation among the plurality of local simulations in response to a mismatch between the expected outputs and the actual outputs.

In an embodiment, a non-transitory computer readable recording medium for recording a computer program is provided for executing the distributed parallel simulation method.

According to some embodiments of the inventive concept, there is provided a distributed parallel simulation method. A plurality of local simulations is executed in parallel for a plurality of local design objects, respectively. The local design objects are included in a model at a specific abstraction level and are spatially distributed. A first output generated at a first simulation time in a current local simulation of at least one of the local design objects among the plurality of local simulations is saved. The first output is compared with a second output generated at a second simulation time following the first simulation time in the current local simulation. Values of the second output and position information of the values from the current local simulation are transmitted to at least one remaining local simulation among the plurality of local simulations in response to a determination of a mismatch between the first output and the second output.

In an embodiment, the local simulations are performed by a plurality of design verification apparatuses, respectively, connected to each other through a network.

In an embodiment, the method further comprises generating an input required at the second simulation time using an input generated at the first simulation time, the values and the position information of the value in the at least one remaining local simulation; and executing the at least one remaining local simulation using the input generated for the second simulation time.

In an embodiment, a non-transitory computer readable recording medium is provided for recording a computer program for executing the distributed parallel simulation method.

According to some embodiments of the inventive concept, there is provided a distributed parallel simulation method. An actual output is generated using a local design object in a current local simulation of a plurality of local simulations. An expected output is compared with the actual output. A mismatch is determined between the actual output and the expected output. One or more values of the actual output and position information of the one or more values are transmitted from the current local simulation to a remaining local simulation of the plurality of local simulations in response to the determination of the mismatch.

In an embodiment, the local design object is included in a model at a specific abstraction level.

In an embodiment, the method further comprises performing the local simulations by a plurality of design verification apparatuses connected to each other through a network.

In an embodiment, the method further comprises generating one or more inputs from at least one of the expected input, the one or more values, and the position information of the one or more values; and executing the remaining local simulation using the one or more inputs.

In an embodiment, generating the actual output comprises generating the actual output based on expected inputs used in a run-with-expected input/output mode or actual inputs used in a run-with-actual input/output mode.

In an embodiment, the method further comprises detecting a number of matches between the expected input and the actual input while the current local simulation executes in a run-with-actual input/output mode using the actual input; and switching the current local simulation to a run-with-expected input/output mode using the expected input based on a result generated in response to detecting the number of matches.

### BRIEF DESCRIPTION OF THE DRAWINGS

The inventive concept will become more apparent in view of the attached drawings and accompanying detailed description.

FIG. 1 is a block diagram of a design verification apparatus according to some embodiments of the inventive concept;

FIG. 2 is a block diagram of a design verification apparatus according to other embodiments of the inventive concept;

FIG. 3A is a block diagram of a design verification apparatus according to other embodiments of the inventive concept;

FIG. 3B is a block diagram of a design verification apparatus according to other embodiments of the inventive concept;

FIG. 4A is a block diagram of a design verification apparatus according to other embodiments of the inventive concept;

FIG. 4B is a block diagram of a design verification apparatus according to still other embodiments of the inventive concept;

FIG. 5 is a conceptual diagram of the hierarchy of an electronic system level (ESL) model and its corresponding hierarchy of a register transfer level (RTL) model;

FIG. 6 is a conceptual diagram of the hierarchy of an RTL model and its corresponding hierarchy of a gate level (GL) model;

FIG. 7 is a conceptual diagram of a computer network including a plurality of computers that can execute a distributed parallel simulation according to some embodiments of the inventive concept;

FIGS. 8A and 8B are conceptual diagrams of an example in which a temporal design check point (t-DCP) is obtained in a front-end simulation using a model at a high abstraction level and a rear-end simulation using a model at a low abstraction level is carried out by time-sliced parallel execution;

FIGS. 9A and 9B are conceptual diagrams of an example in which a spatial design check point (s-DCP) is obtained in a front-end simulation using a model of a high abstraction level and a rear-end simulation using a model of a low abstraction level carried out by distributed-processing-based parallel execution;

FIG. 10 is a conceptual diagram of components included in an extra code added for a distributed-processing-based parallel simulation according to some embodiments of the inventive concept;

FIG. 11 is a timing chart of signal-level cycle-accurate data and transaction-level data at a register transfer level (RTL);

FIGS. 12A through 12C are schematic diagrams of design objects in the ESL model shown in FIG. 5, design objects in the RTL model shown in FIG. 5, and mixed design objects at a medium abstraction level;

FIGS. 13A through 13F are conceptual diagrams for illustrating a method of generating mixed design objects at the medium level of abstraction by replacing each of the design objects in the ESL model shown in FIG. 12A with a corresponding one of the design objects in the RTL model shown in FIG. 12B;

FIGS. 14A and 14B are conceptual diagrams that illustrate an embodiment in which six mixed simulations of six respective mixed design objects shown in FIGS. 13A through 13F are independently executed in parallel and a time-sliced parallel simulation of the RTL model is executed as a back-end simulation using state information collected at least one simulation time or period during the independent parallel simulation;

FIG. 15 is a conceptual diagram of the design process and the verification process which proceed through progressive refinement from the initial level of abstraction to the final level of abstraction according to some embodiments of the inventive concept;

FIG. 16 is a conceptual diagram of a method of generating a GL model from a transaction level model via an RTL model using a progressive refinement process according to some embodiments of the inventive concept;

FIG. 17 is a conceptual diagram of a method of executing a distributed-processing-based parallel simulation or time-sliced parallel simulation of a model of a lower abstraction level using an s-DCP or a t-DCP in a progressive refinement process in which verification using a transaction-level cycle-accurate model, verification using an RTL model and verification using a GL model are performed sequentially;

FIGS. 18A and 18B are conceptual diagrams for explaining a combined method of distributed-processing-based parallel execution and singular execution;

FIG. 19 is a conceptual diagram of an example of reducing the synchronization and communication overhead between a simulator and a hardware-based verification platform by carrying out a simulation with simulation acceleration using distributed-processing-based parallel execution according to some embodiments of the inventive concept;

FIG. 20 is a diagram of the logical topology of a network of a plurality of local computers for a simulation using distributed-processing-based parallel execution according to some embodiments of the inventive concept;

FIG. 21 is a diagram of the logical topology of a network of a plurality of local computers for a simulation using distributed-processing-based parallel execution according to other embodiments of the inventive concept;

FIG. 22 is a diagram of the logical topology of a network of a plurality of local computers for a simulation using distributed-processing-based parallel execution according to further embodiments of the inventive concept;

FIG. 23 is a conceptual diagram of a distributed parallel simulation environment in which a distributed parallel simulation is executed using a simulator installed in each of a plurality of computers according to some embodiments of the inventive concept;

FIG. 24A is a flowchart of a method for distributed parallel simulation according to some embodiments of the inventive concept;

FIG. 24B is a flowchart of a method for distributed-processing-based parallel simulation according to some embodiments of the inventive concept;

FIGS. 25A and 25B are flowcharts of a local simulation executed in a local simulator for executing a distributed-processing-based parallel simulation according to some embodiments of the inventive concept;

FIGS. 26A and 26B are flowcharts of a local simulation executed by a local simulator for executing a distributed-processing-based parallel simulation according to other embodiments of the inventive concept;

FIGS. 27A and 27B are flowcharts of a local simulation executed by a local simulator in star topology according to some embodiments of the inventive concept;

FIGS. 28A and 28B are flowcharts of a local simulation executed by a local simulator in star topology according to other embodiments of the inventive concept;

FIG. 29 is a conceptual diagram of components included in an extra code added for a distributed-processing-based parallel simulation according to other embodiments of the inventive concept; and

FIG. 30 is a flowchart of a method for distributed-processing-based parallel simulation according to other embodiments of the inventive concept.

### DETAILED DESCRIPTION OF THE EMBODIMENTS

The inventive concept will now be described more fully hereinafter with reference to the accompanying drawings, in which exemplary embodiments of the inventive concept are shown. The advantages and features of the inventive concept and methods of achieving them will be apparent from the following exemplary embodiments that will be described in more detail with reference to the accompanying drawings. It should be noted, however, that the inventive concept is not limited to the following exemplary embodiments, and may be implemented in various forms. Accordingly, the exemplary embodiments are provided only to disclose the inventive concept and let those skilled in the art know the category of the inventive concept. In the drawings, embodiments of the inventive concept are not limited to the specific examples provided herein and are exaggerated for clarity.

The terminology used herein is for the purpose of describing particular embodiments only and is not intended to limit the invention. As used herein, the singular terms “a,” “an” and “the” are intended to include the plural forms as well, unless the context clearly indicates otherwise. As used herein, the term “and/or” includes any and all combinations of one or more of the associated listed items. It will be understood that when an element is referred to as being “connected” or “coupled” to another element, it may be directly connected or coupled to the other element or intervening elements may be present.

Similarly, it will be understood that when an element such as a layer, region or substrate is referred to as being “on” another element, it can be directly on the other element or intervening elements may be present. In contrast, the term “directly” means that there are no intervening elements. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

Additionally, the embodiment in the detailed description will be described with sectional views as ideal exemplary views of the inventive concept. Accordingly, shapes of the exemplary views may be modified according to manufacturing techniques and/or allowable errors. Therefore, the embodiments of the inventive concept are not limited to the specific shape illustrated in the exemplary views, but may include other shapes that may be created according to manufacturing processes. Areas exemplified in the drawings have general properties, and are used to illustrate specific shapes of elements. Thus, this should not be construed as limited to the scope of the inventive concept.

It will be also understood that although the terms first, second, third etc. may be used herein to describe various elements, these elements should not be limited by these terms. These terms are only used to distinguish one element from another element. Thus, a first element in some embodiments could be termed a second element in other embodiments without departing from the teachings of the present invention. Exemplary embodiments of aspects of the present inventive concept explained and illustrated herein include their complementary counterparts. The same reference numerals or the same reference designators denote the same elements throughout the specification.

Moreover, exemplary embodiments are described herein with reference to cross-sectional illustrations and/or plane illustrations that are idealized exemplary illustrations. Accordingly, variations from the shapes of the illustrations as a result, for example, of manufacturing techniques and/or tolerances, are to be expected. Thus, exemplary embodiments should not be construed as limited to the shapes of regions illustrated herein but are to include deviations in shapes that result, for example, from manufacturing. For example, an etching region illustrated as a rectangle will, typically, have rounded or curved features. Thus, the regions illustrated in the figures are schematic in nature and their shapes are not intended to illustrate the actual shape of a region of a device and are not intended to limit the scope of example embodiments.

Hereinafter, a simulation can refer to any method of modeling a design under verification (DUV) or at least one design object within the DUV in software at a proper abstraction level and executing the modeled design object in software.

In detail, a simulation can be defined as a process of implementing the behavior of the DUV or the at least one design object within the DUV at a specific abstraction level in a specific computer data structure and its operations, making the behavior into a computer-executable form, operating the behavior in a computer with values input to the computer-executable form and performing a series of computations or processes on the input values.

Therefore, a simulation carried out by a commercial simulator may be considered as the simulation. Also, a simulation carried out by a simulator fabricated in accordance with the above definition may be defined as the simulation. Even a software process virtually carried out in a computer using modeling through the same process as the above-described simulation process may be considered as a simulation.

With the rapid development of integrated circuit (IC) design and semiconductor processing techniques, digital circuit design or digital system design has been scaled to accommodate several tens of millions of gates, or several hundreds of millions of gates, or more, resulting in a corresponding increase in complexity of the design.

System-level ICs, a so called system-on-chip (SoC), typically includes one or more embedded processor cores, e.g., reduced instruction set computer (RISC) cores or digital signal processing (DSP) cores. A large part of its functionality is typically realized in software.

The reduction of design time is very critical to the success of related electronic products since products of superior quality need to be developed in a short time due to the growing competition in a market. Therefore, there is a growing interest in electronic system level (ESL) design methodologies for designing semiconductor chips. For semiconductor chips that are designed using an ESL design methodology, which is at a higher abstraction level than a register transfer level (RTL) design methodology used in traditional digital hardware design, software that drives the semiconductor chips as well as the semiconductor chip design needs to be developed.

Therefore, a recent trend of simultaneously proceeding hardware design and software development includes the offering a virtual platform (VP), which is a software model for hardware is built that is used as a system level model, e.g., ESL model, for architecture exploration, software development, hardware/software co-verification, and/or system verification. The VP can be also used as an executable specification, i.e., a reference model.

Since the VP is built at the higher abstraction level, it can be built in a reduced timeframe. Also, when the VP for an implementable DUV is built before the DUV is designed, a table bench (TB) can be verified using the VP before the existence of the DUV. The VP can therefore play a critical role in platform-based design (PBD), which is widely adopted in SoC design.

The VP has as a core component a bus model, referred to as a transaction level model (TLM) when it is made at a transaction level, which is made by modeling an on-chip bus at a transaction level according to a predetermined bus protocol, to model design blocks connected to the on-chip bus at the transaction level, so that the design blocks at the transaction level can communicate with the bus model according to an abstract bus protocol. As a result, the VP enables a simulation to be executed at relatively higher simulation speed, for example, about 100 to 10,000 times faster than the RTL model.

In a SoC design, it is most important that the VP has a sufficient execution speed to develop software, and therefore, the VP is modeled not at the RTL using Verilog, Inc. or VHSIC hardware description language (VHDL) but at a higher abstraction level such as a transaction level or an algorithmic level using a language such as C, C++, SystemC, or the like.

The abstraction level, which is a very important concept in system design, is the level that represents the degree of detail in the description of a design object.

Digital systems can be classified into a layout-level, transistor-level, gate-level (GL), RTL, transaction-level, algorithmic-level, etc., from the low level of abstraction to the high level of abstraction. In other words, a GL is at a lower abstraction level than an RTL, an RTL is at a lower abstraction level than a transaction-level, and a transaction-level is at a lower abstraction than an algorithmic-level.

Accordingly, when the abstraction level of a specific design object A is transaction-level and the abstraction level of a design object B, which is the more refined description or representation of the design object A, is RTL, then the design object A can be at the higher level of abstraction than the design object B.

When a design object X includes design objects A and C and a design object Y includes a design object B refined from the design object A and the design object C, the design object X can be at a higher level of abstraction than the design object Y. Moreover, the accuracy of a delay model may determine the abstraction level at the same GL or RTL. In other words, the more accurate the delay model, the lower the abstraction level.

For instance, it is defined that the netlist of a zero-delay model is at a higher abstraction level than the netlist of a unit-delay model, and the netlist of the unit-delay model is at a higher abstraction level than the netlist of a full-timing model using a standard delay format (SDF), even though the netlists are at the same GL.

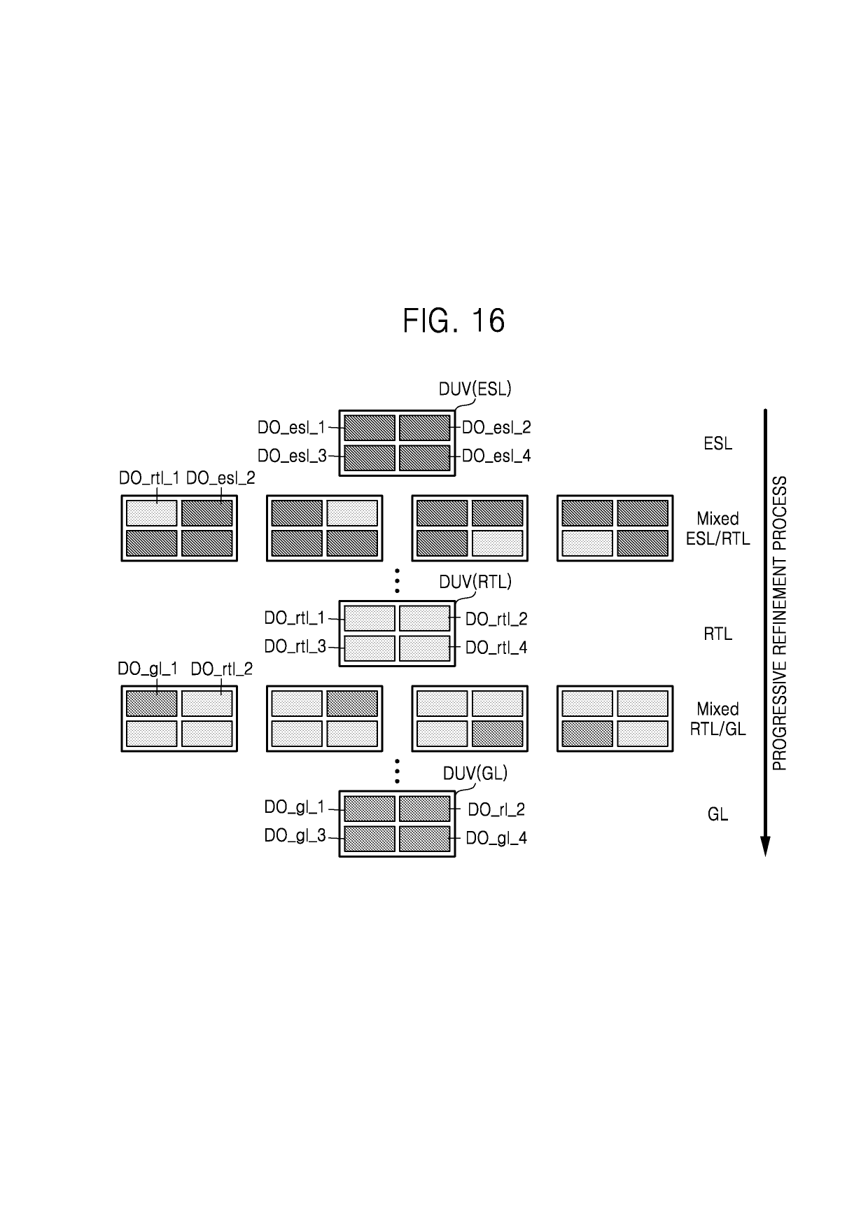

SoC design can include a procedure for defining an object, which is eventually implemented as a chip, as an initial design object and the initial design object is refined from the initial abstraction level, e.g., the transaction-level, to the final abstraction level, e.g., the GL, through a progressive refinement process, shown for example at FIG. 16.

Design methodology using the progressive refinement process is the only design methodology that can efficiently cope with the recent design complexity of SoC apart from platform-based design methodology. SoC design is usually carried out using the progressive refinement process.

The core of design methodology using the progressive refinement process may be to progressively refine design blocks existing inside a design object MODEL_DUV(HIGH) modeled at a high abstraction level so that a design object MODEL_DUV(LOW) modeled at a lower abstraction level than the design object MODEL_DUV(HIGH) is obtained automatically, for example, through logic synthesis or high-level synthesis, and/or obtained manually.

For instance, in the refinement process from ESL to RTL in which an implementable RTL model is obtained from an ESL model, the ESL model is MODEL_DUV(HIGH) and the implementable RTL model is MODEL_DUV(LOW). This process can be carried out by manual labor, high-level synthesis, or a combination thereof. In the refinement process of RTL to GL in which a GL model, i.e., GLnetlist, is obtained from an implementable RTL model, the RTL model is MODEL_DUV(HIGH) and the GL model is MODEL_DUV(LOW). This process can be carried out by logic synthesis.

The GL model with the back-annotation of delay information, referred to as SDF, extracted in a placement and routing process can become a timing-accurate GL model. Unless otherwise defined, the term “model” can refer to both DUV and TB.

It is not necessary that all design objects in the ESL model beat the system level. It is not necessary that all design objects in the RTL model be at the RTL. For instance, even when some of the design objects in the ESL model are at the RTL, it is possible that they are treated as the ESL model if they are surrounded by an abstraction wrapper to be at an agreeable abstraction level with other design objects at the system level.

Also, even when some of the design objects in the RTL model are at the GL, it is possible that they are treated as the RTL like other design objects existing at the RTL.

Moreover, in a GL model some design objects, e.g., memory block which does not produce a GL netlist by logic synthesis, can exist at the RTL.

Therefore, in accordance with the inventive concept, “a model at a specific abstraction level” may refer to a model at any one of various abstraction levels that can exist in a progressive refinement process from ESL to GL. The various abstraction levels include not only ESL, RTL, and GL but also any mixed levels of abstraction such as a mixed level of ESL and RTL, a mixed level of RTL and GL, and/or a mixed level of ESL, RTL and GL.

Also, the “abstraction level” includes not only ESL, RTL, and GL but also any mixed levels of abstraction such as a mixed level of ESL and RTL, a mixed level of RTL and GL, and/or a mixed level of ESL, RTL and GL.

For instance, when DUV includes four design objects A, B, C, and D as sub modules, the design objects A and B are at the ESL, the design object C is at the RTL, and the design object D is at the GL. The DUV can serve as a model at the mixed level of ESL, RTL and GL, but can be referred to as a model at a specific abstraction level. Moreover, the DUV may be specified as a model at a mixed abstraction level of ESL/RTL/GL. Hereinafter, a model at a mixed level of abstraction will be referred to as a “mixed high/low abstraction level model” or “mixed abstraction level model” when it must be clearly mentioned that the model is represented at the mixed level of abstraction.

The term “transaction,” which is the important concept in the ESL, can correspond to a signal or pin in the RTL. Information in the signal or pin can be expressed as a bit or bit vector. A transaction can refer to information that represents logically related multiple signals or pins in a single unit. A transaction can be transmitted using a function call.

For instance, when signals of a total of (N+M+P) bits including N bits of an address signal, M bits of a data signal, and P bits of a control signal are made into logically related N-bit address bus, M-bit data bus and P-bit control bus in a design including a processor module and a memory module; each cycle can be expressed as an interpretable symbol, such as a read address and its corresponding data, a write address and its corresponding data, a read-wait address and its corresponding data, or a write-wait address and its corresponding data, instead of a binary vector, which includes an (N+M+P)-bit vector and is very hard to interpret, which is referred to as a transaction.

A transaction may be defined cycle-by-cycle. This type of transaction will be referred to as cycle-accurate transaction and can be shortened to “ca-transaction”, or over multiple cycles. This type of transaction will be referred to as a timed transaction, cycle-count transaction, or PV-T transaction, and generally, timed-transaction in short.

A timed-transaction defined over multiple cycles may be represented by Transaction_name(start_time, end_time, other_attributes). Also, a transaction may include a transaction without the concept of time. This type of transaction will be referred to as “untimed-transaction” in short. Although there is no standard definition about the term transaction, it can be classified into untimed-transaction, timed-transaction, and ca-transaction.

An untimed-transaction is at the highest level of abstraction but is the least accurate in timing, aca-transaction is at the lowest level of abstraction but is the most accurate in timing, and a timed-transaction is between in terms of abstraction level and time accuracy. The refinement process is progressive so that design objects at a transaction level in a VP are progressively transformed through refinement into design objects at an RTL with at least bit-level cycle accuracy.

At the end of the transformation, all design objects at the transaction level in the VP are translated into design objects at the RTL. As a result, the transaction-level VP is translated into an implementable RTL model. In addition, the design objects at the RTL in the implementable RTL model are progressively transformed into design objects at the GL with habit-level timing accuracy, or better. At the end of the transformation, design objects at the RTL are translated into design objects at the GL, and therefore, the RTL model is translated into a GL model.

FIG. 16 is a conceptual diagram of a method of generating a GL model from a transaction-level model via an RTL model using a progressive refinement process according to some embodiments of the inventive concept. Referring to FIG. 16, when a transaction-level model DUV(ESL) includes as lower blocks four design objects DO_esl_1, DO_esl_2, DO_esl_3, and DO_esl_4 at a transaction level, the four transaction-level design objects DO_esl_1, DO_esl_2, DO_esl_3, and DO_esl_4 are progressively and replaced with RTL design objects DO_rtl_1, DO_rtl_2, DO_rtl_3, and DO_rtl_4, respectively, through a mixed ESL/RTL. The transaction-level model DUV(ESL) is translated into an RTL model DUV(RTL) including only the RTL design objects DO_rtl_1, DO_rtl_2, DO_rtl_3, and DO_rtl_4 in the progressive refinement process.

In addition, the four RTL design objects DO_rtl_1, DO_rtl_2, DO_rtl_3, and DO_rtl_4 exist as lower blocks in the RTL model DUV(RTL) and are progressively and respectively replaced with GL design objects DO_gl_1, DO_gl_2, DO_gl_3, and DO_gl_4 through a mixed level of RTL/GL and the RTL model DUV(RTL) is translated into a GL model DUV(GL) including only the GL design objects DO_gl_1, DO_gl_2, DO_gl_3, and DO_gl_4 in the progressive refinement process.

There are two objects to be designed in a SoC design. The first is a DUV. The second is a TB for the simulation of the DUV. The DUV is the design entity that is eventually manufactured as a semiconductor chip through semiconductor manufacturing processes. The TB is a model of an environment in which the semiconductor chip is mounted and operated and is used to simulate the DUV.

During the simulation of the DUV, the TB provides inputs to the DUV and receives and processes outputs from the DUV. DUV and TB have a hierarchical structure including at least one lower module. The lower module is a design block which includes at least one design module. The design module includes at least one submodule.

In accordance with the inventive concept, any design blocks, design modules, submodules, DUV, TB, combinations thereof, and some parts thereof, and combinations of the parts can be referred to as a “design object”. Examples of a design object can include but not be limited to a module provided by Verilog, Inc. an entity in VHDL, and a sc_module in SystemC.

Accordingly, a VP may be a design object. A part of the VP, at least one design block in the VP, part of the design block, a design module in the design block, part of the design module, a submodule in the design module, and/or part of the submodule may alternatively be provided. In other words, a DUV, part of a DUV, a TB, and/or part of a TB can be defined as a design object.

In a design process using conventional progressive refinement, verification at the high abstraction level can be performed quickly, but verification at the low abstraction level is relatively slow. Therefore, verification speed dramatically decreases as the progressive refinement process goes down to the lower level of abstraction.

Embodiments of the inventive concept are provided to solve this problem and the inventive concept will be described in detail by explaining the embodiments.

In contrast to the conventional single simulation, there is a distributed parallel simulation method using two or more simulators to increase the verification speed.

In accordance with the inventive concept, the single simulation is defined to include not only a case using one simulator but also a case using two or more simulators, e.g., using one Verilog simulator and one Vera simulator, and running these simulators on a single central processing unit (CPU).

Examples of a simulator include hardware description language (HDL) simulators, such as NC-Verilog/Verilog-XL and X-sim from Cadence, VCS from Synopsys, ModelSim from Mentor, Riviera/Active-HDL from Aldec, FinSim from Fintronic, etc., hardware verification language (HVL) simulators such as e simulator from Cadence Design Systems, Vera simulator from Synopsys, etc., and system description language (SDL) simulators such as a SystemC simulator, Incisive simulator from Cadence Design Systems, and so on.

In another classification, event-driven simulators and cycle-based simulators can be provided. A simulator in accordance with the inventive concept may include any of the above-described simulators. Accordingly, when two or more simulators are used, each of the simulators can include but not be limited to any of the simulators mentioned above. Accordingly, embodiments of the inventive concept are not limited to the simulators herein, i.e., other simulators not referred to herein can be included.

Distributed parallel simulation in which a simulation is performed using distributed processing is also called parallel distributed simulation or parallel simulation. Hereinafter, the term “distributed parallel simulation” will be used. According to some embodiments of the inventive concept, distributed parallel simulation is a technique in which DUV and/or TB, i.e., a model at a specific abstraction level, is partitioned into at least two design objects and each of the design objects is distributed into and executed in a simulator.

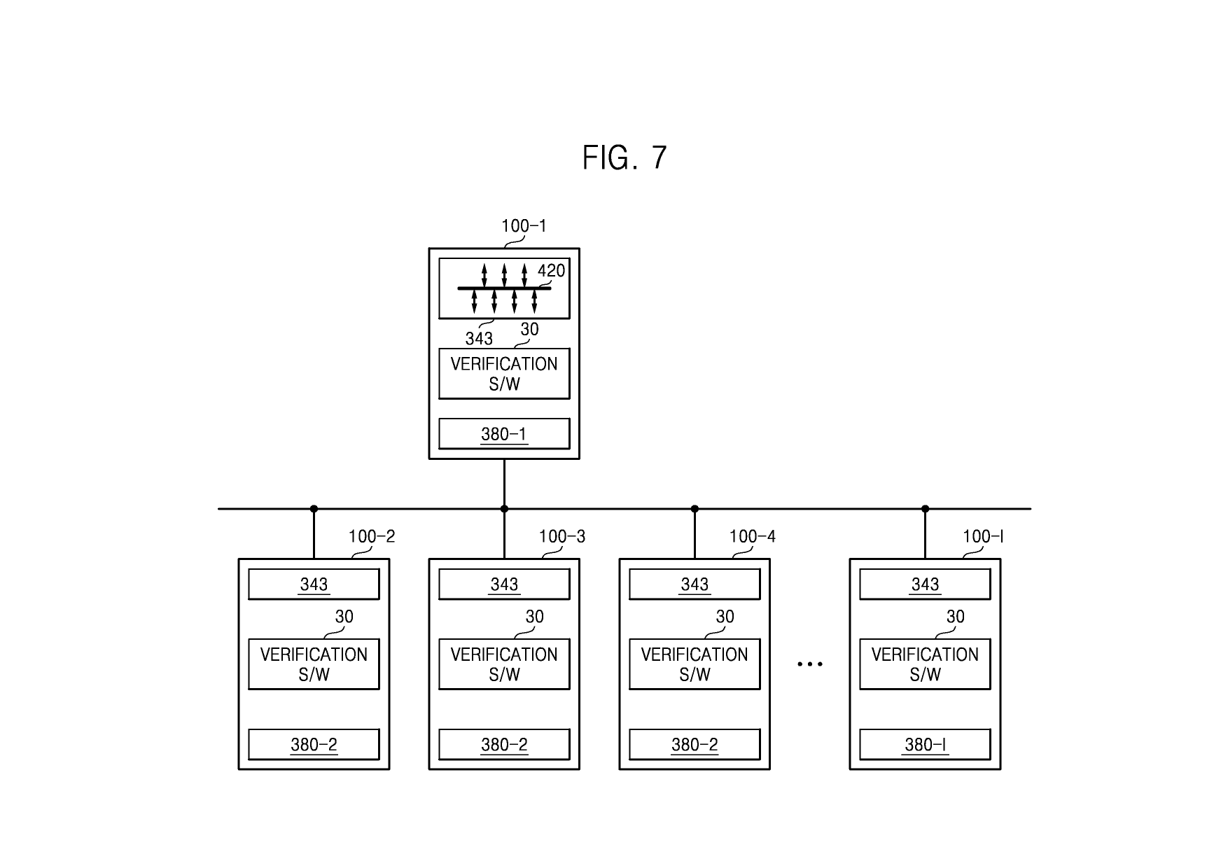

FIG. 7 is a conceptual diagram of a computer network including a plurality of computers that can execute a distributed parallel simulation according to some embodiments of the inventive concept. Referring to FIG. 7, the distributed parallel simulation may be carried out in parallel in a plurality of computers 100-1 through 100-I where “I” is a natural number.

Verification software (S/W) 30 according to some embodiments of the inventive concept, a simulator 343 executing a local simulation in a distributed parallel simulation environment, and a specific design object 380-1 (e.g., a specific design object in an RTL model) are executed at the first computer 100-1. A simulation of an on-chip bus design object 420 including a bus arbiter and an address decoder in a specific model, e.g., an RTL model, is executed in the simulator 343. The other computers 100-2 through 100-I can each run a verification S/W 30, and a simulator 343. A specific design object 380-2 through 380-I is executed on a corresponding one of the computers 100-2 through 1004.

For convenience' sake in the description, the verification S/W 30 is installed in each of the computers 100-2 through 100-I in the embodiments illustrated in FIG. 7. However, the verification S/W 30 may not installed in the computers 100-2 through 100-I apart from the first computer 100-1. In this case, the specific design objects 380-2 through 380-I respectively loaded to the computers 100-2 through 1004 may be sequentially verified by the verification S/W 30 which is running in the first computer 100-1. Whether the verification S/W 30 is installed in each of the computers 100-1 through 100-I may be changed in various ways.

The distributed parallel simulation requires the partitioning process in which a simulation model is divided into at least two design objects. In accordance with the inventive concept, the design object that needs to be executed in a specific local simulation through the partition is referred to as a “local design object”.

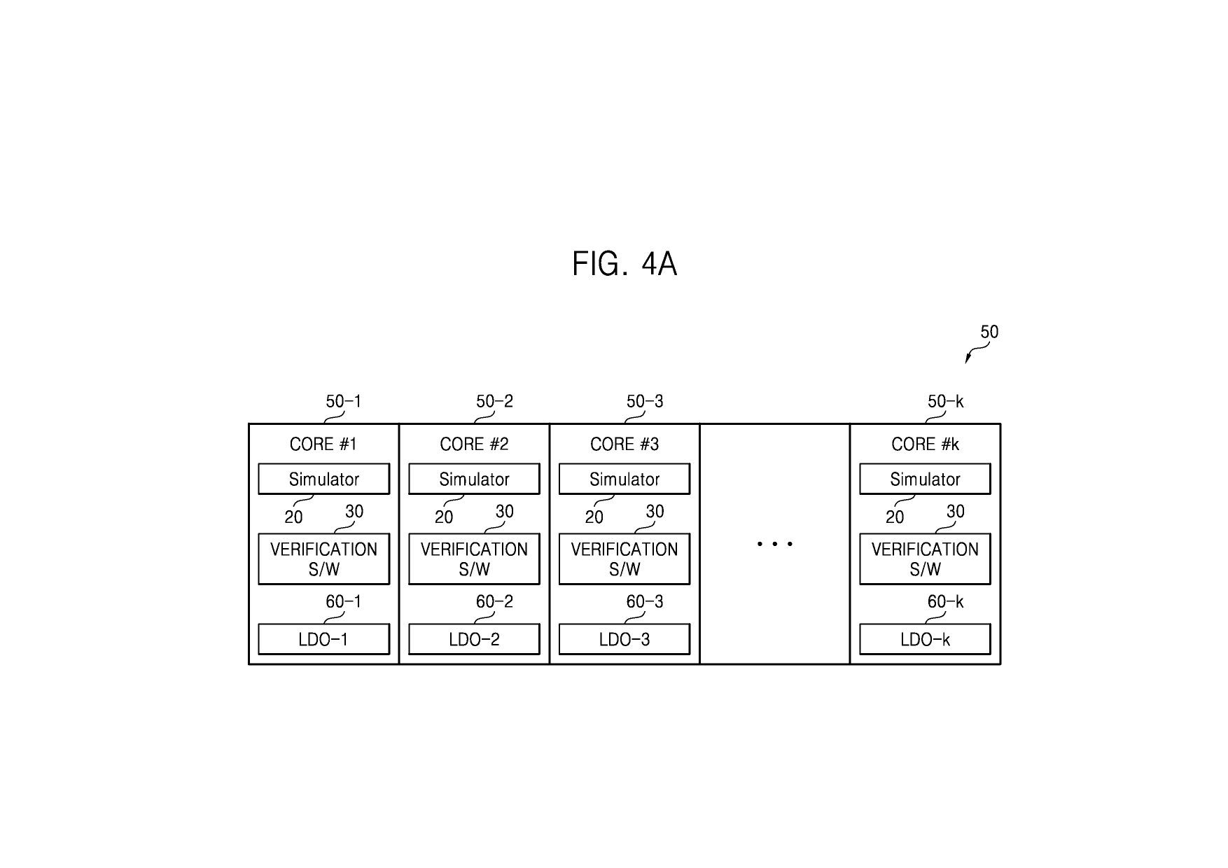

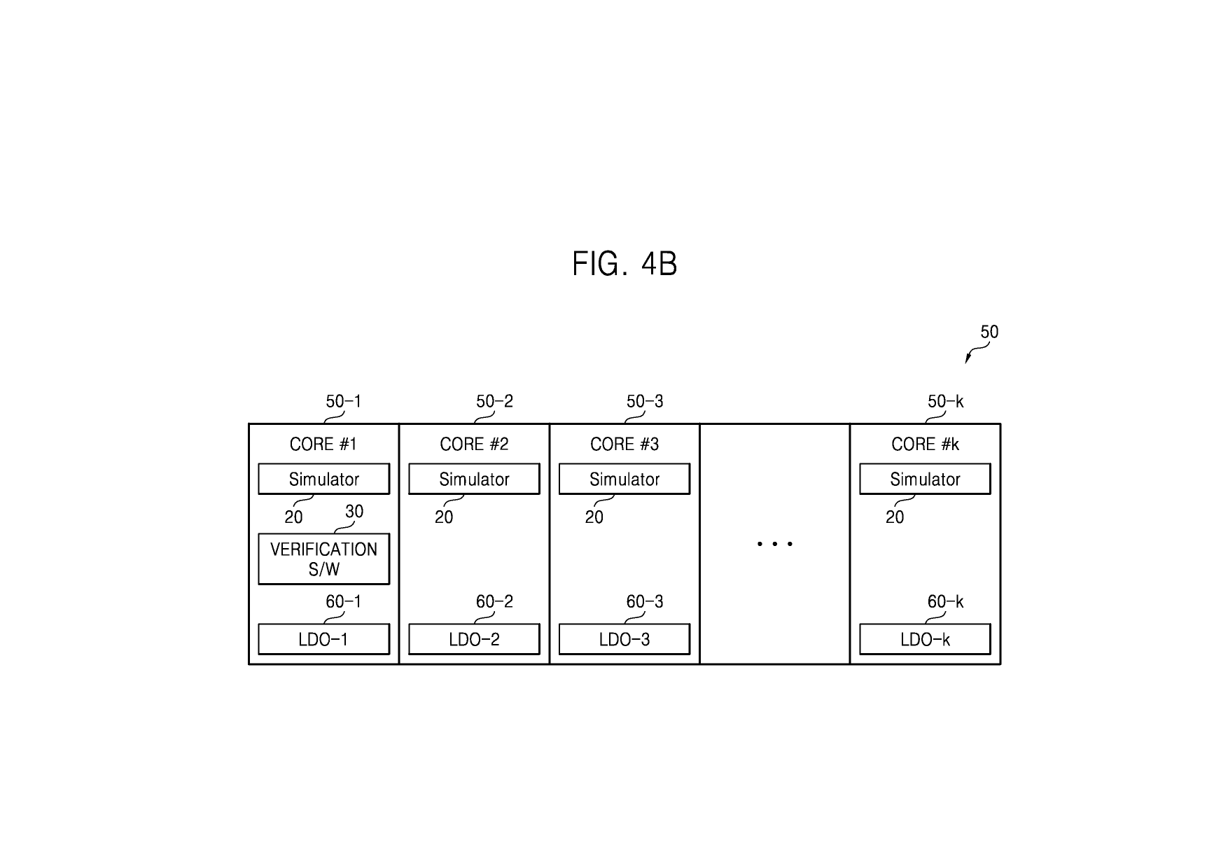

Distributed parallel simulation can be carried out by connecting at least two computers with a high-speed computer network, for example, gigabit (Gb) Ethernet and running a simulator on each computer, or by running a simulator in each CPU core or processor of a multi-core or multi-processor computer having at least two CPU cores, illustrated for example at least at FIGS. 4A and 4B.

In accordance with the inventive concept, simulation executed by each of at least two simulators that enables the distributed parallel simulation can be referred to as a “local” simulation. For instance, Pentium quad-core chip and AMD quad-core chip, which include four processor cores, can construct a multi-core computer using the processor cores. Also, a multi-processor computer can be constructed by installing multiple CPU chips at one or more system board.

However, improvement in the performance of conventional distributed parallel simulation is limited due to communication overhead and synchronization overhead among simulators. Embodiments according to the inventive concept can solve such problems associated with conventional distributed parallel simulation.

In distributed parallel simulation, communication is a process of transferring a change in a logic value, which occurs during the execution of simulation in the interconnection, i.e., that already exists in design, among local design objects allocated to respective local simulators through the partition, to other local simulations at specific simulation time.

For instance, let's assume a distributed parallel simulation for design in which 128-bit outputs A[127:0] and B[127:0] exist in a design object X, a 128-bit input C[127:0] exists in a design object Y, a 128-bit input D[127:0] exists in a design object Z, the output A[127:0] and the input C[127:0] are connected with each other, and output B[127:0] and the input D[127:0] are connected with each other. It is also assumed that three local design objects for respective first through third local simulations are defined as the design object X for a first local simulation, the design object Y for a second local simulation, and the design object Z for a third local simulation, respectively, through a partition occurring before the execution of the simulation. In response to the distributed parallel simulation being executed under these conditions, communication from the first local simulation to the second local simulation may be required to transfer a logic value change in the connection between the output A[127:0] and the input C[127:0] from the design object X to the design object Y. Also, communication from the first local simulation to the third local simulation may be required to transfer a logic value change in the connection between the output B[127:0] and the input D[127:0] from the design object X to the design object Z.

Therefore, it can be inferred that communication among local simulations frequently occurs throughout the execution of the distributed parallel simulation. It can be concluded that the frequent communication is a main cause of hindrance with respect to the improvement in the performance of the distributed parallel simulation.

During the execution of distributed parallel simulation each local simulation retains its own local simulation time. In distributed parallel simulation, “synchronization” is a process required to prevent incorrect simulation results from being caused by the disagreement of simulation time between local simulations during the execution of the simulation. There are two basic methods for synchronization used in the distributed parallel simulation. The first can be referred to as a conservative (or pessimistic) method. The second can be referred to as an optimistic method.

Conservative synchronization guarantees that the causality relation among simulation events is retained among local simulators, so that rollback is not needed. However, conservative synchronization is limited in that the speed of distributed parallel simulation is dictated by the slowest local simulation and there is excessive synchronization.

Optimistic synchronization temporally allows the violation of the causality relation among simulation events and requires rollback to correct it. Accordingly, the reduction of the number of rollbacks is critical to the performance of the distributed parallel simulation. However, in conventional distributed parallel simulation using optimistic synchronization, the start point of each local simulation executed without synchronization with other local simulations is not specially considered to minimize the number of rollbacks. Accordingly, simulation performance can degrade significantly due to excessive rollbacks.

Distributed parallel simulation using a conventional optimistic approach and/or a conventional pessimistic approach is well-known to those of ordinary skill in the art, and is disclosed in many documents and papers. Thus, detailed descriptions thereof will be omitted for brevity.

It is desirable to have the same number of processors in distributed parallel simulation as the number of local simulations to maximize the simulation performance. However, as long as there are at least two processors available, i.e., at least two computers are connected with a network or a multi-processor computer includes at least two processors, even though there are more than two local simulations, it is still possible to perform a distributed parallel simulation by configuring one processor to execute two or more local simulations.

In summary, the synchronization and communication methods for both an optimistic approach and a pessimistic approach have critical problems greatly limiting the performance of distributed parallel simulation using two or more simulators. Therefore, embodiments of the inventive concept are provided to solve these problems.

In the embodiments of the inventive concept, ESL-to-GL design, in which an implementable RTL model is obtained from a transaction-level model, e.g., an ESL model, at a system level through a progressive refinement process and a GL model, i.e., a GL netlist representing a connection structure of cells in specific implementation library with which the placement and routing process can be carried out, can be obtained from the implementable RTL model through the progressive refinement process, and can be described as a two-step process.

The first step includes refining the RTL model from the ESL model and is referred to as an ESL-to-RTL design. The second step includes refining the GL model from the RTL model and is referred to as an RTL-to-GL design. Also, various models existing at different abstraction levels in the progressive refinement process can be referred to as “equivalent models at different abstraction levels”.

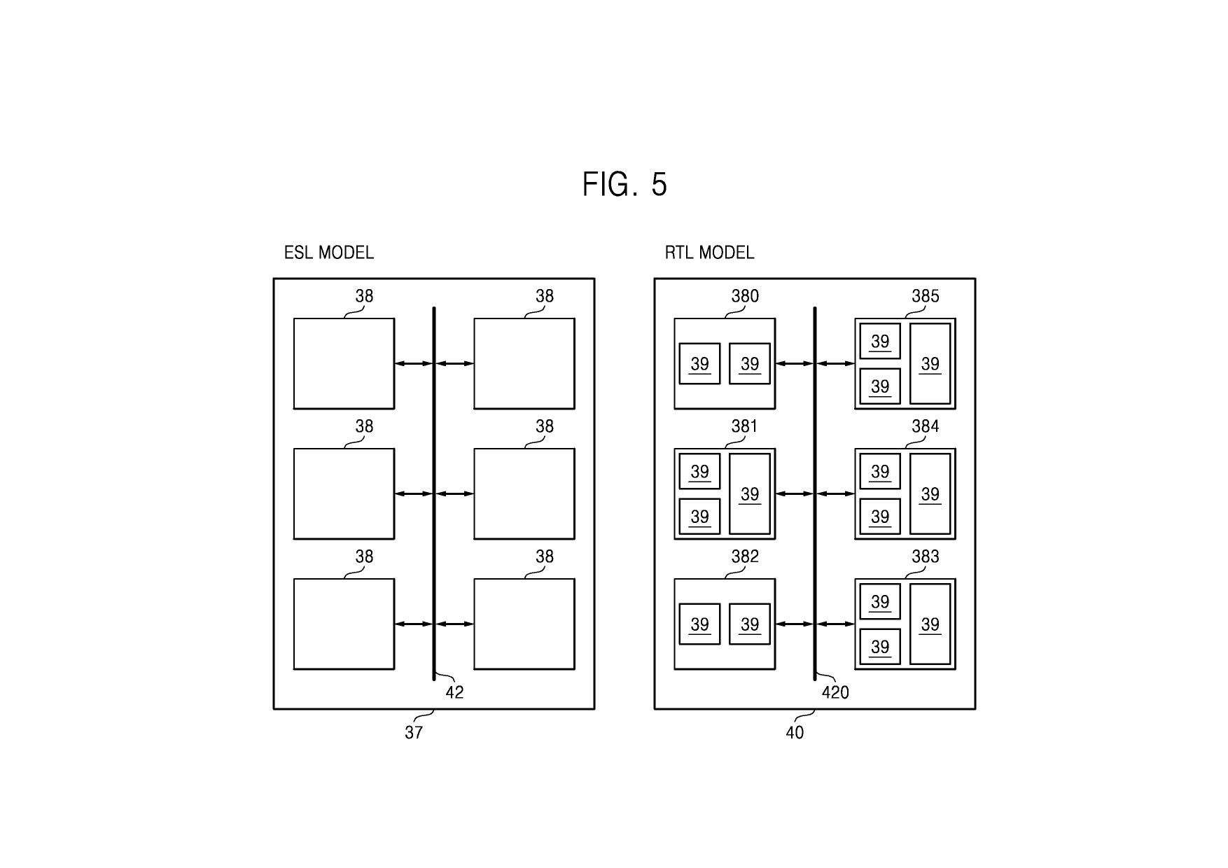

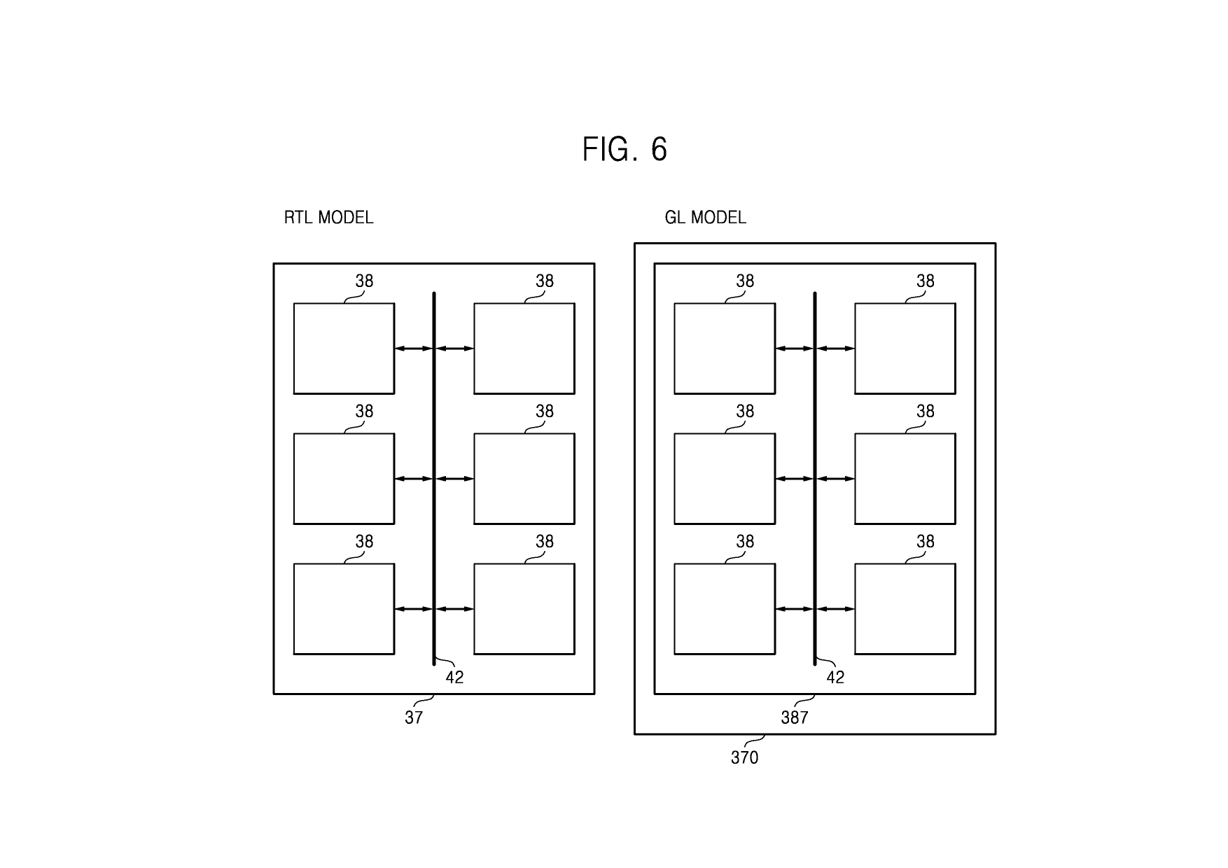

It is important to have the same or a similar hierarchical structure between a model at the high abstraction level, MODEL_DUV(HIGH), and a model at the low abstraction level, MODEL_DUV(LOW) in the refinement process, illustrated for example at FIGS. 5 and 6. In SoC design, since the complexity of DUV, at which a design object is very high, models at different abstraction levels naturally have the same or a similar hierarchical structure from the highest hierarchy to the lowest hierarchy.

When models at the highest level through a predetermined level have the same or a similar hierarchical structure, there are corresponding design objects among the models having at least one design object at different abstraction levels. This situation exists between an ESL model and an RTL model and between an RTL model and a GL model that does not violate the hierarchical structure.

The hierarchical structure of the GL model may become different from that of the RTL model due to the insertion of a boundary scan structure or manual design at the GL. However, even in this situation, the hierarchical structure is not changed dramatically and the GL model and the RTL model have very similar hierarchical structure, so that a design object at a high abstraction level and a corresponding design object at a low abstraction level can be found in these hierarchical structures.

Even when the hierarchical structure of the GL model is not preserved during logic synthesis, since the name of a design object, i.e., an instance name, in the GL model has information about a corresponding design object in the RTL model, the design object at a high abstraction level and the corresponding design object at a low abstraction level can be found. Accordingly, in accordance with embodiments of the inventive concept, it is presumed that models at different abstraction levels preserve the same or similar hierarchical structure to a certain extent from the top level to a certain level in the hierarchical structure or that a design object in a model at a high abstraction level can be matched with a design object in a model at a low abstraction level, which can be referred to as “partial hierarchy matching relation”.

For instance, when there are four design blocks B(1)_tlm, B(2)_tlm, B(3)_tlm, and B(4)_tlm in a TLM DUV(TLM), and an RTL model DUV(RTL) is designed from the TLM DUV(TLM) through a progressive refinement process, four design blocks B(1)_rtl, B(2)_rtl, B(3)_rtl, and B(4)_reliant exist in the RTL model DUV(RTL). Here, the design blocks B(1)_tlm, B(2)_tlm, B(3)_tlm, and B(4)_tlm correspond to the design blocks B(1)_rtl, B(2)_rtl, B(3)_rtl, and B(4)_rtl, respectively.

In another instance, when there are four design blocks B(1)_rtl, B(2)_rtl, B(3)_rtl, and B(4)_rtl in an RTL model DUV(RTL), a GL model DUV(GL) is designed from the RTL model DUV(RTL) through a progressive refinement process, and the GL model has a hierarchical structure of B(0)_gl, B(1)_gl, B(2)_gl, B(3)_gl, and B(4)_gl with the insertion of a boundary scan cell; B(1)_gl, B(2)_gl, B(3)_gl, and B(4)_gl correspond to B(1)_rtl, B(2)_rtl, B(3)_rtl, and B(4)_rtl, respectively. Accordingly, in a design using a progressive refinement process, at least one design object in a model at a high abstraction level is translated into a design object in a model at a low abstraction level.

In a SoC design, a RISC processor core, DSP processor core, memory block, MPEG decoder block, JPEG decoder block, MP3 decoder block, Ethernet core, PCI-X core, DMA controller block, and memory controller block can be provided as examples of a design object, and are design blocks that can execute very complicated functions. Therefore, many designers participate in a process of refining design objects within a DUV and work in parallel. In this case, time taken for the refinement of a design object varies' with a designer's performance and experience and the difficulty of the design object.

This refinement process may be carried out manually with a great dependence one designer know-how or automatically using a high-level synthesis tool, e.g., Cynthesizer from Forte Design or Catapult C from Mentor Graphic, or a logic synthesis tool, e.g., Design Compiler from Synopsys or Synplify from Synplicity.

At the final stage of the refinement process, it is necessary to verify whether a specific design object has been correctly refined. In order to effectively verify the correct refinement of a specific design object B(i)_refined in a state where other design objects have not been refined yet, a design object B(i)_abst corresponding to the specific design object B(i)_refined existing in a model at a high abstraction level, MODEL_DUV(HIGH), can be replaced with the design object B(i)_refined to make a model at a mixed abstraction level, MODEL_DUV(MIXED). Subsequently, a result of executing the model MODEL_DUV(MIXED) is compared with a result of executing the model MODEL_DUV(HIGH).

For instance, let's assume that design objects B(1)_tlm, B(2)_tlm, B(3)_tlm, and B(4)_μm in a TLM DUV_TLM are refined in parallel by designers or design objects B(4)_rtl, B(3)_rtl, B(2)_rtl, and B(1)_rtl are sequentially refined in order. Here, “tlm” indicates that a design object is modeled at a transaction level and “rtl” indicates that a design object is modeled at an RTL.

First, as soon as the design object B(4)_rtl is completed, designers charged for the refinement of B(4) can verify whether B(4)_rtl has been correctly refined by constructing MODEL_DUV(MIXED)_4=(B(1)_tlm, B(2)_tlm, B(3)_tlm, B(4)_rtl), executing, i.e., simulating it, and comparing the simulation result with a result of simulating MODEL_DUV(HIGH)=(B(1)_tlm, B(2)_tlm, B(3)_tlm, B(4)_tlm).

In the same manner, as soon as the remaining design objects B(3)_tlm, B(2)_tlm, and B(1)_tlm are completed, MODEL_DUV(MIXED)_3=(B(1)_tlm, B(2)_tlm, B(3)_rtl, B(4)_tlm), MODEL_DUV(MIXED)_2=(B(1) tlm, B(2)_rtl, B(3)_tlm, B(4)_μm), and MODEL_DUV(MIXED)_1=(B(1)_rtl, B(2)_tlm, B(3)_tlm, B(4) tlm) are constructed. It can be verified whether the design objects B(3)_tlm, B(2)_tlm, and B(1)_μm have been correctly refined.

In another instance, when design objects B(1)_rtl, B(2)_rtl, B(3)_rtl, and B(4)_rtl in an RTL model DUV RTL are refined in parallel by designers or design objects B(4)_gl, B(3)_gl, B(2)_gl, and B(1)_gl are sequentially refined in order where “gl” denotes GL. As soon as the design object B(4)_gl is completed, designers or others responsible for the refinement of B(4) can verify whether B(4)_gl has been correctly refined by constructing and executing MODEL_DUV(MIXED)_4=(B(1)_rtl, B(2)_rtl, B(3)_rtl, B(4)_gl) and by comparing the execution result with a result of executing MODEL_DUV(HIGH)=(B(1)_rtl, B(2)_rtl, B(3)_rtl, B(4)_rtl).

In the same manner, as soon as the remaining design objects B(3)_gl, B(2)_gl, and B(1)_gl are completed, MODEL_DUV(MIXED)_3=(B(1)_rtl, B(2)_rtl, B(3)_gl, B(4)_rtl), MODEL_DUV(MIXED)_2=(B(1)_rtl, B(2)_gl, B(3)_rtl, B(4)_rtl), and MODEL_DUV(MIXED)_1=(B(1)_gl, B(2)_rtl, B(3)_rtl, B(4)_rtl) are constructed and it can be verified whether the design objects B(3)_gl, B(2)_gl, and B(1)_gl have been correctly refined.

Since the abstraction level of an input/output port of a refined design object B(i)_refined is different from that of an un-refined design objects B(k)_abst in a model MODEL_DUV(MIXED), an additional interface may be necessary for the connection between B(i)_refined and B(k)_abst. For instance, in refinement from ESL to RTL, transactors may be required because the port at the ESL is at a transaction-level and the port at the RTL is at a cycle level at a pin signal level.

The transactors may be different depending on the degree of abstraction of the transaction at the ESL. For instance, when a transaction at the ESL is cycle accurate, a very simple transactor may be used. When the transaction is a timed-transaction, a relatively complex transactor may be used. In a refinement process from RTL to GL, an extra interface is not necessary because the input/output port at the RTL and the input/output port at the GL are the same at a pin signal level.

When the verification at the GL is to verify the timing, a timing adjustor may be needed to generate signals with correct timing at the port interface. Delay values used in the timing adjustor can be obtained by analyzing SDF or delay parameters in library cells, performing a very short GL timing simulation using SDF or a static timing analysis, or by using a combination thereof.

As described above, a refinement step can be performed in which a model at a medium abstraction level, MODEL_DUV(MIXED)_i, is constructed by replacing a design object B(i)_abst in a model at a high abstraction level, MODEL_DUV(HIGH), with a refined design object B(i)_refined in a DUV in a progressive refinement process. This is referred to as a “partial refinement” step and such a process is referred to as a “partial refinement process”.

After the partial refinement step, a refinement step, in which all design objects to be refined in the model at high abstraction level, MODEL_DUV(HIGH), are replaced with refined design objects to construct a model at a low abstraction level, MODEL_DUV(LOW), is carried out. There may be a design object that is not to be refined or does not need to be refined and this design object is not refined. This refinement step is referred to as a complete refinement step and this refinement process is referred to as a “complete refinement process”.

In other words, in a refinement from ESL to RTL, a model MODEL_DUV(RTL) is obtained through the complete refinement process. In a refinement from RTL to GL a model MODEL_DUV(GL) is obtained through the complete refinement process.

For instance, all four design objects need to be refined in refinement from ESL to RTL. When a design object B(3)_rtl, for example, a memory module, does not need to be refined in a refinement from RTL to GL, at least one of a MODEL_DUV(RTL)=(B(1)_rtl, B(2)_rtl, B(3)_rtl, B(4)_rtl) and MODEL_DUV(GL)=(B(1)_gl, B(2)_gl, B(3)_gl, B(4)_gl) are constructed through the complete refinement process.

A result of simulating the model at low abstraction level, MODEL_DUV(LOW), finally obtained through the complete refinement process can be compared with a result of simulating the model at high abstraction level, MODEL_DUV(HIGH). In addition, the model can be at a medium abstraction level, MODEL_DUV(MIXED)_i, so that the correctness of design can be verified through the progressive refinement process.

In an embodiment, the verification process is spontaneously carried out in design using the progressive refinement process. Here, verification speed for the model at medium abstraction level, MODEL_DUV(MIXED)_i, is much lower than that for the model at high abstraction level, MODEL_DUV(HIGH), because most of design objects in MODEL_DUV(MIXED)_i are still at the high abstraction level in the partial refinement process and verification speed for the model at low abstraction level, MODEL_DUV(LOW), is much lower than that for MODEL_DUV(HIGH) because all or most of design objects in MODEL_DUV(LOW) are at the abstract low level in the complete refinement process. These factors can significantly hamper an effective verification. For instance, verification of an RTL model refined from an ESL model is 10 to 10,000 times slower than verification of the ESL model. Also, verification of a GL model refined from the RTL model is 100 to 300 times slower than verification of the RTL model.

An object of the inventive concept is to provide a method for solving a problem in which a simulation speed gradually or dramatically decreases as it moves to a low abstraction level in a progressive refinement process. Another object of the inventive concept is to provide a method for increasing the speed of a distributed parallel simulation by effectively reducing synchronization overhead.

When a back-end simulation is carried out in distributed parallel fashion using an expected input and an expected output obtained from a front-end simulation and at least one design object is locally changed due to debugging or specification change in the front-end and the back-end, the abstraction level of a design object simulated in the front-end simulation is different from that of a design object simulated in the back-end simulation. According to some embodiments of the inventive concept, verification S/W and a simulator may be installed in a design verification apparatus.

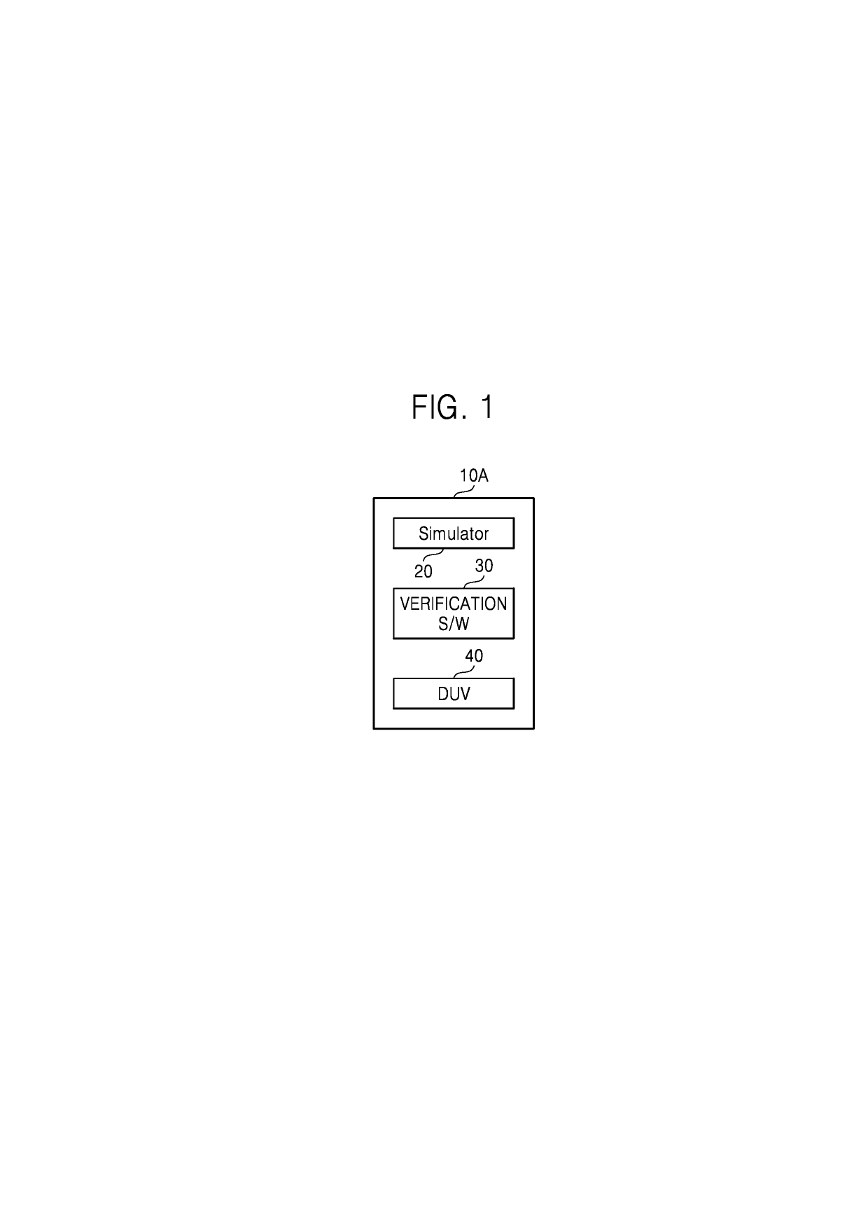

FIG. 1 is a block diagram of a design verification apparatus 10A including S/W according to some embodiments of the inventive concept. Referring to FIG. 1, the design verification apparatus 10A may be a computer, a CPU core, or a processor. The design verification apparatus 10A can include a simulator 20, verification S/W 30, and a DUV 40, some or all of which is stored at a memory device or the like, and executed by the computer, CPU, or processor of the verification apparatus 10A. The simulator 20, the verification S/W 30, and the DUV 40 may be stored in one memory device all together or in different memory devices separately. The simulator 20 may perform design verification on the DUV 40 using the verification S/W 30.

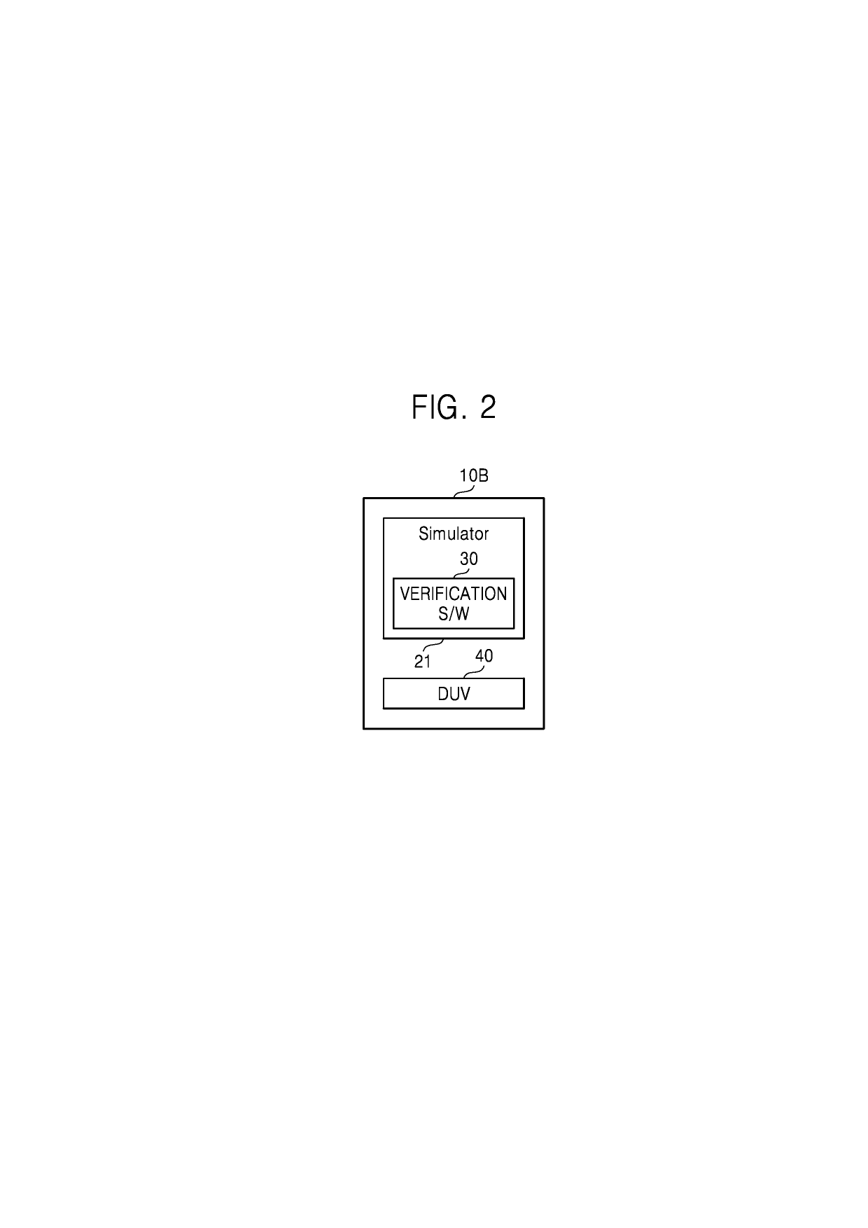

FIG. 2 is a block diagram of a design verification apparatus 10B including S/W according to other embodiments of the inventive concept. Referring to FIGS. 1 and 2, while the simulator 20 and the verification S/W 30 are separately implemented and run in the embodiments illustrated in FIG. 1, the verification S/W 30 can be embedded in a simulator 21. The design verification apparatus 10B may run the simulator 21, the verification S/W 30, and the DUV 40. The simulator 21 may perform design verification on the DUV 40 using the verification S/W 30.

The design verification apparatus 10A or 10B can include, or be in communication with, any type of electronic apparatus that can perform design verification on the DUV 40 using the simulator 20 or 21 and the verification S/W 30.

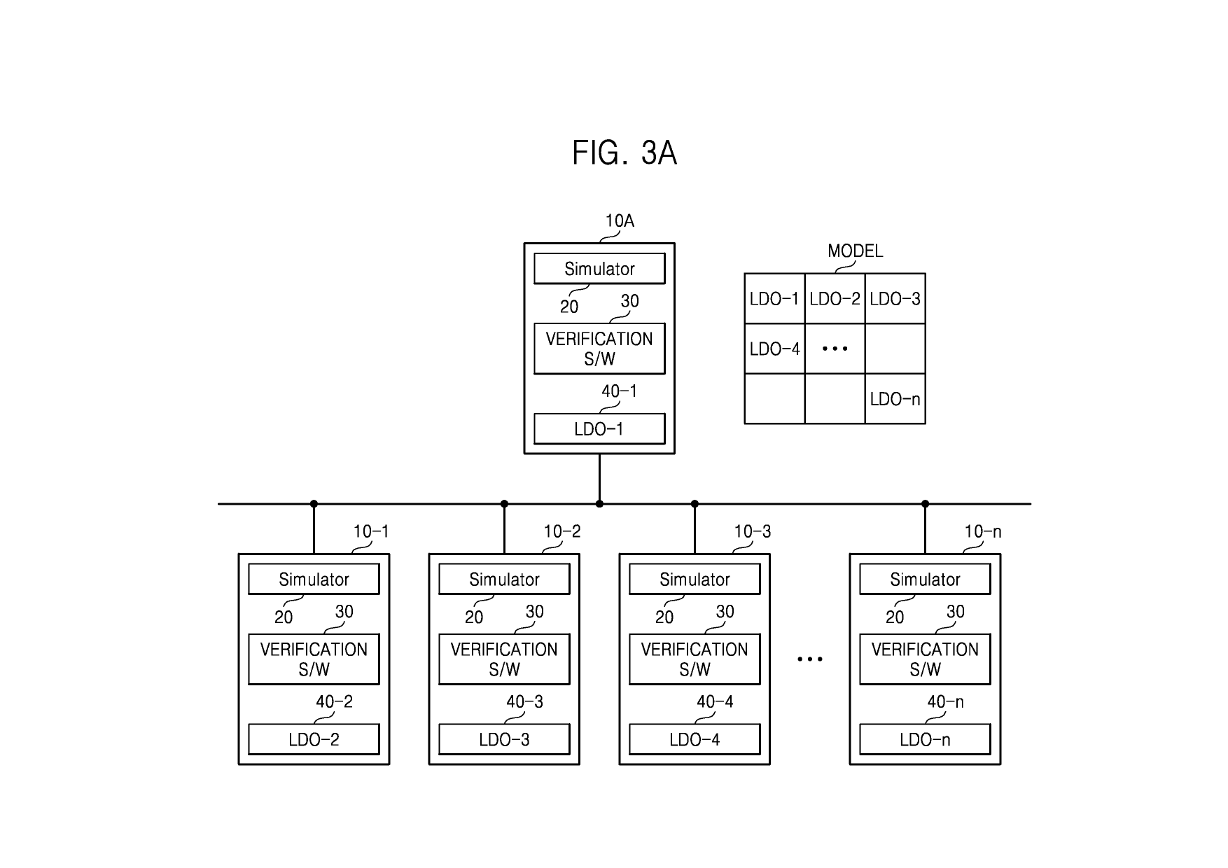

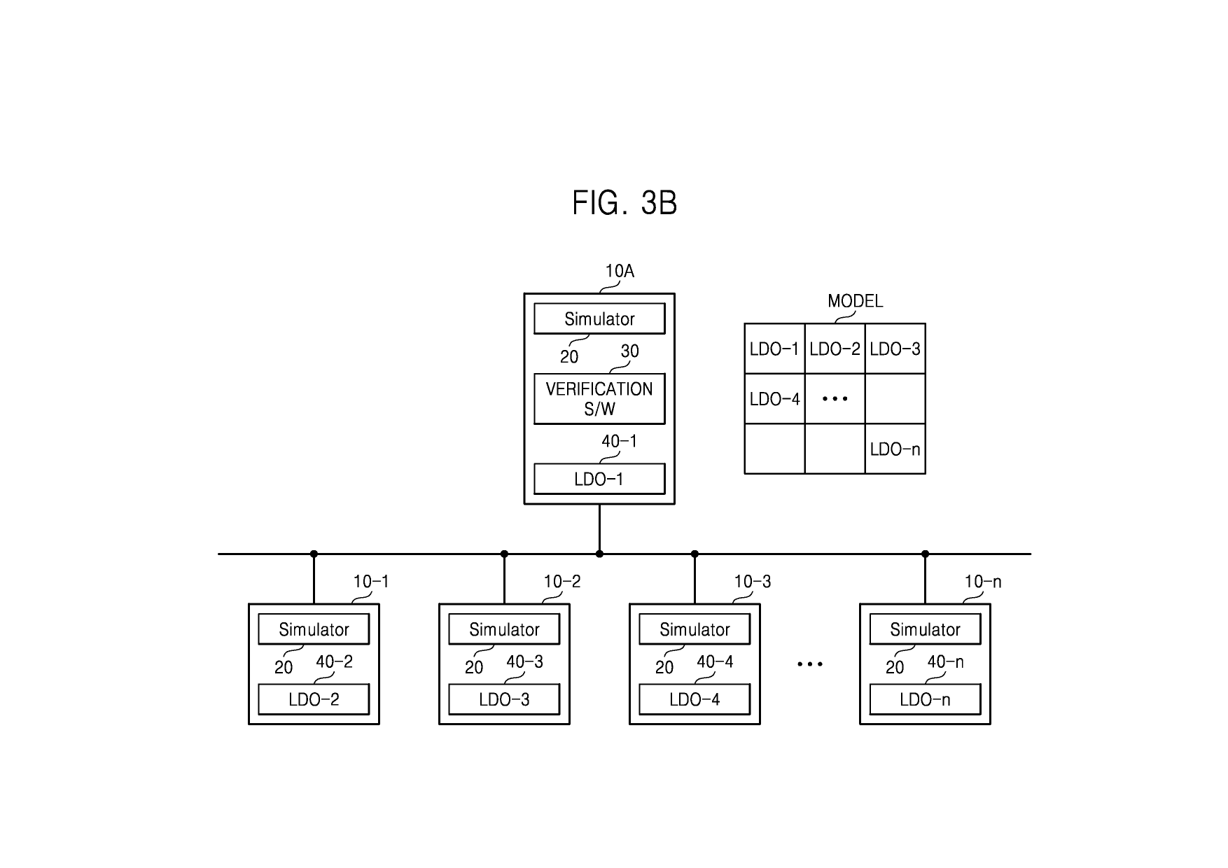

FIG. 3A is a block diagram of a design verification apparatus including S/W according to further embodiments of the inventive concept. Referring to FIG. 3A, design verification apparatuses 10A and 10-1 through 10-n (generally, 10) may perform a distributed parallel simulation or distributed-processing-based parallel simulation through a computer network.

For convenience' sake in the description, it is assumed that the design verification apparatuses 10 may perform design verification on partitioned design objects or local design objects LDO-1 through LDO-n, respectively, using a simulator 20 and the verification S/W 30. A design object MODEL subjected to the distributed parallel simulation or the distributed-processing-based parallel simulation includes the local design objects LDO-1 through LDO-n. As described with reference to FIG. 2, the verification S/W 30 may be embedded in each simulator 20.

FIG. 3B is a block diagram of a design verification apparatus including S/W according to other embodiments of the inventive concept. Compared to the embodiments illustrated in FIG. 3A, the verification S/W 30 is run only in the design verification apparatus 10A, and the design verification apparatuses 10-1 through 10-n sequentially perform design verification on the local design objects LDO-2 through LDO-n, respectively, according to the control of the simulator 20 installed in each of the design verification apparatuses 10-1 through 10-n and the verification S/W 30 installed in the design verification apparatus 10A.

FIGS. 4A and 4B are block diagrams of a design verification apparatus 50 including S/W according to different embodiments of the inventive concept. Referring to FIGS. 4A and 4B, the design verification apparatus 50 includes a plurality of CPU cores, or processors, 50-1 through 50-k. Referring to FIG. 4A, the simulator 20 and the verification S/W 30, which are installed in each of the CPU cores or the processors 50-1 through 50-k may perform design verification on each of local design objects 60-1 through 60-k.

Referring to FIG. 4B, the verification S/W 30 is run only in the CPU core or the processor 50-1. Here, the CPU cores or the processors 50-2 through 50-k sequentially perform design verification on the local design objects LDOs 60-2 through 60-k, respectively, according to the control of the simulator 20 installed in the CPU cores or the processors 50-2 through 50- and the verification S/W 30 installed in the CPU core or the processor 50-1.

According to some embodiments of the inventive concept, design verification may be performed using a single design verification apparatus, at least two design verification apparatuses connected with each other through a network, at least one simulation accelerator connected to a design verification apparatus, or at least one field programmable gate array (FPGA) connected to a design verification apparatus.

The verification S/W 30 is run in a design verification apparatus. When the design verification apparatus includes at least two computers, the at least two computers are connected with each other through a network, e.g., Ethernet or Gb Ethernet, so that they transmit/receive files or data to/from each other. When the design verification apparatus includes at least two CPU cores or processors as illustrated in FIGS. 3A and 3B, they may transmit/receive files or data to/from each other through a bus.

One or more simulators used for design verification may include only event-driven simulators. Parallel simulation using only event-driven simulators can be referred to as parallel discrete event simulation (PDES). Simulators may alternatively include an event-driven simulator and a cycle-based simulator, may include only cycle-based simulators, may include a cycle-based simulator and a transaction-based simulator, may include only transaction-based simulator, may include an event-driven simulator and a transaction-based simulator, or may include an event-driven simulator, a cycle-based simulator, and a transaction-based simulator. That is, one or more simulators used for design verification may be configured in various ways in the embodiments of the inventive concept.

When at least two simulators include an event-driven simulator and a cycle-based simulator, distributed parallel simulation may be carried out in a co-simulation mode in which event-driven simulation is run partly and cycle-based simulation is run partly. When at least two simulators include an event-driven simulator, a cycle-based simulator, and a transaction-based simulator, distributed parallel simulation may be carried out in a co-simulation mode in which an event-driven simulation is partially run, a cycle-based simulation is partially run, and a transaction-based simulation is partially run.

For instance, in a distributed parallel simulation or distributed-processing-based parallel simulation of an AMBA platform-based SoC model at a specific abstraction level, an on-chip bus design object including a bus arbiter and an address decoder is a block modeled at a ca-transaction level and local simulation for the block may be cycle-based simulation. The remaining design objects such as ARM core, DSP, memory controller, DAM controller, and other peripheral devices are blocks modeled at an RTL and local simulation for these blocks may include an event-driven simulation.

HDL simulators, e.g., Cadence Design Systems NC-sim, Synopsys VCS, Mentor Graphic ModelSim, and Aldec Active-HDL/Riviera, used in chip design at an RTL are all event-driven simulators. The Scirocco simulator from Synopsys as an example of a cycle-based simulator.

In a systematically progressive refinement (SPR) verification method applied to design using a progressive refinement process according to some embodiments of the inventive concept, RTL verification on an implementable RTL model at an RTL may be executed in parallel or partially, for example, an incremental simulation method may be used for the partial execution, using the result of system-level verification on an ESL model or the result of ESL/RTL verification on at least one model at a medium abstraction level, MODEL_DUV(MIXED)_i, built during the progressive refinement from ESL to RTL, so that the RTL verification can be performed quickly.

Also, in the SPR verification method, GL verification on an implementable GL model at a GL may be executed in parallel or partially, for example, the incremental simulation method may be used for the partial execution, using the result of RTL verification on an RTL model or the result of RTL/GL verification on at least one model at a medium abstraction level, MODEL_DUV(MIXED)_i, built during the progressive refinement from RTL to GL, so that the GL verification can be performed quickly.

Moreover, in the SPR verification method, ESL verification on an ESL model at a different transaction level may be executed in parallel or partially, for example, the incremental simulation method may be used for the partial execution, using the result of system-level verification on a transaction model with high abstraction, or the result of a mixed verification of at least one model MODEL_DUV(MIXED_AT_TLM)_i built with a transaction model with high abstraction and a transaction model with low abstraction, for example, a specific design object in MODEL_DUV(MIXED_AT_TLM) is at a ca-transaction level and the remaining design objects are at a timed-transaction level, during the progressive refinement process, so that the ESL verification can be performed quickly.

As described above, verification is basically carried out by a simulation using at least one simulator. The verification may also carried out by simulation acceleration using at least one hardware-based verification platform, such as a simulation accelerator, a hardware emulator, or a FPGA board, together with a simulator.

Such simulation acceleration that increases the execution speed of a simulation using one or at least two simulation accelerators, one or at least two hardware emulators, or one or at least two FPGA boards together with one or at least two simulators is also a simulation in a broad sense. Accordingly, unless otherwise specified, the term “verification” is interchangeable with the term “simulation” in a description according to the inventive concept.

In accordance with embodiments of the inventive concept, formal verification is not taken into account, but simulation using dynamic verification is considered only. Accordingly, the term “simulation” is used instead of “verification and the simulation includes simulation using a simulator only and a simulation using a simulation accelerator, a hardware emulator, or a FPGA board together with the simulator.

In an SPR verification method according to some embodiments of the inventive concept, the parallel or partial execution of a simulation at the low abstraction level may be carried out using a result of a simulation executed at a high abstraction level before or simultaneously with the simulation executed at the low abstraction level in a progressive refinement process or a result of at least one simulation executed at a medium abstraction level, or the parallel or partial execution of simulations at the same abstraction level may be carried out using a result of a simulation executed prior to the same abstraction level in the progressive refinement process.

Also, in the SPR verification method, the parallel or partial execution of a simulation at a specific abstraction level may be carried out using a result of a simulation previously executed at a low abstraction level, for example, in cases where design iteration occurs, in the progressive refinement process.

One of the essential ideas of the inventive concept is the use of a result of a simulation executed previously so that a simulation executed later can be executed quickly. A current simulation may be executed at the lower abstraction level than or the same abstraction level as a previous simulation. In some cases, the current simulation may be executed at the higher abstraction level than the previous simulation. A change may occur in at least one design object in at least one model simulated between a current simulation and the previous simulation.

A case in which a previous simulation is executed at the higher abstraction level than a current simulation will be described in detail. During a simulation executed at a high abstraction level using a model at the high abstraction level in a progressive refinement process, state information of the model at the high abstraction level collected at one or more specific simulation times or periods is used, referred to as a “usage method 1”. While two or more simulations are executed at a medium abstraction level using a model at a mixed high/low abstraction level, design state information, also referred to as a “state information”, of the model at the medium abstraction level collected at one or more specific simulation times or periods is used, referred to as a “usage method 2”. During a simulation executed at a high abstraction level using a model at a high abstraction level in a progressive refinement process, input/output information of at least one design object in the model at the high abstraction level collected in an entire or a specific simulation period is used, referred to as a “usage method 3”. While two or more simulations can be executed at a medium abstraction level using a model at a mixed high/low abstraction level, input/output information of design objects at the low abstraction level in the model at the mixed high/low abstraction level collected in an entire or a specific simulation period can be used, referred to as a “usage method 4”.

In a parallel simulation using a unique distributed-processing-based parallel execution method according to some embodiments of the inventive concept, each local simulation executes a local design object, while the local simulation execute only a local design object in conventional distributed parallel simulation. The local simulations can also execute a model of DUV and TB at a high abstraction level, which is at the higher abstraction level than a whole model of DUV and TB made up of all of local design objects executed in the respective local simulations, or a whole model of DUV and TB optimized for fast simulation. There are many methods of optimizing a model for fast simulation, but representatively a model for cycle-based simulation is optimized for 10 times faster simulation than a model for event-driven simulation. Dynamic information can be obtained from the model of DUV and TB at the high abstraction level or the whole model of DUV and TB, optimized for fast simulation. The local simulation uses dynamic information as an expected input for the simulation of each local design object and an expected output of the simulation of the local design object, thereby minimizing synchronization overhead and communication overhead with other local simulations in distributed parallel simulation, so that simulation speed is increased.

The state information of a model is dynamic information containing all signal values or variables dictating a flip-flop output, a latch output, memory, or a combinational feedback loop in the model at a specific simulation time. For example, this can occur at a simulation time corresponding to the 29,100,511st nanosecond or during a specific simulation period, for example, a 100-nanosecond period from 29,100,200 nanoseconds to 29,100,300 nanoseconds. The dynamic information of a model or a design object is at least one signal in the model or the design object, a logic value of a signal line, or at least one variable or constant in the model or design object at a specific simulation time or for a specific simulation period, for example, an entire simulation period, during the simulation. To obtain the dynamic information during the simulation, a system task such as $dumpvars, $dumpports, $dumpall, $readmemb, or $readmemh or a user-defined system task may be used in a Verilog simulator or the like. The dynamic information may be stored in a VCD, SHM, VCD+ or FSDB format, or a user-defined binary or text format, or other format readily known to those of ordinary skill in the art.

The state information of a design object can include dynamic information containing all signal values or variables dictating a flip-flop output, a latch output, memory, or a combinational feedback loop in the design object at a specific simulation time or during a specific simulation period.

The input information of a design object includes the values of all inputs of the design object during a specific simulation period, for example, an entire simulation period. The output information of a design object includes values of all outputs of the design object during a specific simulation period, for example, an entire simulation period. The input/output information of a design object includes values of all inputs and outputs of the design object during a specific simulation period, for example, an entire simulation period.

As described above, according to some embodiments of the inventive concept, a simulation using a model at a certain abstraction level may be executed in parallel or partially using a result of a simulation previously executed using a model at the certain abstraction level in a progressive refinement process, so that simulation speed is increased. Also, a simulation using a model at a high abstraction level may be executed in parallel or executed partially using a result of a previously executed simulation using a model at a low abstraction level in a progressive refinement process. Accordingly, the simulation speed can be increased.

In a simulation method according to some embodiments of the inventive concept, the speed of a local simulation for a model at a low abstraction level is increased by executing a parallel or partial simulation of the model at the low abstraction level using a result of simulation of a model at a high abstraction level in a progressive refinement process, or by using an expected input and an expected output of the local simulation for the model at the low abstraction level, which can be obtained by running both the model at a high abstraction level and the model at a high abstraction level in the local simulation.

In other words, simulation using a model M(LOW) at a low abstraction level is quickly executed by using a result of a simulation executed before any design object is changed due to a debugging or specification change, by using a result of a simulation using a model M(HIGH) at a high abstraction level, or by using the model M(HIGH) at the high abstraction level together with the model M(LOW) at the low abstraction level.

Accordingly, a method for quick simulation using the model M(HIGH) at the high abstraction level according to some embodiments of the inventive concept may be carried out by using a result of simulation using a model M(HIGHER) at a higher abstraction level than the model M(HIGH), at this time, M(HIGHER) corresponds to a model at a high abstraction level and M(HIGH) corresponds to a model at a low abstraction level, in a sequential operation of the method, by applying a distributed parallel simulation, or by applying a single simulation.

In the inventive concept, parallel simulation using a model at a specific abstraction level includes both distributed-processing-based parallel execution, hereinafter, referred to as DPE, and time-sliced parallel execution, hereinafter referred to as TPE. Thus, parallel simulation using DPE and parallel simulation using TPE indicate new simulation methods proposed by the inventive concept.

A temporal design check point (t-DCP) and a spatial design check point (s-DCP) will be defined first. The t-DCP is defined as the dynamic information of DUV or at least one design object in the DUV, which is necessary to start a simulation for the DUV or the at least one design object in the DUV at a specific simulation time Ta other than a simulation time 0.

The dynamic information of a design object may be at least one signal in the design object, a logic value of a signal line, or a constant of at least one variable in the design object at a specific simulation time or for a specific simulation period, for example, an entire simulation period, during simulation. Accordingly, the state information of a design object may include an example of a t-DCP.

A model for simulation must include both DUV and TB. Therefore, to start the simulation at the specific simulation time Ta other than the simulation time 0, both DUV and TB need to be considered. At least one of three or more methods can be performed.

In the first method, TB is executed from the simulation time 0 and DUV from the simulation time Ta. In detail, when TB is reactive, TB alone is executed from the simulation time 0 to Ta using the output information of DUV, which needs to be obtained at a previous simulation. Both DUV and TB are simulated together from the simulation time Ta. When TB is non-reactive, TB alone is executed from the simulation time 0 to Ta. Both TB and DUV are executed together from the simulation time Ta.

In the second method, TB is saved and restarted so that TB is started at the simulation time Ta. In detail, a TB state, which includes the values of all variables and constants at a specific simulation time or period in TB, or a simulation state is saved and reset, so that TB is restarted.

However, unlike DUV which includes a hardware model, TB is a test environment model. Accordingly, to restart the execution the TB state at a specific simulation time, the description style of TB needs to be confined, for example, to a synthesizable style, or an additional manual operation is needed.

In the third method, an algorithmic-based input generation subcomponent in TB is replaced with a pattern-based input generation subcomponent. An input generation subcomponent provides an input stimulus for DUV. While it is difficult to start to provide an input for DUV at the specific simulation time Ta instead of the simulation time 0 in algorithmic-based input generation, it is easy to start to provide the input for DUV at the specific simulation time Ta using a pattern pointer or the like in pattern-based input generation.

To use the pattern-based input generation subcomponent, input information, which is generated in original TB and then applied to DUV in a previous simulation, is probed throughout an entire simulation period and saved as at least one file. Thereafter, the input information saved as the at least one file may be used in a simulation to start TB at the specific simulation time Ta.

Such TB using pattern-based input generation is usually used in a regression test. In order to use one of the methods, it is necessary to add extra code to a model under simulation or a simulation environment. The extra code may be automatically added using verification software in some embodiments of the inventive concept.

A t-DCP similar to or the same as the state information of DUV or at least one design object in the DUV can be used to enable a simulation for the DUV or the at least one design object in the DUV to start at the specific simulation time Ta other than the simulation time 0. When the t-DCP is used, an entire simulation time for the DUV can be divided into a plurality of time slices in each of which simulation is independently executed, so that a time parallel simulation can be carried out.

When simulation using HDL simulators is event-driven, it is important to ensure that there is no event loss even if a simulation for DUV or at least one design object in the DUV is restarted at the specific simulation time Ta other than the simulation time 0 using a t-DCP like the state information of the DUV or the at least one design object. It is also important than the simulation is executed from the simulation time 0 to the specific simulation time Ta and then continued after being restarted at the specific simulation time Ta. It is also important that a simulation result obtained after the specific simulation time Ta is constant.

To ensure the restart of simulation at the specific simulation time Ta, instead of saving the state information of a previous simulation only at the specific simulation time Ta, the state information of the previous simulation for a predetermined time section “d” including the specific simulation time Ta is saved and the restart of the simulation begins with the predetermined time section “d” using the state information corresponding to the predetermined time section “d”. Here, the predetermined time section “d” is a maximum time interval at which an event is triggered by another event. The predetermined time section “d” varies with a model under simulation and may be input by a user. Alternatively, the predetermined time section “d” may be automatically calculated. For instance, when the specific simulation time Ta is a time point corresponding to the 10,000,000th nanosecond, saving the state information is carried out not just at the specific simulation time Ta, but during a time section, for example, an increment of 10 nanoseconds, from the 9,999,999th nanosecond to the 10,000,000th nanosecond. At this time, the predetermined time section “d” is 10 nanoseconds. Thereafter, when the simulation is restarted, it is executed from the 9,999,999th nanosecond to the 10,000,000th nanosecond using the state information.

When at least one local simulation is event-driven in a distributed-processing-based parallel simulation, restarting the simulation without event loss is essential to correct a rollback. When the above-described method is used, a rollback can be correctly performed.

When distributed parallel simulation for DUV or at least two design objects in a DUV is carried out using at least two simulators, communication and synchronization is needed for the correct transmission of signal values or transaction values between simulators respectively allocated the design objects. The s-DCP is necessary to minimize the communication and synchronization between the simulators. The s-DCP is defined as the dynamic information of an equivalent model of DUV or TB at different abstraction levels, the dynamic information of at least one design object in the equivalent model at different abstraction levels, the dynamic information of DUV or TB, the dynamic information of at least one design object in DUV or TB, a model of DUV and TB at a high abstraction level, and/or a model of entire DUV and TB optimized for fast simulation. An example can include using a two-state simulation option or radiant technology in VCS or a combination thereof or using a similar method in NC-sim or ModelSim for fast simulation.

The s-DCP is simulated together with a specific local design object by a local simulator in distributed parallel simulation and is used to obtain the expected input and expected output of a local simulation S_1(k) for the specific local design object. When the actual output of the specific local design object, which is obtained by applying the expected input to the specific local design object and actually executing the local simulation S_l(k), is the same as the expected output, the local simulation S_l(k) can proceed further without synchronization and communication with other local simulations executed by other local simulators for other local design objects in the model. Here, the terms “expected input and expected output for a local simulation” can correspond to an expected input and an expected output, which are estimated before or during an actual execution of the local simulation. The estimating the expected input and output before or during the actual execution includes estimating them before the actual simulation starts, dynamically estimating the expected input before or at a specific simulation time when an actual input is applied during the actual execution and dynamically estimating the expected output before or at another specific simulation time when an actual output is output, or estimating them using a combined method thereof. Accordingly, the s-DCP may be the whole model for DUV and TB at a high abstraction level, the whole model for DUV and TB optimized for fast simulation, the input/output information of at least one design object collected from a previous simulation, or a combination thereof.

To provide the s-DCP used for the expected input and expected output of a local design object in a local simulation and to control the execution of the simulation such as run with expected input and output, run with actual input and output, rollback, etc, described below, an extra code can be added to a design code or a simulation environment. The design code can be written in HDL, SystemC, C/C++, SDL, HVL, or any combination thereof. The simulation environment can include simulation compiling, elaboration, or simulation script. The extra code may be written in HDL, such as Verilog, SystemVerilog, or VHDL, so that it is included in a model written in HDL; it may be written in C/C++/SystemC so that it is interfaced with a model in HDL using PLI/VPI/FLI. The extra code may alternatively be written in the combination of HDL and C/C++/SystemC so that it is included in and interfaced with the model in HDL using PLI/VPI/FLI. The extra code is normally added to TB of a model, i.e., the outside of DUV and written in C/C++. However, when necessary, the extra code may be partially added to DUV. The addition of the extra code may be automatically carried out by reading at least one design source file dictating a model or a simulation environment file using verification software in some embodiments of the inventive concept.

The extra code instructs that an expected input be applied to a local design object under a local simulation, an expected output be compared with an actual output of the local design object obtained from an actual simulation of the local design object, and that a subsequent expected input be applied when the expected output is the same as the actual output. The extra code has a similar function to TB having a function that includes applying an input and checking whether an output is produced as expected, so that the extra code is automatically generated.

When a roll-forward is necessary, a current local simulation is run using an expected input and an expected output. The roll-forward is needed in the current local simulation when there is a mismatch between an actual output and an expected output in another local simulation at a simulation time t_d and the simulation time t_d comes later than a current simulation time t_c of the current local simulation. Therefore, the current local simulation needs to be executed to the simulation time t_d. However, when there is a mismatch between an actual output and an expected output in the current local simulation at a simulation time t_b between the simulation times t_c and t_d, the current local simulation needs to stop temporally at the simulation time t_b and inform other local simulations of a new rollback time t_b, and the possibility of a rollback. Therefore, the roll-forward is no different than a run using an expected input/output. Thus, it is not necessary to be specially treated for the current local simulation. The rollback is performed when a rollback is necessary, and conventional distributed parallel simulation is run with an actual input and output. The run with an actual input and output can include a mode in which transfer of data, i.e., inputs from other local simulations or output to other local simulations, among local simulations is actually performed in distributed parallel simulation and either optimistic or pessimistic synchronization is performed for the transfer. A data transfer interval and a synchronization interval may include a smallest simulation precision unit, a minimum simulation time, a cycle, a transaction, or the like. Accordingly, both conventional conservative distributed parallel simulation and conventional optimistic distributed parallel simulation can be run with the actual input and output. The above-described method needs to support a rollback used in conventional optimistic distributed parallel simulation.

Variables of a local design object can be reset to include design state information without repeating simulation compiling at each rollback by reading the design state information from a file using acc_set_value( ) in VPI/PLI at a specific simulation time or in a specific simulation period, setting the variables to the design state information, and dynamically changing the file before each rollback so that the content of the file including the design state information has variables of the local design object at the specific simulation time corresponding to a simulation restart time or in the specific simulation period corresponding to a simulation restart period.

Consequently, in a distributed parallel simulation environment, local design objects are independently simulated by respective local simulators using an expected input, which is obtained from an s-DCP according to an extra code added for DPE of the inventive concept, to obtain an actual output of each local design object. The actual output is compared with an expected output obtained from the s-DCP. When the actual output is the same as the expected output, communication and synchronization among the local simulators can be omitted completely or as much as possible and each local simulation is run forward. Such operation is referred to as a run-with-expected input/output mode. As a result, simulation speed can be dramatically increased.

Only when the actual output is different from the expected output obtained from the s-DCP, referring to a “point of mismatch between expected output and actual output”, is communication and synchronization among the local simulators performed in a distributed parallel simulation.

Even after the simulation switches to a run-with-actual input/output mode in which the communication and synchronization among the local simulators is performed. This switching time is referred to as an “application point of run-with-actual input/output mode”. The application point of run-with-actual input/output mode may be a time t_lock, which is the earliest point of mismatch between expected output and actual output among those of local simulations in a distributed parallel simulation or a time t_advance_lock earlier than the time t_lock. However, for the optimization of simulation performance, the application point of run-with-actual input/output mode needs to be as close to the time t_lock as much as possible. Therefore, when a mismatch between expected output and actual output occurs in each local simulation using the run-with-expected input/output mode, the run-with-expected input/output mode is stopped and a point of mismatch between the expected output and an actual output is broadcast to other local simulations. To roll back to the time t_lock or t_advance_lock, each local simulation need to save its simulation state (The simulation state is a run-time image of a simulation process at a specific simulation time, which is saved as a checkpoint. Most of commercial simulators have such checkpoint feature, e.g., save/restart feature in VCS from Synopsys, NC-Verilog from, Cadence Design Systems, or ModelSim from Mentor, or the state information of at least one local design object in the local simulation periodically at the time t_lock or t_advance_lock or non-periodically when predetermined conditions are met, actual inputs produced, for example, from one or more other local simulations in the run-with-actual input/output mode under the distributed parallel simulation environment, during the simulation are continuously compared with expected inputs obtained from the s-DCP or the actual outputs produced during the simulation are continuously compared with expected outputs obtained from the s-DCP. For the efficiency of comparison, an expected value, i.e., an expected output or an expected input, may be compared with an actual value, i.e., an actual output or an actual input, at an aligned abstraction level. A module can align an abstraction level of the expected value with that of the actual value is referred to as an adaptor or a transactor. For instance, when an expected value is compared with an actual value in a distributed parallel simulation at an RTL, the abstraction level of the actual value may be raised to a ca-transaction level the same as the level of the expected value, or both the RTL of the expected value and the ca-transaction level of the actual value may be raised to a timed-transaction level. When a certain number, which may be set as an input before the simulation and may be adaptively changed as well during the simulation, of matches occurs during the comparison, from this point, referred to as a “cancellation point of run-with-actual input/output mode”, the local simulators can be released from the run-with-actual input/output mode so that communication overhead and synchronization overhead is again eliminated. In this case, each local simulation in the distributed parallel simulation can be independently run without communication and synchronization with other local simulations, so that the local simulation is performed very quickly. As compared to the run-with-actual input/output mode, an independent run of a local simulation without communication and synchronization with other local simulations is referred to as the run-with-expected input/output mode in the inventive concept. When distributed parallel simulation is executed alternatively in the run-with-expected input/output mode and/or the run-with-actual input/output mode, the performance of the simulation can be greatly increased.

Some specific examples of an s-DCP include input/output information corresponding to at least one design object in a DUV and TB, a simulation model which includes DUV and TB and is described at a higher abstraction level than the DUV and TB, and a whole model for DUV and TB which is optimized for fast simulation. When the boundaries of portions of design such as local design objects run by local simulators, which are defined for local simulations in a distributed parallel simulation, do not coincide with the boundaries of design objects, e.g., modules in Verilog design, entities in VHDL design, and sc_modules in SystemC design, in a DUV, an s-DCP includes the input/output information corresponding to the local design objects for the local simulations.

In distributed parallel simulation using the s-DCP to minimize communication overhead and synchronization overhead, a point of mismatch between expected output and actual output may be different among local design objects executed by respective local simulators. In this case, all of the local simulators need to operate in the run-with-actual input/output mode requiring communication and synchronization, starting from an earliest point t_e among two or more points of mismatch between expected output and actual output. Accordingly, local simulations that have advanced further than the earliest mismatch point t_e are required to be rolled back. For instance, in response to first through fourth design objects being executed in a simulation without communication and synchronization up to simulation times of 1,000,000 nanoseconds (ns), 1,000,010 ns, 1,000,020 ns, and 1,000,030 ns, respectively, and the earliest mismatch point t_e is 1,000,000th ns, local simulations for the respective second through fourth design objects can be rolled back to the point of 1,000,000th ns and all local simulations for the respective design objects can be executed in the run-with-actual input/output mode from the point of 1,000,000th ns to a subsequent cancellation point of a run-with-actual input/output mode from which communication and/or synchronization are not required. The rollback may be carried out using simulation save/restart feature. There are two simulation save/restart methods. The first method includes saving a simulation state periodically or at one or more specific time points and reloading and re-executing it during simulation. The second method includes saving a design state, i.e., state information of a design object, periodically or at one or more specific time points or periods and reloading and re-executing it.

As described above, to make the simulation save/restart feature possible, a process of saving a simulation state or a design state periodically or at one or more specific time points or periods is needed. This process is referred to as a checkpoint process or “checkpointing.” Here, a checkpoint is generated through the process. Checkpoints can include one or more specific time points or periods at which a simulation state or a design state is saved and at which re-simulation is started. In response to the rollback being performed, a rollback point to which simulation is rolled back is not an earliest point t_est among points of mismatch between expected output and actual output but instead includes a checkpoint which is the same as the earliest mismatch point t_est or closest to the earliest mismatch point t_est in a direction toward the past.

An expected input/output used to minimize communication overhead and synchronization overhead in distributed-processing-based parallel simulation may be represented in a signal of a bit/bit-vector type or a transaction of a high-abstraction data structure type, such as a record type.

A transaction may include a cycle-by-cycle transaction or a cycle-count transaction. Therefore, a comparison between an expected input and an actual input or between an expected output and an actual output may be performed at a different abstraction level, such as at a signal level, at a cycle-by-cycle transaction level, or at a cycle-count transaction level, depending on the abstraction level of a model. Therefore, a comparison between an expected input and an actual input, or between an expected output and an actual output, can cover the comparison performed at the signal level, the comparison performed at the cycle-by-cycle transaction level, the comparison performed at the cycle-count transaction level, and/or the comparison performed at an untimed transaction level.

A distributed parallel simulation method according to some embodiments of the inventive concept is referred to as a distributed parallel execution method using an s-DCP, a DPE method, or a distributed-processing-based parallel simulation method. In other words, a DPE method or a distributed-processing-based parallel simulation method is not a conventional distributed parallel simulation method but is instead a distributed parallel simulation method that is proposed by the inventive concept to minimize communication overhead and synchronization overhead in a distributed simulation by using an expected input and an expected output obtained using an s-DCP.

To maximize the performance of a distributed parallel execution method using an s-DCP, a relevant feature is to minimize the number of times of cancellation of the run-with-actual input/output mode and the sum of periods of time from an application of the run-with-actual input/output mode to a cancellation thereof, i.e., an entire time during which a simulation is executed in the run-with-actual input/output mode. When minimizing in this manner, the accuracy of the s-DCP used to obtain the expected input and output is critical. When the accuracy of the s-DCP increases, a running time of the run-with-actual input/output mode in an entire simulation time decreases while a running time of the run-with-expected input/output mode increases, so that communication overhead and synchronization overhead, which is a crucial factor limiting the performance of a distributed parallel simulation, can be dramatically reduced. As a result, the performance of the distributed parallel simulation is greatly increased.

As well as the accuracy of the s-DCP, a period of time taken to acquire the s-DCP, i.e., s-DCP the acquisition time is also important. The accuracy of the s-DCP is highest when expected inputs and/or expected outputs for local design objects are obtained from the simulation of a model at one abstraction level, but the s-DCP acquisition time is long, which could be problematic in the majority of cases.

However, such approach of acquiring an s-DCP from the simulation of a model at one abstraction level is very efficient in case of regression test with respect to the examination of backward compatibility, when design is changed very locally, or when a previously acquired s-DCP is reused in a repetitive simulation using a TB.

In most case, a regression test is passed with no design errors detected. Therefore, when a distributed parallel simulation or a combination of distributed parallel simulation and singular simulation is executed using an s-DCP obtained prior to the regression test from a simulation of design objects at one abstraction level, the regression test can be performed very quickly with the maximum performance of a distributed parallel simulation because the accuracy of the s-DCP is very high so that the number of cancellations of the run-with-actual input/output mode and the total simulation time for the run-with-actual input/output mode is minimized.

Also, in a case where design is only locally changed due to debugging or specification change, if an s-DCP collected before the change in the design is used in a distributed parallel simulation, a combination of distributed parallel simulation and singular simulation (described below), or an incremental distributed-processing-based parallel simulation (also described below), simulation performance is maximized so that the simulation can be executed very quickly.

Situations may exist where is not desirable that a distributed-processing-based parallel simulation is run in the run-with-actual input/output mode starting from at least one application point t_lockstep of the run-with-actual input/output mode during the execution of the simulation instead of running the distributed parallel simulation in the run-with-actual input/output mode, starting from the application point t_lockstep of the run-with-actual input/output mode. An example can be when many simulator licenses cannot be allocated for a simulation task for a long time because there are not enough licenses available for the simulator or when an expected increase in the performance of a distributed parallel simulation in the run-with-actual input/output mode is not satisfactory, In an embodiment, a singular simulation for DUV can be performed using a single simulator. Here, simulation for TB may be performed using the single simulator or when it is necessary to execute the simulation for TB using a simulator, e.g., an HVL simulator, the two simulators may interwork with each other. This is described in detail below.

A distributed-processing-based parallel simulation may be executed for a specific simulation period, e.g., from simulation time 0 to the first point of mismatch between expected output and actual output, to minimize synchronization overhead and communication overhead, so that distributed parallel simulation can be quickly executed. At the end of the distributed-processing-based parallel simulation, a t-DCP of DUV is generated. This can include the sum of all t-DCPs of local design objects in a DUV that are run in respective local simulations. Starting from the application point of the run-with-actual input/output mode, a singular simulator may be executed for the DUV using the t-DCP of the DUV. That is, instead of the distributed parallel simulation, the singular simulation is executed starting from the application point of the run-with-actual input/output mode.

Such method is referred to as a “combination of DPE/singular execution” in which both s-DCP and t-DCP are used. A separate simulation compilation may be necessary for the singular execution. In other embodiments, the distributed-processing-based parallel simulation may be executed in a different manner than the above-described method, starting from the application point of the run-with-actual input/output mode.

For instance, when there four design objects B0, B1, B2, and B3 in a DUV, the design objects B0, B1, B2, and B3 may be respectively allocated to, and executed, by four simulators each executing at a computer in an initial distributed-processing-based parallel simulation up to an application point of a run-with-actual input/output mode. Thereafter, the design object B0, e.g., TB design object, may be solely allocated to the first simulator and the design objects B1, B2, and B3 may be allocated to the second simulator so that only two simulators are used in distributed parallel simulation in the run-with-actual input/output mode and the remaining two simulators are available for other simulation tasks. At this time, a new simulation compilation is necessary for a specific local simulation. For example, while a local simulation of the design object B0 can be executed continuously without a new compilation, a local simulation of the design objects B1 through B3 requires a new compilation. Some or all of the foregoing approaches can be included in DPE method according to embodiments of the inventive concept.

However, in otherwise cases, it is practically problematic to execute a simulation at one abstraction level for an extended amount of time to obtain an s-DCP when the s-DCP is not a simulation model but rather includes dynamic information. It is more efficient to use as the s-DCP a model at a high abstraction level existing in a progressive refinement process or an entire model of DUV and TB optimized for fast simulation, or to obtain the s-DCP using dynamic information obtained in a simulation using the model at the high abstraction level, for example, corresponding to the usage method 3 or the usage method 4.

For instance, a simulation at a GL, an RTL model or a mixed RTL/GL model may be directly used as an s-DCP in a local simulation. Alternatively or in addition, a GL model optimized for fast simulation may be directly used as the s-DCP. Alternatively or in addition, dynamic information obtained during an RTL simulation may be used as the s-DCP. Alternatively or in addition, dynamic information obtained during a mixed RTL/GL simulation may be used as the s-DCP. The dynamic information obtained during the mixed RTL/GL simulation can include the combined input/output information of all design objects at the GL in respective models at a mixed level of RTL/GL. For instance, in embodiments where the GL model is constructed as DUV(GL)=(B(1)_gl, B(2)_gl, B(3) gl, B(4)_gl) and the RTL model is constructed as DUV(RTL)=(B(1)_rtl, B(2)_rtl, B(3)_rtl, B(4)_rtl), four mixed RTL/GL models can be constructed as DUV(MIXED)_4=(B(1)_rtl, B(2)_rtl, B(3)_rtl, B(4)_gl), DUV(MIXED)_3=(B(1)_rtl, B(2)_rtl, B(3)_gl, B(4)_rtl), DUV(MIXED)_2=(B(1)_rtl, B(2)_gl, B(3)_rtl, B(4)_rtl), and DUV(MIXED)_1=(B(1)_gl, B(2)_rtl, B(3)_rtl, B(4)_rtl). The input/output information of B(1)_gl can be obtained in a simulation using the model DUV(MIXED)_1. The input/output information of B(2)_gl can be obtained in a simulation using the model DUV(MIXED)_2. The input/output information of B(3)_gl can be obtained in a simulation using the model DUV(MIXED)_3. The input/output information of B(4)_gl can be obtained in a simulation using the model DUV(MIXED)_4. A combination of these four items of input/output information can be used as the s-DCP. For an RTL simulation, an ESL model, a mixed ESL/RTL model, an RTL model optimized for fast simulation, dynamic information obtained during an ESL simulation, or dynamic information obtained during a mixed ESL/RTL simulation may be used as an s-DCP. The dynamic information obtained during the mixed ESL/RTL simulation can include the combined input/output information of all design objects at the RTL in respective models at a mixed level of ESL/RTL. For instance, in embodiments where the RTL model is constructed as DUV(RTL)=(B(1)_rtl, B(2)_rtl, B(3)_rtl, B(4)_rtl) and the ESL model is constructed as DUV(ESL)=(B(1)_esl, B(2)_esl, B(3)_esl, B(4)_esl), four mixed ESL/RTL models are constructed as DUV(MIXED)_4=(B(1)_esl, B(2)_esl, B(3)_esl, B(4)_rtl), DUV(MIXED)_3=(B(1)_esl, B(2)_esl, B(3)_rtl, B(4)_esl), DUV(MIXED)_2=(B(1)_esl, B(2)_rtl, B(3)_esl, B(4)_esl), and DUV(MIXED)_1=(B(1)_rtl, B(2)_esl, B(3)_esl, B(4)_esl). The input/output information of B(1)_reliant be obtained in a simulation using the model DUV(MIXED)_1. The input/output information of B(2) reliant be obtained in a simulation using the model DUV(MIXED)_2. The input/output information of B(3)_reliant be obtained in a simulation using the model DUV(MIXED)_3. The input/output information of B(4)_reliant be obtained in a simulation using the model DUV(MIXED)_4. A combination of these four items of the input/output information can be used as the s-DCP.

For an ESL simulation, any or all of a transaction model at a higher level than an ESL model, an ESL transaction model optimized for fast simulation, dynamic information obtained during an ESL simulation of a transaction model at a level higher than the ESL, or dynamic information obtained during a mixed simulation of a TLM at a level higher than the ESL and a TLM at the same level as the ESL, may be used as an s-DCP. For instance, the dynamic information obtained during the mixed simulation may be the combined output information of all design objects at a ca-transaction level in respective models at a mixed level of timed-transaction/ca-transaction. When a ca-tlm is constructed as an ESL model DUV(ca-tlm)=(B(1)_ca-tlm, B(2)_ca-tlm, B(3)_ca-tlm, B(4)_ca-tlm), and a timed-tlm is constructed as ESL model DUV(timed-tlm)=(B(1)_timed-tlm, B(2)_timed-tlm, B(3)_timed-tlm, B(4) timed-tlm), four mixed timed-tlm/ca-tlm models can be constructed as DUV(MIXED)_4=(B(1)_timed-tlm, B(2)_timed-tlm, B(3)_timed-tlm, B(4)_ca-tlm), DUV(MIXED)_3=(B(1)_timed-tlm, B(2)_timed-tlm, B(3)_ca-tlm, B(4)_timed-tlm), DUV(MIXED)_2=(B(1)_timed-tlm, B(2)_ca-tlm, B(3)_timed-tlm, B(4)_timed-tlm), and DUV(MIXED)_1=(B(1)_ca-tlm, B(2)_timed-tlm, B(3)_timed-tlm, B(4)_timed-tlm). The output information of B(1)_ca-tlm can be obtained in the simulation using the model DUV(MIXED)_1 among those four mixed timed-tlm/ca-tlm models. The output information of B(2)_ca-tlm can be obtained in a simulation using the model DUV(MIXED)_2. The output information of B(3)_ca-tlm can be obtained in a simulation using the model DUV(MIXED)_3. The output information of B(4)_ca-tlm can be obtained in a simulation using the model DUV(MIXED)_4. A combination of these four items of the output information can be used as the s-DCP.

In another instance, the dynamic information obtained during the mixed simulation may be the combined output information of all design objects at an RTL level in respective mixed ca-transaction/RTL models. When a ca-tlm is constructed as an ESL model DUV(ca-tlm)=(B(1)_ca-tlm, B(2)_ca-tlm, B(3)_ca-tlm, B(4)_ca-tlm) and an RTL model is constructed as DUV(RTL)=(B(1)_rtl, B(2)_rtl, B(3)_rtl, B(4)_rtl), four mixed ca-tlm/RTL models can be constructed as DUV(MIXED)_4=(B(1)_ca-tlm, B(2)_ca-tlm, B(3)_ca-tlm, B(4)_rtl), DUV(MIXED)_3=(B(1)_ca-tlm, B(2)_ca-tlm, B(3)_rtl, B(4)_ca-tlm), DUV(MIXED)_2=(B(1)_ca-tlm, B(2)_rtl, B(3)_ca-tlm, B(4)_ca-tlm), and DUV(MIXED)_1=(B(1)_rtl, B(2)_ca-tlm, B(3)_ca-tlm, B(4)_ca-tlm). The output information of B(1)_reliant be obtained in a simulation using the model DUV(MIXED)_1 among those four mixed ca-tlm/RTL models; the output information of B(2)_rtl is obtained in a simulation using the model DUV(MIXED)_2; the output information of B(3)_rtl is obtained in a simulation using the model DUV(MIXED)_3; and the output information of B(4)_rtl is obtained in a simulation using the model DUV(MIXED)_4. A combination of these four items of the output information can be used as the s-DCP.

In another instance, the dynamic information obtained during the mixed simulation may be the combined output information of all design objects at a GL in respective mixed RTL/GL models. When a GL model is constructed as DUV(RTL)=(B(1)_rtl, B(2)_rtl, B(3)_rtl, B(4)_rtl) and DUV(GL)=(B(1)_gl, B(2)_gl, B(3)_gl, B(4)_gl), four mixed RTL/GL models can be constructed as DUV(MIXED)_4=(B(1)_rtl, B(2)_rtl, B(3)_rtl, B(4)_gl), DUV(MIXED)_3=(B(1)_rtl, B(2)_rtl, B(3)_gl, B(4)_rtl), DUV(MIXED)_2=(B(1)_rtl, B(2)_gl, B(3)_rtl, B(4)_rtl), and DUV(MIXED)_1=(B(1)_gl, B(2)_rtl, B(3)_rtl, B(4)_rtl). The output information of B(1)_gl can be obtained in a simulation using the model DUV(MIXED)_1 among the four mixed RTL/GL models. The output information of B(2)_gl can be obtained in a simulation using the model DUV(MIXED)_2. The output information of B(3)_gl can be obtained in a simulation using the model DUV(MIXED)_3. The output information of B(4)_gl can be obtained in a simulation using the model DUV(MIXED)_4. A combination of these four items of the output information can be used as the s-DCP.

As described above, when a model at a high abstraction level, a model at one abstraction model optimized for fast simulation, dynamic information obtained from a simulation of the model at the high abstraction level, or dynamic information obtained from a simulation of the model at one abstraction level optimized for fast simulation is used as an s-DCP, a simulation speed is very high so that expected inputs and expected outputs can be obtained very quickly. At this time, it is an issue whether the accuracy of the s-DCP is satisfactory. Since there is a consistency between a high abstraction level model and a low abstraction level model under a progressive refinement process, the accuracy of an s-DCP obtained by executing the high abstraction level model can be reasonably high.

If the consistency among models is perfect in the progressive refinement process, the entire simulation can be executed without using the run-with-actual input/output mode at all. The higher the consistency among the models, the more reduced the total number of cancellations of the run-with-actual input/output mode and the total simulation time for the run-with-actual input/output mode. Therefore, it is important to increase the consistency among the models.

A high consistency can be maintained between models at adjacent abstraction levels, e.g., an RTL model and a ca-transaction model or an RTL model and a GL model, among various abstraction levels in the progressive refinement process. When the accuracy of an s-DCP obtained from the simulation of a model of a high abstraction level is not satisfactory, for example, in case of an incorrect model at the high abstraction level or in case of the low model or dynamic information accuracy in a simulation at the high abstraction level, a process is required for enhancing the accuracy of the s-DCP.

The accuracy of the s-DCP may be enhanced by using a model with high accuracy at the high abstraction level from the beginning of a process. When a model at the high abstraction level is incorrect, the accuracy of the s-DCP can be enhanced by obtain a correct model through modification of the model and obtaining dynamic information with high accuracy by simulating the correct model at the high abstraction level. Alternatively, the s-DCP with high accuracy can be obtained by modifying dynamic information obtained from simulation of the incorrect model at the high abstraction level. Also, an s-DCP with high accuracy can be obtained by statically or dynamically modifying dynamic information obtained from simulation of a less accurate model at the high abstraction level.

In an example of easily building a model with high accuracy at the high abstraction level, a block in a model is decomposed into a communication module interfacing with other blocks in the model and an internal computation module. This method can be widely applied to a transaction-level model (TLM). Here, when the computation module is supplied with desired-level timing annotation with the computation module, for example, written at an untimed-transaction level, untouched, as well as high simulation speed timing accuracy, e.g., cycle-by-cycle accuracy or cycle-count accuracy necessary to a current module level can be accomplished in light of the input and output of the model. As-DCP with high accuracy can be obtained from such a model. Also, when a transactor is added to the communication module at a specific transaction level in the model, the abstraction level of the module can be changed into a different abstraction level in light of the input and output of the model. When a high-level synthesis tool is used such as the Cynthesizer TLM synthesis tool from Forte Design, a TLM communication module can be synthesized to have signal-level accuracy in hardware. An s-DCP with high accuracy can also be obtained.

In a specific example for obtaining an s-DCP with high accuracy by modifying the s-DCP, a transaction in a model at a ca-transaction level or a timed-transaction level needs to meet an on-chip bus protocol, e.g., an AMBA bus protocol, and therefore, the accuracy of the s-DCP can be enhanced by modifying the s-DCP violating the bus protocol to comply with the bus protocol.

In another specific example for obtaining an s-DCP with high accuracy by modifying the s-DCP, in order to enhance the accuracy of the s-DCP obtained from an RTL simulation or a mixed RTL/GL simulation for distributed-processing-based parallel simulation of a GL model, accurate delay information may be obtained with respect to only specific signal lines, for example, clock signal lines and/or flip-flop output signal lines for input information for respective local simulations, in a design object by analyzing an SDF, analyzing delay parameters of library cells, performing a GL timing simulation using the SDF for only a short period of simulation time, performing static timing analysis, or doing any combination of these; and the accurate delay information may be reflected to the s-DCP. Here, distributed parallel simulation can be performed using DPE according to some embodiments of the inventive concept, so that “simulation using DPE”, “distributed-processing-based parallel simulation”, and “distributed parallel simulation using DPE,” each referring to a new distributed parallel simulation proposed by the inventive concept. Here, examples of accurate delay information can include clock skew delay in a flip-flop clock input, clock-to-Q delays clock-to-Q(high_to_low) and clock-to-Q(low_to_high) for which an output of a positive-edge sensitive flip-flop changes since a rising edge of a clock input, clock-to-Q delays clock-to-Q(high_to_low) and clock-to-Q(low_to_high) for which an output of a negative-edge sensitive flip-flop changes, since a falling edge of a clock input, set_to_Q delay from an asynchronous set enable edge in a flip-flop to a time at which a flip-flop output changes, and reset_to_Q delay from an asynchronous reset enable edge in a flip-flop to a time at which a flip-flop output changes. In other words, a model is partitioned such that every output of a local design object of each local simulator can be the output of a flip-flop for local simulations in a GL timing simulation executed in distributed parallel simulation.

In another specific example for obtaining an s-DCP with high accuracy by modifying the s-DCP, to enhance the accuracy of the s-DCP obtained from an ESL simulation or a mixed ESL/RTL simulation for distributed-processing-based parallel simulation of an RTL model, accurate delay information, e.g., time during which an output of a flip-flop changes since the rising of a clock, phase difference among asynchronous clocks, etc., that does not exist in an ESL model may be obtained and reflected to the s-DCP.

The modification of the s-DCP may be statically performed before the distributed parallel simulation or, when necessary, dynamically performed during the distributed parallel simulation, which means that the s-DCP is modified while the distributed parallel simulation is being executed. In a specific example of dynamically modifying an s-DCP when the s-DCP is dynamic information during distributed parallel simulation and using the s-DCP as an expected input or output, when an expected input and an expected output collected from a front-end simulation performed at a ca-transaction level are used in a back-end simulation performed at an RTL in event-driven distributed-processing-based parallel simulation, the distributed-processing-based parallel simulation is executed at the RTL using an expected input and an expected output from an s-DCP obtained from low-accurate dynamic information collected from the simulation executed at the ca-transaction level and a result of the distributed-processing-based parallel simulation is dynamically reflected to enhance the accuracy of the s-DCP in an initial stage. For instance, when an RTL model is described to change a user clock, for example, which is a timing parameter that does not exist at the ca-transaction level, rising in the model 1 nanosecond (i.e., #1 in Verilog) after a clock rising in an output of a flip-flop in the model, such a clock-to-Q delay event, is dynamically detected from the RTL simulation result in the initial stage and is reflected to the s-DCP collected from the ca-transaction level simulation, that is, a clock-to-Q delay of 1 nanosecond corresponding to the timing information not existing in the s-DCP collected from the ca-transaction simulation is reflected to the s-DCP, thereby enhancing the accuracy of the s-DCP. When an expected input and an expected output obtained from the s-DCP with the enhanced accuracy are used after the initial stage of the simulation, effective distributed-processing-based parallel simulation using the s-DCP with the enhanced accuracy becomes possible thereafter. In accordance with the method, while the simulation is executed in the run-with-actual input/output mode since the accuracy of the s-DCP is low in the initial stage, the accuracy of the s-DCP can be enhanced using dynamic information collected on the fly in the run-with-actual input/output mode, which, for example, may be considered as dynamic learning. Thereafter, the simulation is executed in the run-with-expected input/output mode using the s-DCP with the accuracy enhanced. As a result, the use of the run-with-expected input/output mode is maximized in the simulation after the initial stage. Such scheme can be applied to distributed-processing-based parallel simulation considering the timing at the GL as well. In detail, during the distributed-processing-based parallel simulation considering the timing at the GL, which is a back-end simulation using a less accurate s-DCP collected in an RTL simulation corresponding to a front-end simulation, the original s-DCP with the low accuracy is changed into a high-accuracy s-DCP using a simulation result dynamically obtained in the run-with-actual input/output mode. At this time, the simulation result is dynamic information obtained from the distributed-processing-based parallel simulation executed in the run-with-actual input/output mode and thus includes all accurate GL timing information. Thereafter, the distributed-processing-based parallel simulation is executed using expected inputs and outputs based on the high-accuracy s-DCP, so that the use of the run-with-expected input/output mode is maximized.

Any of the above-described processes of enhancing the accuracy of an s-DCP can be referred to as an “s-DCP accuracy enhancing process”. However, when an original s-DCP is not dynamic information collected from a front-end simulation but a model at a high abstraction level, the s-DCP accuracy enhancing process enhances the accuracy of dynamic information collected during the execution of the original s-DCP, which is the model at the high abstraction level, in real time during simulation.

In particular, any of the s-DCP accuracy enhancing processes described above, i.e., the process of enhancing the accuracy of an s-DCP obtained in a front-end simulation while a back-end simulation is being executed using dynamic information dynamically collected in an initial stage of the back-end simulation, the process of enhancing the accuracy in real-time of dynamic information collected during the execution of an original s-DCP corresponding to a model at a high abstraction level, and the process of enhancing in real time the accuracy of dynamic information collected during the execution of an original s-DCP corresponding to a model at one abstraction level optimized for fast simulation can be referred to as an “s-DCP accuracy enhancing process using dynamic learning”.

More specific examples of an s-DCP accuracy enhancing process are described below.

First, when a simulation that can be executed in parallel with respect to DUV or design objects, which also exist in a model at a high abstraction level according to partial hierarchy matching relation, in a model, DUV, at a low abstraction level subjected to the original simulation is executed at least once using a primary s-DCP or t-DCP obtained from a simulation of a model at a high abstraction level, which has the partial hierarchy matching relation with the low abstraction level model subjected to the original simulation, a secondary s-DCP with enhanced accuracy can be obtained.

In a specific example, a simulation may be independently executed in parallel with respect to each of design objects while an expected input is being applied to each design object using a primary s-DCP. A secondary s-DCP can be obtained by collecting outputs of the design objects during this simulation. Since the secondary s-DCP is obtained with respect to the design objects in a model subjected to an original simulation, it can have high accuracy.

In another specific example, a simulation of DUV, a model at a low abstraction level, may be performed in parallel by a plurality of simulation time slices into which DUV simulation time is divided, i.e., in TPE, using a primary t-DCP obtained from a simulation of a model at a high abstraction level. A secondary s-DCP with enhanced accuracy can be obtained by collecting inputs and outputs of the design objects in the DUV during this simulation.

In another specific example for s-DCP accuracy enhancement, an s-DCP with enhanced accuracy can be obtained through time alignment between at least two pieces of dynamic information of all design objects, which can collectively form a model at a low abstraction level, described at the low abstraction level. The dynamic information can be collected from at least two parallel simulations executed for at least two models at a mixed abstraction level. This can include a larger number of design objects described at a high abstraction level and a smaller number of design objects described at the low abstraction level. The time alignment for dynamic information is to align all pieces of dynamic information in time domain when dynamic information of each of design objects at the low abstraction level is skewed in time domain due to the inaccuracy of the model at the high abstraction level. The time alignment can be done efficiently at a transaction level because the beginning of a specific transaction could be a reference point. The beginning of the transaction can be detected from dynamic information of at least one design object in a model. This can be is collected from at least one simulation of at least one model. In another specific example for s-DCP accuracy enhancement, dynamic information of design objects in a model can be collected from a simulation of a model at the high abstraction level or from at least two parallel simulations executed for at least two models at a mixed abstraction level. This can include a larger number of design objects described at a high abstraction level and a smaller number of design objects described at the low abstraction level. This may also be used as the expected input and output of each local simulation in distributed-processing-based execution and compared with the actual input and output of the local simulation at a transaction level.

The expected input and the expected output may be different with the actual input and the actual output, respectively, by a pin-level cycle unit but may be the same by a unit of multiple cycles at a transaction level. Accordingly, when the comparison between the expected input and the actual input or the comparison between the expected output and the actual output is performed by the unit of multiple cycles at the transaction level instead of the pin-level cycle unit, the accuracy of an s-DCP can be enhanced. In particular, since enhancing the accuracy of an s-DCP incurs more overhead at the cycle-unit pin level than at the transaction level, when the comparison is performed at the accuracy of an s-DCP in transaction unit, the accuracy of the s-DCP can be effectively enhanced through, for example, a process of detecting whether an expected value, i.e., an expected input or output, violates the on-chip bus protocol and correcting the expected value when necessary.

In detail, the comparison between an actual value and an expected value is performed in a transaction unit first to find an expected transaction matching an actual transaction. The actual transaction is compared with the matching expected transaction in a cycle unit to determine whether the expected transaction is the same as the actual transaction. In other words, when the expected value is compared with the actual value in a transaction unit, the expected transaction is compared with the actual transaction based on transaction semantics instead of absolute simulation time. For example, even though the start time and end time of a specific expected transaction are 1,080 ns and 1,160 ns, respectively, and the start time and end time of a specific actual transaction are 1,000 ns and 1,080 ns, respectively, the two transactions should match if their transaction semantics is the same. A mismatch, or difference, in the absolute simulation time between the expected transaction and the actual transaction may come from the inaccuracy of a model at a high abstraction level or the loss of information by abstraction. Therefore, these factors are taken into account in matching between an expected value and an actual value. Also, between transactions at different abstraction levels or between a transaction at a specific abstraction level and an event sequence at an RTL, their appearing order as well as their simulation times can be different. For example, between a transaction T_timed={T1, T2, T3, T4} at a timed-transaction level and its refined transaction T_ca={T3, T1, T4, T2} at a ca-transaction level where T3={t31, t32}, T1={t11, t12, t13, t14}, T4={T41, t42}, and T2={t21, t22, t23} (where tij is a cycle-unit ca-transaction, for example, timed-transaction T3 is made of two ca-transactions t31 and t32), simulation time is different. Accordingly, this factor needs to be considered in matching between an expected value and an actual value at a transaction level. Such a process of enhancing s-DCP accuracy using a transaction-level s-DCP is referred to as “s-DCP accuracy enhancement by transaction transformation”.

Such s-DCP accuracy enhancement by a transaction transformation may be applied to dynamic information obtained from a simulation model at a high abstraction level during the execution of a local simulation, in particular, when an s-DCP is a simulation model at the high abstraction level.

According to the above-described simulation using expected inputs and expected outputs, the performance of distributed parallel simulation using at least two processors can be increased. In addition, even when simulation using a single processor, for example, which may include a multi-core from Intel Corporation, needs to be divided into at least two processes or threads, inter-process communication overhead and process synchronization overhead between the at least two processes or threads can be dramatically reduced.

Even in distributed parallel simulation using expected inputs and outputs according to some embodiments of the inventive concept, if expected values are incorrect, conventional distributed parallel simulation using actual inputs and actual outputs is executed in the run-with-actual input/output mode. In this conventional distributed parallel simulation using actual inputs and actual outputs, as described above, excessive communication overhead may occur during communication. Methods of reducing the excessive communication overhead in such circumstances are described below.

In first approach, actual inputs and actual outputs are used together with expected inputs and expected outputs in a distributed parallel simulation executed in the run-with-actual input/output mode. Even when an expected output is different from an actual output, they are not entirely different but can be somewhat different. In other words, since an expected output is obtained from simulation of a model at a high abstraction level, the expected output is, if different, very partially different from an actual output during most of simulation time. Therefore, if values of the actual output different from the expected output and position information of the different values is transmitted instead of the entire actual output, then communication overhead between local simulations can be greatly reduced.

The above approach is described in detail herein using the above-described example of communication in distributed parallel simulation. In the example, for the distributed parallel simulation for design in which 128-bit outputs A[127:0] and B[127:0] exist in a design object X, a 128-bit input C[127:0] exists in a design object Y, a 128-bit input D[127:0] exists in a design object Z, the output A[127:0] and the input C[127:0] are connected with each other, and output B[127:0] and the input D[127:0] are connected with each other, three local design objects for respective first through third local simulations are defined as the design object X, the design object Y, and the design object Z, respectively, through the partition.

It is assumed that zero-th bit A[0] among the 128 bits A[127:0] and tenth bit B[10] among the 128 bits B[127:0] are different between an actual output and an expected output. Instead of two data items of 128 bits corresponding to the entire actual outputs, only actual values different from the expected output and their position information, i.e., the actual value and position of the zero-th bit in vector A, and the actual value and position of the tenth bit in vector B, are transmitted from the first local simulation to the second and third simulations, respectively.

In general, when local design objects are defined through a partition for a distributed parallel simulation, connections among the local design objects can be complex. That is, a great number of signals can be used for the connection among the local design objects. In such a situation, transmitting only values of an actual output different from an expected output in communication can provide for a very effective method with respect to the dramatic reduction of communication overhead.

A local simulation can receive only values of the actual output different from the expected output and combine the received values into the expected input already existing in the local simulation to completely reproduce the entire actual input. This can include an actual output in the point of view of a local simulation transmitting it and is an actual input in the point of view of a local simulation receiving it. The local simulation can use the reproduced actual input as its correct input.

In a distributed parallel simulation that does not use expected inputs and expected outputs, communication overhead among local simulations may be reduced by comparing current values with logic values used in previous communication and transmitting only different value information and position information of a different value.

This is described in detail using the above-described example. It is assumed that logic values are transmitted from design object X to design objects Y and Z at two consecutive simulation times of 1,000,000 ns and 1,000,002 ns through communication in a distributed parallel simulation. It is also assumed that a value transmitted from the vector A[127:0], i.e., an output of design object X, to the vector C[127:0], i.e., an input of design object Y, at the simulation time of 1,000,000 ns is a decimal number of 0, a value transmitted from the vector B[127:0], i.e., another output of design object X, to the vector D[127:0], i.e., an input of design object Z, at the simulation time of 1,000,000 ns is also a decimal number of 0, a value transmitted from the vector A[127:0] to the vector C[127:0] at the simulation time of 1,000,002 ns is a decimal number of 1, and a value transmitted from the vector B[127:0] to the vector D[127:0] at the simulation time of 1,000,002 ns is a decimal number of 256.

In this case, when the first local simulation having a design object X as a local design object communicates at the simulation time of 1,000,002 ns with the second and third local simulations respectively having design objects Y and Z as local design objects, instead of transmitting data of 256 bits made of the decimal number 1 of A[127:0] of 128 bits and the decimal number 256 of B[127:0] of 128 bits, the first local simulation compares the decimal number 1 of A[127:0] of 128 bits and the decimal number 256 of B[127:0] of 128 bits with the decimal number 0 of A[127:0] of 128 bits and the decimal number 0 of B[127:0] of 128 bits, which are used at the previous simulation time of 1,000,000 ns. Only two types of information are transmitted: information about a different logic value and position information thereof, i.e., 1 corresponding to a value of the zero-th bit A[0] and 0 corresponding to the position of the zero-th bit, and 1 corresponding to a value of the eighth bit B[0] and 8 corresponding to the position of the eighth bit. This is an effective method of significantly reducing communication overhead without using expected inputs and expected outputs.

FIG. 5 is a conceptual diagram of the hierarchy of an ESL model 37 and its corresponding hierarchy of an RTL model 40. The ESL model 37 may be used as a high abstraction level model MODEL_DUV(HIGH). It includes an on-chip bus 42 and a plurality of design objects 38 interconnected to each other via the on-chip bus 42. The design objects 38 represent design blocks.

The RTL model 40 may be used as a low abstraction level model MODEL_DUV(LOW). The RTL model 40 includes an on-chip bus design object 420 including a bus arbiter and an address decoder and a plurality of design objects 380 through 385. The design objects 380 through 385 each includes at least one design module 39. The design objects 38 representing a design block may correspond to the design objects 380 through 385 representing a design module.

FIG. 6 is a conceptual diagram of the hierarchy of an RTL model 37 and its corresponding hierarchy of a GL model 370. The RTL model 37 may be used as the high abstraction level model MODEL_DUV(HIGH). It includes an on-chip bus 42 and a plurality of design objects 38. The design objects 38 represent design blocks.

The GL model 370 includes a design object 387 representing an additional hierarchical structure including a boundary scan cell. The design object 387 represents a design module that does not exist in the RTL model 37 but exists in the GL model 370. The design object 387 may include an on-chip bus 42 and a plurality of design objects 38 representing a design block.

FIG. 7 is a conceptual diagram of a computer network including a plurality of computers 100-1 through 100-I that can execute a distributed parallel simulation according to some embodiments of the inventive concept. The computers 100-1 through 100-I are connected by a network for the execution of distributed parallel simulation. The computers 100-1 through 100-I include a simulator 343 that can perform a local simulation in a distributed parallel simulation environment. Reference numerals 380-1 through 380-I denote local design objects, respectively.

Verification S/W 30 may be installed in all of the computers 100-1 through 100-1 or only in the computer 100-1. Each of the computers 100-1 through 100-I is an example of a design verification apparatus.

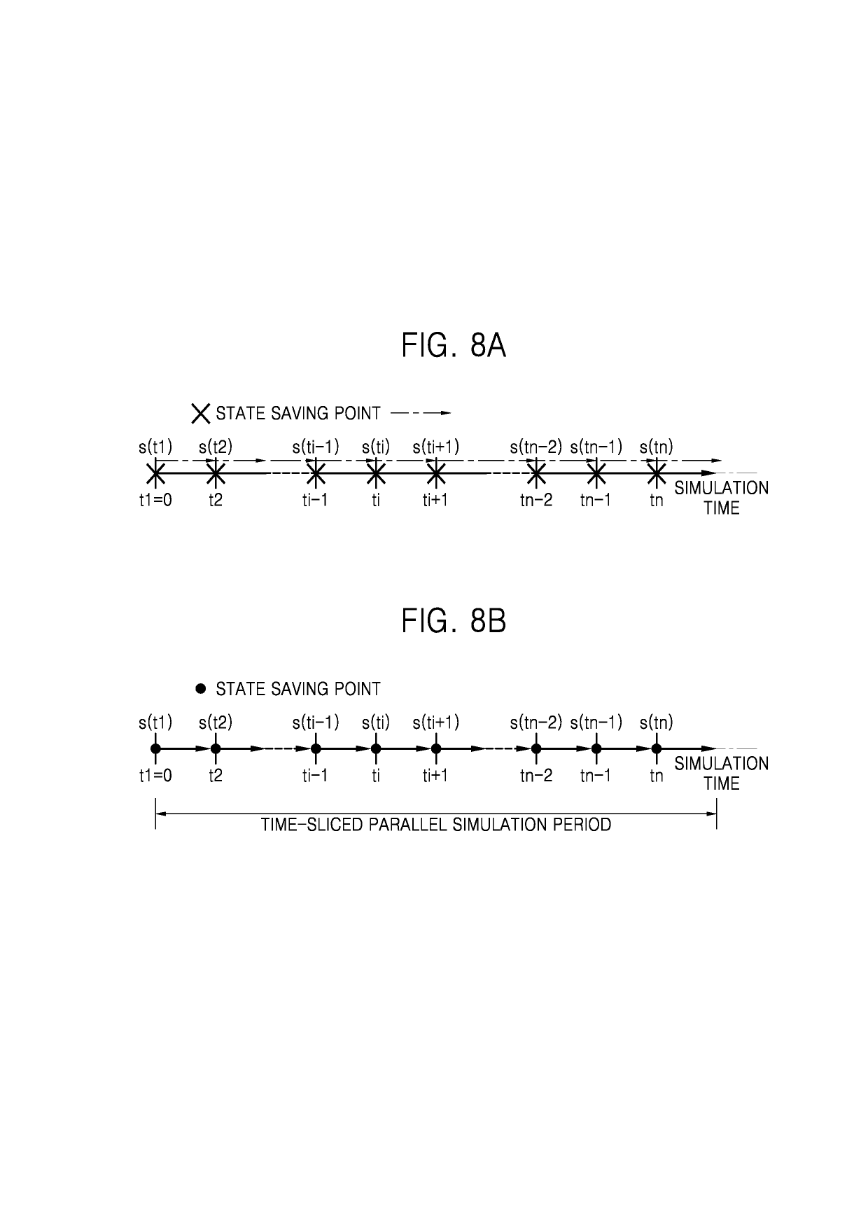

FIGS. 8A and 8B are conceptual diagrams of an example in which a t-DCP is obtained in a front-end simulation using a model at a high abstraction level and a rear-end simulation using a model at a low abstraction level is carried out by TPE. FIG. 8A shows a state (information) saving point s(tn) in each simulation time “tn” in the front-end simulation of the model high abstraction level. FIG. 8B shows a time-sliced parallel simulation period.

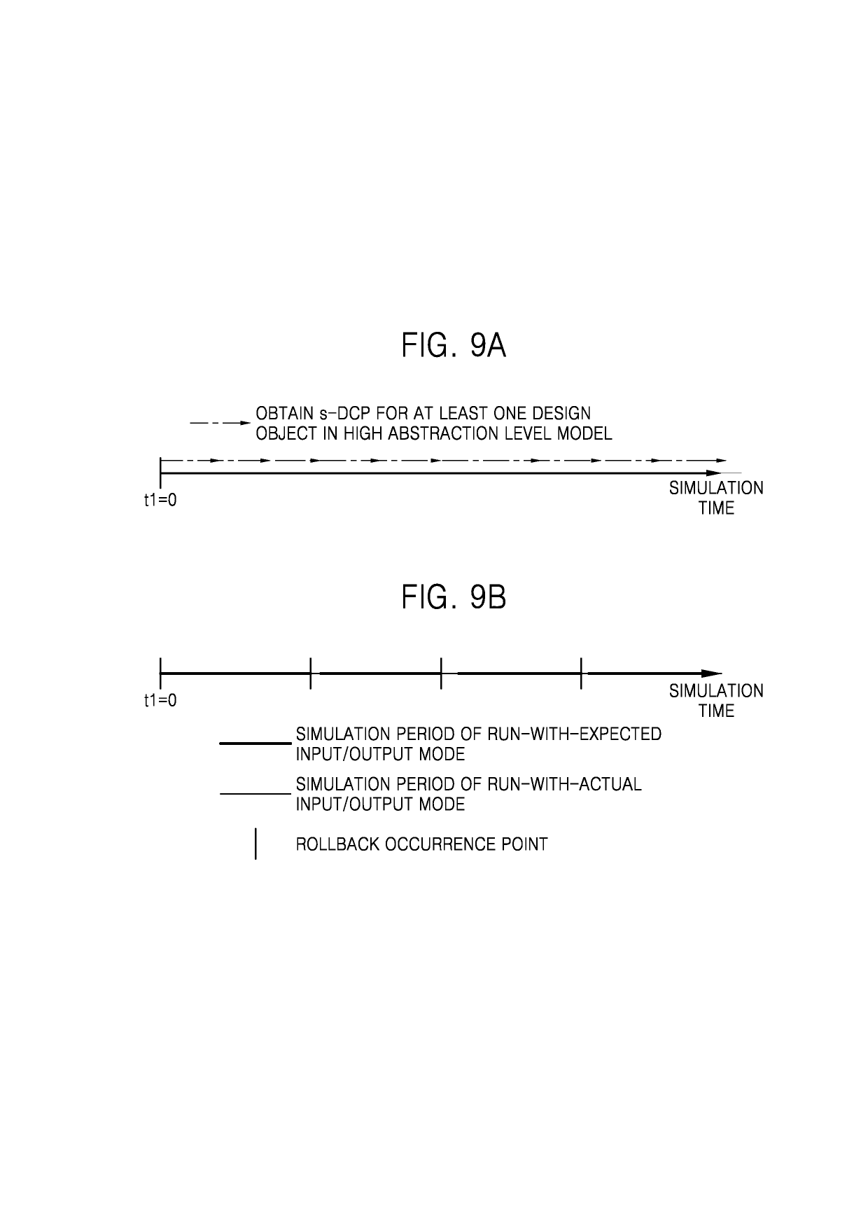

FIGS. 9A and 9B are conceptual diagrams of an example in which an s-DCP is obtained in a front-end simulation using a model at a high abstraction level and a rear-end simulation using a model at a low abstraction level carried out by DPE. FIG. 9A shows simulation time in a process of obtaining the s-DCP in the front-end simulation of a high abstraction level model. FIG. 9B shows simulation time in the DPE of the front-end simulation of the high abstraction level model.

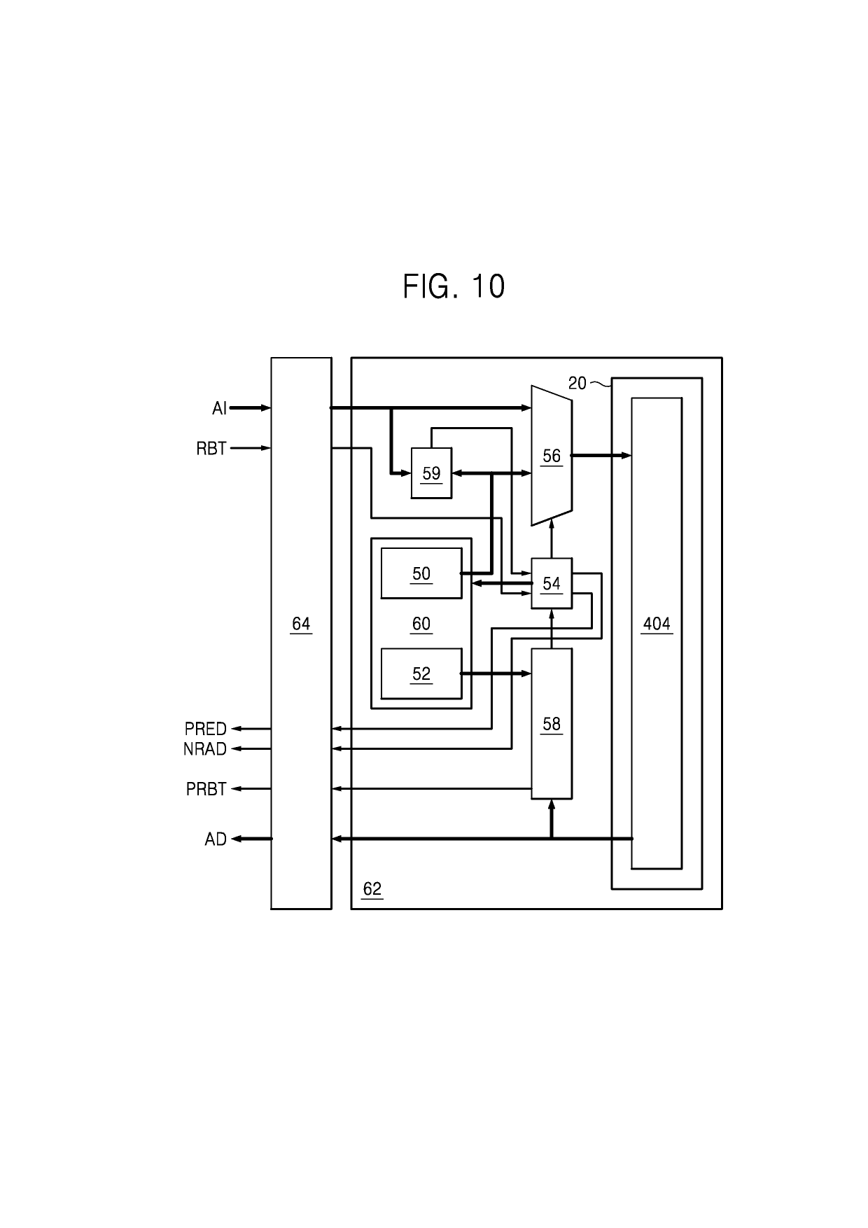

FIG. 10 is a conceptual diagram of components included in a set of extra code added for a distributed-processing-based parallel simulation according to some embodiments of the inventive concept. FIG. 10 schematically shows an example of the components constituting a behavior of an extra code 62 added to a part 404 of a model for verification, for example, parts of the model for verification may be combined together into the complete model, executed in each local simulator or local hardware-based verification platform in the distributed parallel simulation environment. Examples can include but not limited to a hardware emulator, a simulation accelerator, or an FPGA board, such as Palladium/Extreme series from Cadence Design Systems, Vstation series from Mentor Graphics Corp., Hammer series from Tharas Systems, Inc., Gemini series from Fortelink, Inc. SystemExplorer series from Aptix, Inc. ZeBu series from EVE, Inc., HES series from Aldec Corp., CHIPit series from ProDesign, Inc. HAPS series from Hardi Electronics AB, or IP porter series from S2C, Inc.

The extra code 62 is added as verification software to a design code subjected to verification. The extra code 62 is added to the model 404 to perform the function of the components including a run-with-expected input/output & run-with-actual input/output control module 54, an expected input/actual input select module 56, an expected output/actual output comparison module 58, an expected input/actual input comparison module 59, and an s-DCP generation/saving module 60. The behavior of each of the modules 54, 56, 58, 59, and 60 is described below.

The run-with-expected input/output & run-with-actual input/output control module 54 receives inputs from the expected output/actual output comparison module 58, the expected input/actual input comparison module 59, and a communication/synchronization module 64 for distributed parallel simulation. The run-with-expected input/output &run-with-actual input/output control module 54 provides an output for the expected input/actual input select module 56 based on values of the inputs and a current state indicating whether a current local simulation is run in the run-with-expected input/output mode or the run-with-actual input/output mode. In this manner, the expected input/actual input select module 56 selects an expected input or an actual input or controls rollback when rollback is necessary before selecting the actual input. The run-with-expected input/output & run-with-actual input/output control module 54 has state variables based on which whether the local simulation is run in the run-with-expected input/output mode or the run-with-actual input/output mode.

In FIG. 10, AI denotes an actual input, RBT a rollback time, PRED a possibility of run-with-expected data, NRAD a necessity of run-with-actual data, PRBT a possible rollback time, and AD an actual output.

When the run-with-expected input/output & run-with-actual input/output control module 54 receives a decision indicating that an expected output does not match the actual output AD, while a current local simulation is being executed in the run-with-expected input/output mode and the run-with-expected input/output & run-with-actual input/output control module 54 are controlling the expected input/actual input select module 56 to select the expected input, the run-with-expected input/output & run-with-actual input/output control module 54 can provide an output for the expected input/actual input select module 56 to select the actual input AI. The run-with-expected input/output & run-with-actual input/output control module 54 can also switch a current state variable from a run-with-expected input/output to a run-with-actual input/output, and upon receiving a specific rollback time RBT from the communication/synchronization module 64, control a rollback to the specific rollback time RBT. When the run-with-expected input/output & run-with-actual input/output control module 54 receives a decision indicating that an expected output matches the actual output AD at least a predetermined number of times while a current local simulation is being executed in the run-with-actual input/output mode and thus the run-with-expected input/output & run-with-actual input/output control module 54 are controlling the expected input/actual input select module 56 to select the actual input AI, the run-with-expected input/output & run-with-actual input/output control module 54 can provide an output for the expected input/actual input select module 56 to select the expected input and switch a current state variable from the run-with-actual input/output to the run-with-expected input/output.

Also, the run-with-expected input/output & run-with-actual input/output control module 54 can send two outputs, due to the necessity of run-with-actual data NRAD and the possibility of run-with-expected data PRED, to the communication/synchronization module 64 to inform the other local simulations of the current state through the communication/synchronization module 64 and controls the s-DCP generation/saving module 60 to output an expected input or an expected output at a right timing.

The expected output/actual output comparison module 58 compares the expected output from the s-DCP generation/saving module 60 with the actual output AD obtained from the part 404 of the model subjected to design verification, which is executed in a local simulation, provides the run-with-expected input/output & run-with-actual input/output control module 54 with an output indicating the match between the expected output and the actual output AD or an output indicating the mismatch therebetween, and simultaneously sends a current simulation time for a rollback to the communication/synchronization module 64 so that the communication/synchronization module 64 transmits the information, i.e., the current simulation time for rollback, to other local simulations.

The expected input/actual input comparison module 59 compares the expected input from the s-DCP generation/saving module 60 with the actual input Al, which is obtained from at least one other local simulation and received through the communication/synchronization module 64. When the expected input matches the actual input AI at least a predetermined number of times, the expected input/actual input comparison module 59 provides the run-with-expected input/output & run-with-actual input/output control module 54 with an output indicating the occurrence of the predetermined number of matches.

The expected input/actual input comparison module 59 and the expected output/actual output comparison module 58 determine in response to the comparison a match or mismatch between an expected value and an actual value using a bit signal unit and absolute simulation time and also a time alignment and s-DCP accuracy enhancement by a transaction transformation.

The expected input/actual input select module 56 selects either the actual input AI received from the communication/synchronization module 64 or the expected input from the s-DCP generation/saving module 60 based on the output from the run-with-expected input/output & run-with-actual input/output control module 54 and applies the selected input to the part 404 of the model subjected to verification. The part 404 is executed by a local simulator 20.

When the part 404 of the model is executed in a simulation acceleration mode on a local hardware-based verification platform, the extra code 62 needs to be synthesizable. When the part 404 of the model is executed by a local simulator, the extra code 62 just needs to be in a form readily available for simulation, and therefore, the extra code 62 may be written in HDL, e.g., Verilog or VHDL, SDL, e.g., SystemC or SystemVerilog, C/C++, or any combination thereof. The extra code 62 is automatically generated by verification software according to some embodiments of the inventive concept.

In the embodiments illustrated in FIG. 10, the entire extra code 62 exists as a C/C++ code or SystemC code outside an HDL simulator and interfaces with the part 404 of the model written in HDL through VPI/PLI/FLI. However, as described above, a part of the extra code 62 may be written in HDL while the remaining of the extra code 62 is written in C/C++ or SystemC.

In FIG. 10, the communication/synchronization module 64 can include a communication and synchronization module necessary for distributed parallel simulation.

As described above, in some embodiments, the s-DCP stored in the s-DCP generation/saving module 60 includes input/output information of a local design object executed in a current local simulation. The input/output information is obtained from dynamic information obtained from a previous simulation and can be used as an expected input 50 and an expected output 52.

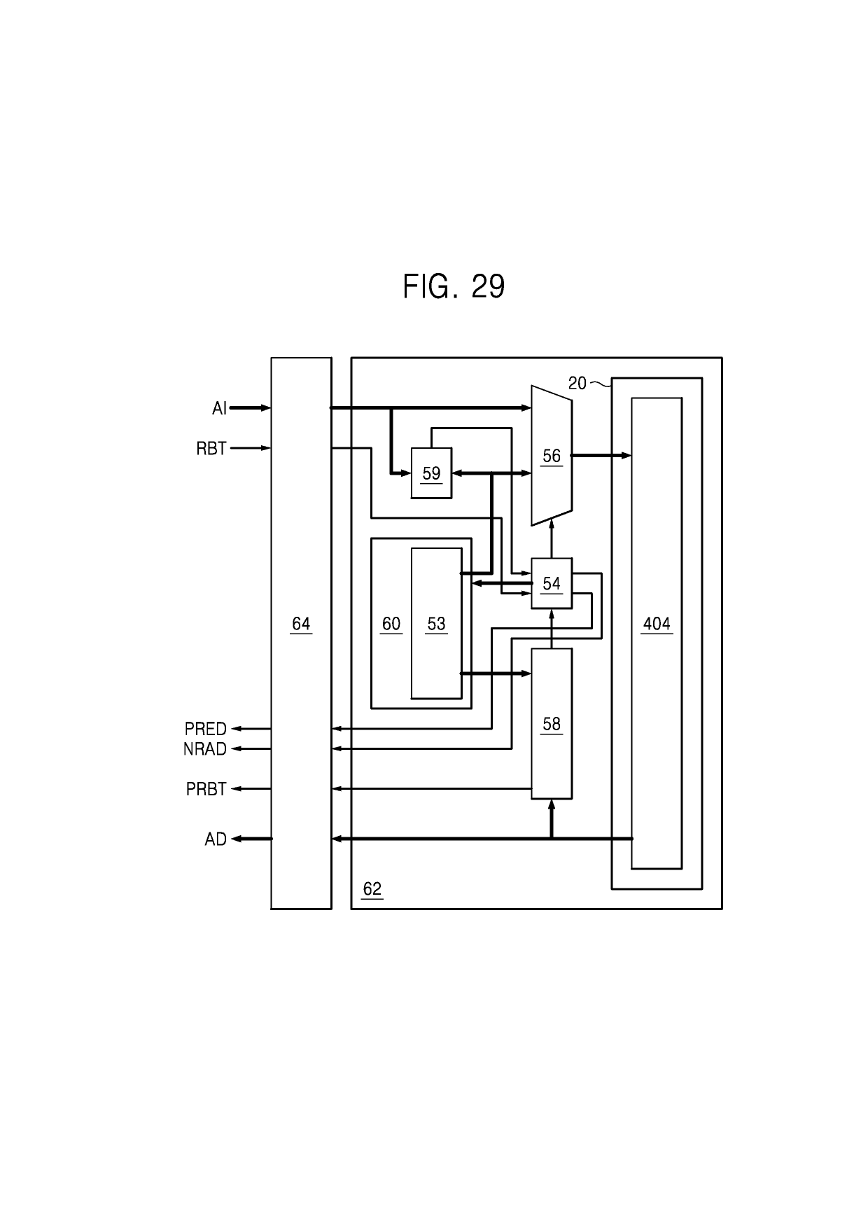

The expected input 50 and the expected output 52 may be saved as a file so that they can be read in HDL (e.g., Verilog $readmemb or $readmemh) or in C/C++ using VPI/PLI/FLI. A high abstraction level model may be included in the s-DCP. In this case, while the high abstraction level model is simulated together with a local design object corresponding to a low abstraction level model, an expected input and an expected output may be dynamically generated from the high abstraction level model and used for the simulation of the local design object, shown for example at FIG. 29.

When an extra code for each local simulation in distributed-processing-based parallel simulation is created in the structure illustrated in FIG. 10 or 29, every local simulation may be consistently executed all together in the run-with-expected input/output mode or each local simulation may be independently executed in the run-with-expected input/output. For example, some local simulations may be executed in the run-with-actual input/output mode while the remaining local simulators are executed in the run-with-expected input/output mode.

When every local simulation is consistently executed in the run-with-expected input/output mode, there is no communication overhead and synchronization overhead. When each local simulation is independently executed in the run-with-expected input/output, communication overhead and synchronization overhead may not be completely removed from an entire distributed parallel simulation but can be significantly reduced.

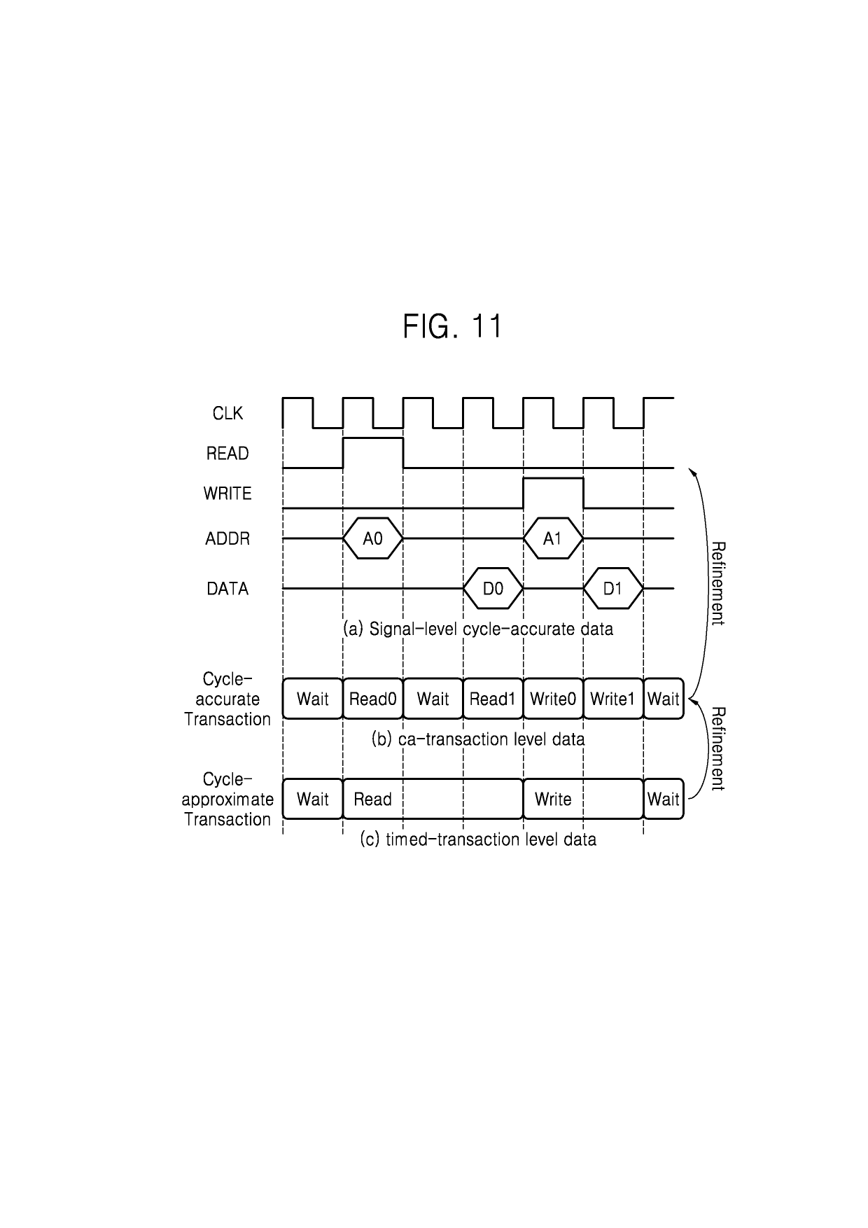

FIG. 11 is a timing chart of signal-level cycle-accurate data and transaction-level data at a transaction level. FIG. 11 shows a clock signal CLK, a read command READ, a write command WRITE, an address ADDR, and data DATA.

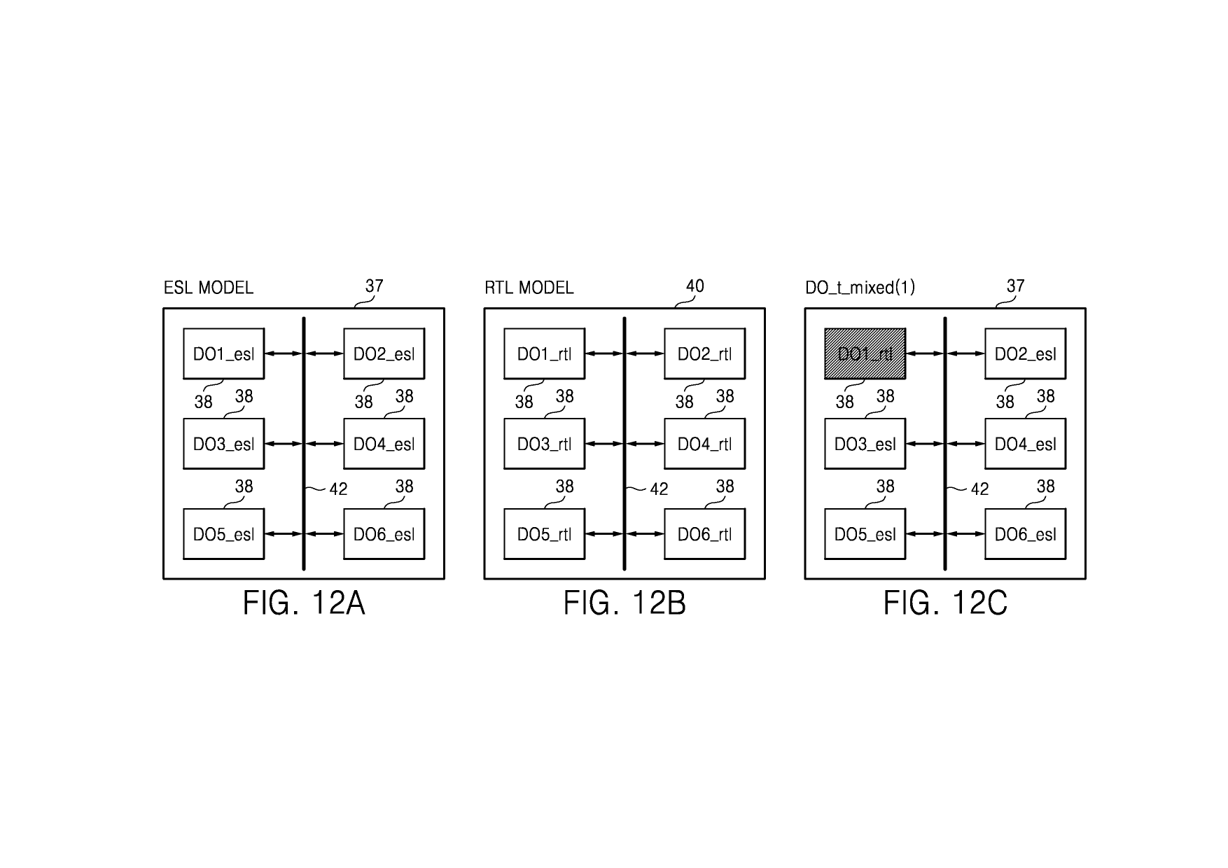

FIGS. 12A through 12C are schematic diagrams of design objects in the ESL model 37 shown in FIG. 5, design objects in the RTL model 40 shown in FIG. 5, and mixed design objects at a medium abstraction level. The ESL model 37 can include a plurality of design objects DO1_esl through DO6_esl. The RTL model 47 can include a plurality of design objects DO1_rtl through DO6_rtl. A mixed model DO_t_mixed(1) can include a plurality of design objects DO1_rtl and DO2_esl through DO6_rtl. A progressive refinement process, for example, described herein, can be applied for refining the design object DO1_esl the design object DO1_rtl.

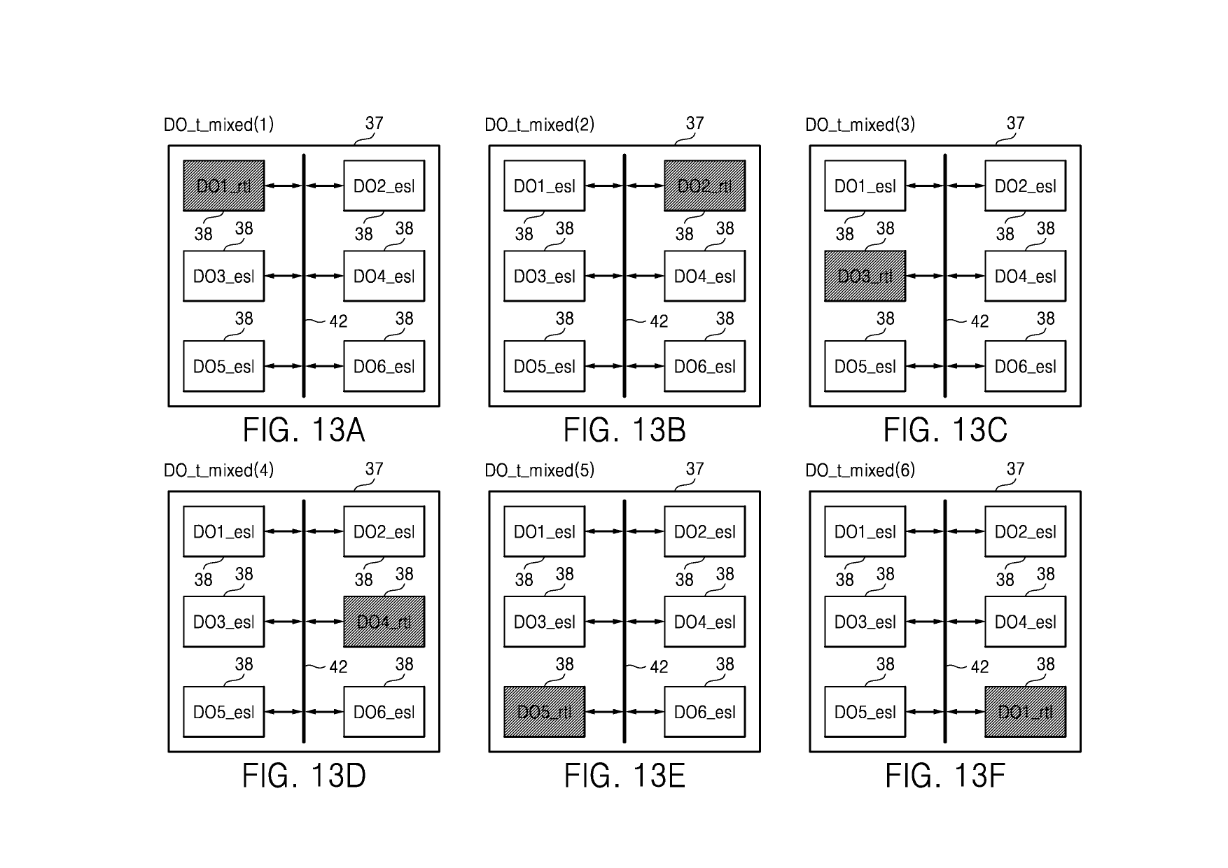

FIGS. 13A through 13F are conceptual diagrams for illustrating a method of generating mixed design objects at the medium abstraction level by replacing each of the design objects in the ESL model 37 shown in FIG. 12A with a corresponding one of the design objects in the RTL model 40 shown in FIG. 12B. Referring to FIGS. 13A through 13F, when a model, e.g., DO_t_mixed(2), at the mixed ESL/RTL abstraction level is generated from the ESL model 37 using a progressive refinement process, although simulation speed for the model at the mixed ESL/RTL abstraction level is much lower than simulation speed for the ESL model at the high abstraction level, the simulation speed for the model at the mixed ESL/RTL abstraction level can be increased using DPE according to some embodiments of the inventive concept.

For instance, when two local simulations are constructed for the mixed model DO_t_mixed(2) in a distributed parallel simulation using DPE, a transactor is executed for conversion from a transaction level to the RTL for the design object DO2_rtl in one local simulation, and the remaining transaction-level design objects are executed in the other local simulation. A simulation speed for the model DO_t_mixed(2) at the mixed ESL/RTL abstraction level can be effectively increased as compared to the model DO_t_mixed(2) when executed in a single simulation.

The simulation speed for a mixed abstraction level model can be increased using three or more local simulations in a distributed parallel simulation using DPE.

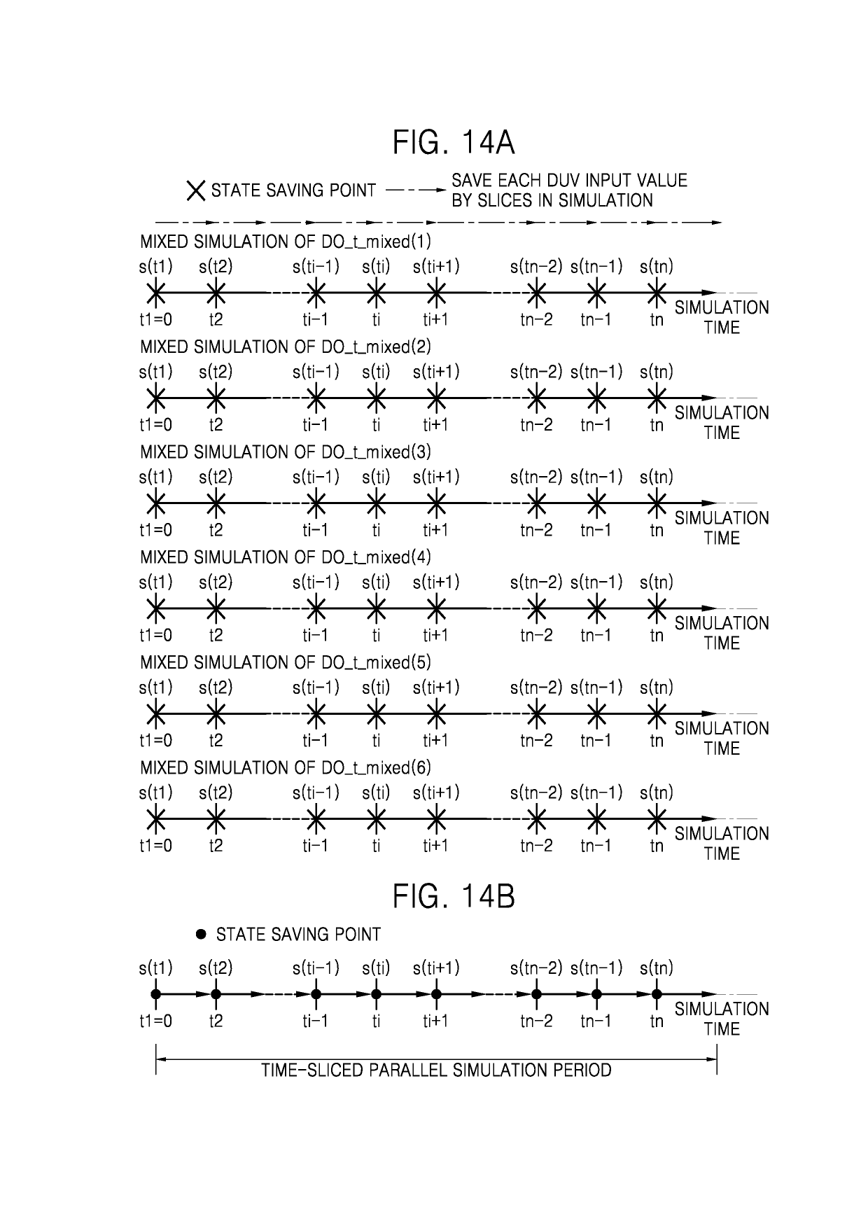

FIGS. 14A and 14B are conceptual diagrams that illustrate an embodiment in which six mixed simulations of six respective mixed design objects shown in FIGS. 13A through 13F are independently executed in parallel and a time-sliced parallel simulation of the RTL model is executed as a back-end simulation using state information collected at least one simulation time or period during the parallel simulation.

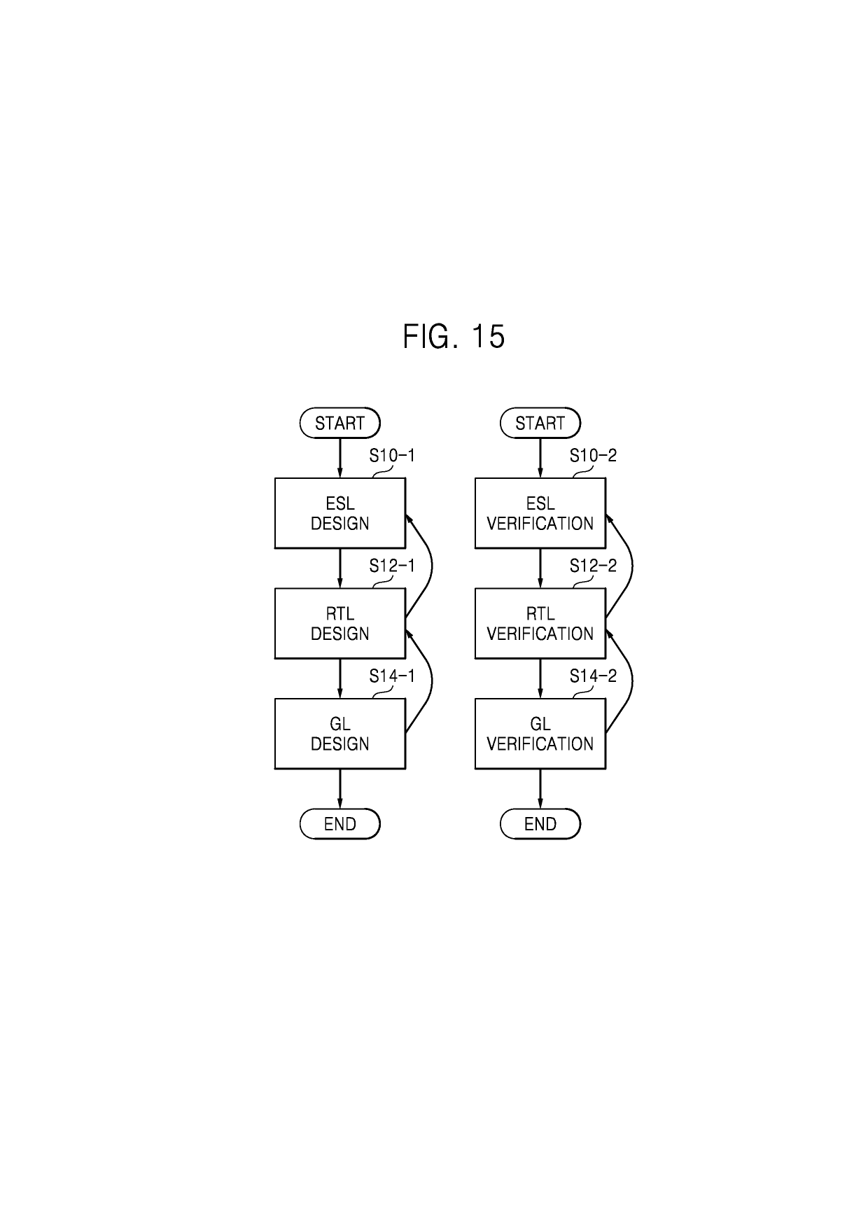

FIG. 15 is a conceptual diagram of the design process and the verification process which proceed through a progressive refinement process from the initial level of abstraction to the final level of abstraction according to some embodiments of the inventive concept.

FIG. 16 is a conceptual diagram of a method of generating a GL model from a transaction level model via an RTL model using a progressive refinement process according to some embodiments of the inventive concept.

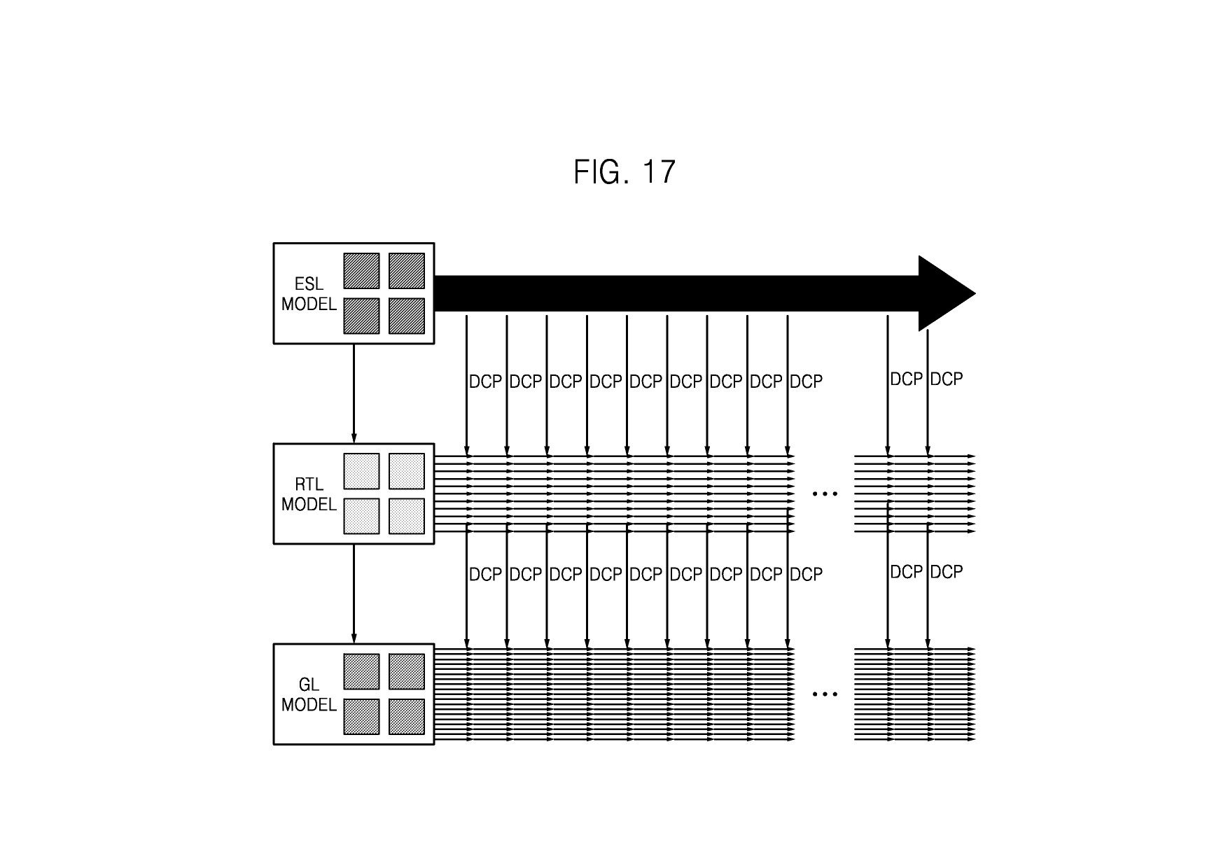

FIG. 17 is a conceptual diagram of a method of executing a distributed-processing-based parallel simulation or time-sliced parallel simulation of a model at a low abstraction level using an s-DCP or a t-DCP in a progressive refinement process in which verification using a transaction-level cycle-accurate model, verification using an RTL model and verification using a GL model are performed sequentially. In FIG. 17, DCP denotes s-DCP and/or t-DCP.

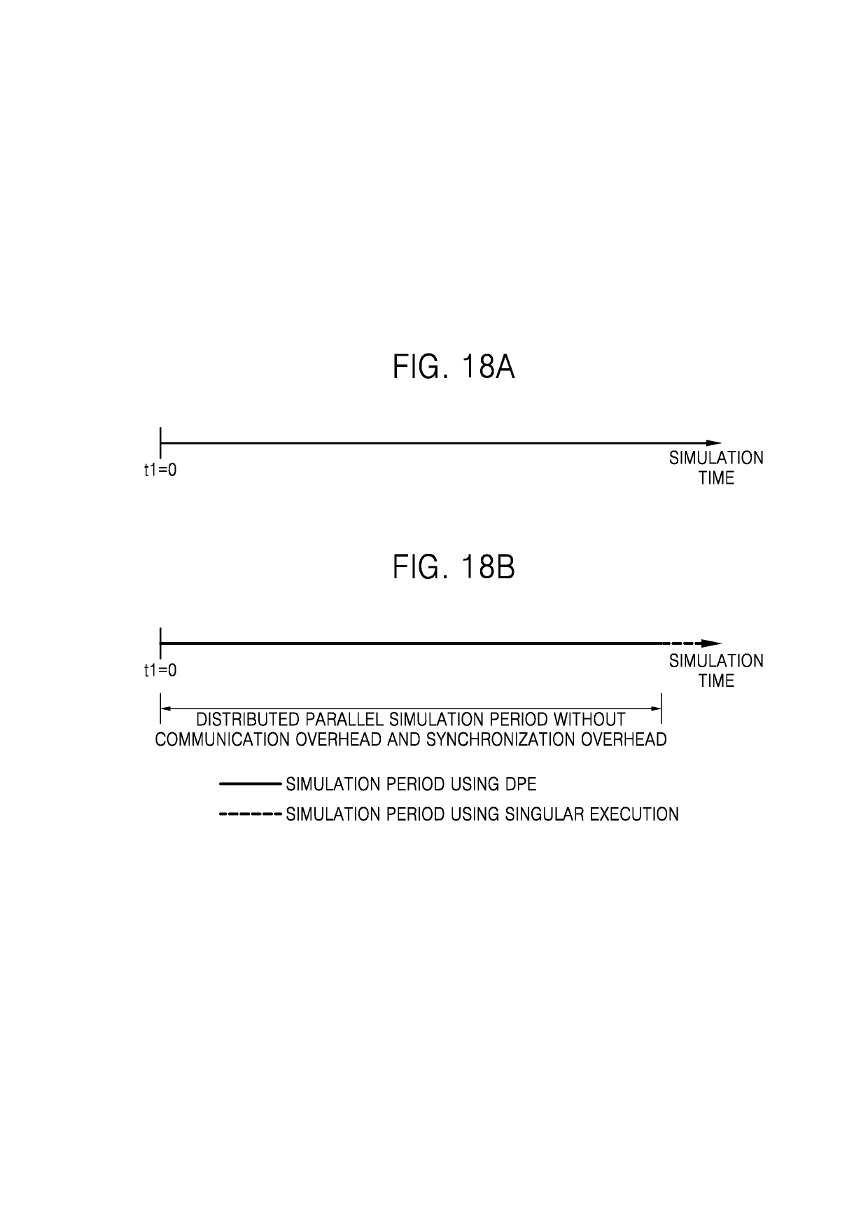

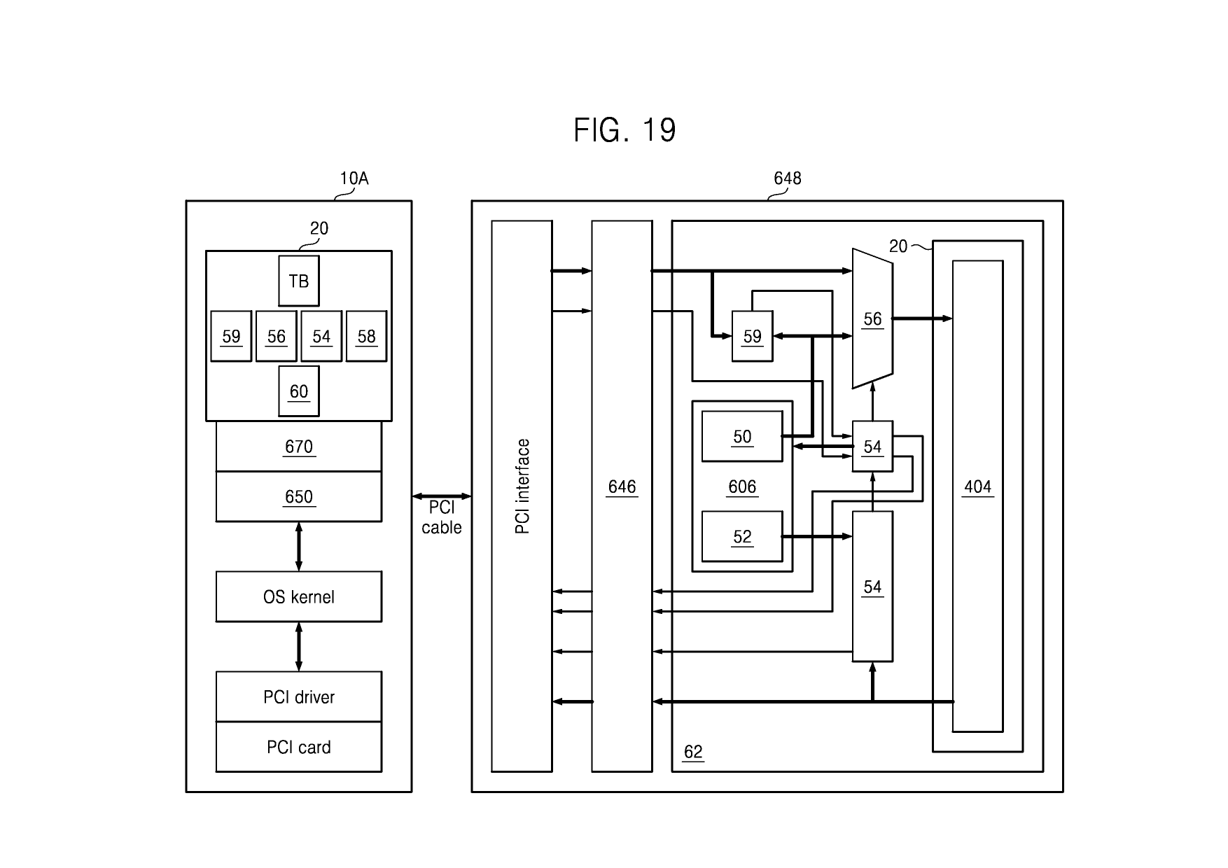

FIGS. 18A and 18B are conceptual diagrams for explaining a combined method of DPE and singular execution. Referring to FIG. 18A, an s-DCP is obtained in a simulation temporally prior to the combined simulation of DPE and singular execution. Referring to FIG. 18B, a simulation of a model at a specific abstraction level is executed in the combination of DPE and singular execution using the s-DCP obtained in the previous simulation.

FIG. 19 is a conceptual diagram of an example of reducing the synchronization and communication overhead between a simulator and a hardware-based verification platform by carrying out a simulation with simulation acceleration using DPE according to some embodiments of the inventive concept.

When simulation acceleration is used, a synthesizable design object, e.g., DUV, in a model is implemented in at least one FPGA or Boolean processor on the hardware-based verification platform, a non-synthesizable design object, e.g., TB, is implemented in a simulator, The simulator and the hardware-based verification platform can be connected to each other to operate in parallel, for example, via a Peripheral Component Interconnect (PCI) connection or other physical connector. Accordingly, the simulation with the simulation acceleration is the same as a distributed parallel simulation with two local simulations.

Accordingly, DPE according to some embodiments of the inventive concept can be applied to conventional simulation acceleration with no modification, so that communication overhead and synchronization overhead existing between a hardware-based verification platform and a simulator in the conventional simulation acceleration can be minimized.

In a simulation acceleration, an expected input and an expected output used in specific simulation execution SA_run(j) are obtained from dynamic information collected from a previous simulation execution SA_run(i) run temporally prior to the specific simulation execution SA_run(j), as described above. A partial change may occur in at least one design object in a model due to specification change or debugging between SA_run(i) and SA_run(j).

The previous simulation execution SA_run(i) may be run using the hardware-based verification platform on which the specific simulation execution SA_run(j) is run together with a simulator. The previous simulation execution SA_run(i) may be run using only one or more simulators apart from the hardware-based verification platform on which the specific simulation execution SA_run(j) is run. In this case, the entire model is simulated using one or more simulators only. Although the abstraction level of a model simulated using the one or more simulators may be the same as the abstraction level of a design object executed on the hardware-based verification platform, it may be higher than the abstraction level of the design object executed on the hardware-based verification platform in order to increase simulation speed.

For instance, when a design object DUV executed on the hardware-based verification platform is at an RTL, the abstraction level of a model, including DUV, for simulation may be a ca-transaction level. When a design object DUV executed on the hardware-based verification platform is at a GL, the abstraction level of a model, including DUV, for simulation may be an RTL.

In other words, DPE according to some embodiments of the inventive concept can be used even in conventional simulation acceleration, so that at least one time of run-with-expected input/output and when necessary at least one time of run-with-actual input/output may be alternately executed throughout the simulation acceleration. In addition, high-accuracy expected inputs/outputs obtained from dynamic information collected from a previous simulation are used so that the simulation acceleration can be mostly executed in the run-with-expected input/output mode. As a result, communication overhead and synchronization overhead can be greatly reduced and the speed of simulation acceleration can be significantly increased.

In this case, when the capacity of memory in the hardware-based verification platform is large enough to store expected inputs and expected outputs, all of the expected inputs and outputs can be stored in the memory in the hardware-based verification platform. However, when the capacity of memory in the hardware-based verification platform is not large enough, some or all of expected inputs and outputs may be stored in a large-capacity storage device, e.g., hard disk or main memory, at a computer connected with the hardware-based verification platform, a buffer in a predetermined size enough to store some of the expected inputs and outputs may be provided for the hardware-based verification platform. Only necessary expected inputs and outputs are dynamically transferred from the large-capacity storage device on the computer to the buffer in burst during a simulation acceleration.

In a simulation acceleration using DPE according to some embodiments of the inventive concept, a design object (DUV) DO_on_hwp is executed in the hardware-based verification platform using an expected input from a simulation time 0 to a simulation time T_diff(1) when an actual output and an expected output of the design object DO_on_hwp are different from each other while the actual output of the design object DO_on_hwp is compared with the expected output thereof. Thereafter, a design object (usually TB) is executed in a simulator from a simulation time 0 to a simulation time Tdiff(1).

In other words, DUV is executed in the run-with-expected input/output mode from the simulation time 0 to the simulation time Tdiff(1). Then TB is executed in the run-with-expected input/output mode. TB and DUV are independently executed but TB cannot be executed prior DUV. In a cycle, DUV and TB are simultaneously executed in the run-with-actual input/output mode during a period from T_diff(1) to T_match(1), DUV is executed first in the run-with-expected input/output mode. Then TB is executed in the run-with-expected input/output mode during a period from T_match(1) to T_diff(2), in which TB and DUV are independently executed but TB execution cannot come before DUV execution. DUV and TB are simultaneously executed in the run-with-actual input/output mode during a period from T_diff(2) to T_match(2), and DUV is executed first in the run-with-expected input/output mode. Then TB is executed in the run-with-expected input/output mode during a period from T_match(2) to T_diff(3), in which TB and DUV are independently executed but TB execution cannot come before DUV execution. This cycle may be repeated at least once.

In this case, since TB is not executed prior to DUV, rollback for TB is not necessary.

In addition, when an expected input and an expected output are collected from a simulation executed before the simulation acceleration using the DPE, at least one design object in DUV and TB is changed due to debugging or specification change since the execution of the simulation. The at least one design object that has been changed is included in a local simulation executed in the hardware-based verification platform. Rollback for the local simulation on the hardware-based verification platform is not necessary.

Those methods described above may be applied to DPE using only simulators as well as the simulation acceleration using the DPE, so that rollback is not necessary in at least one local simulation. However, as compared to a case requiring rollback, simulation speed may be decreased due to constraints on the execution order of local simulations.

For rollback of a design object executed in a hardware-based verification platform, a rollback feature provided by a commercial hardware-based verification platform, e.g., Palladium series/Extreme series from Cadence Design Systems, Vstation series from Mentor, ZeBu series from EVE, Gemini series from Fortelink, Inc., or Hammer series from Tharas, Inc. can be used, the output-probing input-probing method disclosed in U.S. Pat. No. 6,701,491, incorporated by reference herein in its entirety, can be used, or the shadow register for flip-flops or latches in the design object can be used.

Each local simulation in a distributed parallel simulation environment presented in this inventive concept can be executed by a simulator, or executed in a hardware-based verification platform, e.g., a simulation accelerator, hardware emulator, or FPGA board, if a part of a model for verification, which is executed in the local simulation, is synthesizable. If the simulator is used for the local simulation, the simulator may be an event-driven Verilog simulator, an event-driven SystemVerilog simulator, an event-driven VHDL simulator, an event-driven SystemC simulator, a cycle-based SystemC simulator, a cycle-based VHDL simulator, a cycle-based Verilog simulator, a cycle-based SystemVerilog simulator, a Vera simulator, an e-simulator, or any type of simulator for semiconductor design. Accordingly, in distributed parallel simulation, some local simulations may be event-driven simulations while other local simulations may be cycle-based simulations. For instance, as described with reference to FIG. 5, the on-chip bus design object 420 may be executed in a cycle-based simulation while the other design objects 380 through 385 are executed in event-driven simulations. Also, local simulations may be event-driven simulations, such event-driven distributed parallel simulation being referred to as parallel distributed event-driven simulation (PDES), or all local simulations may be cycle-based simulations.

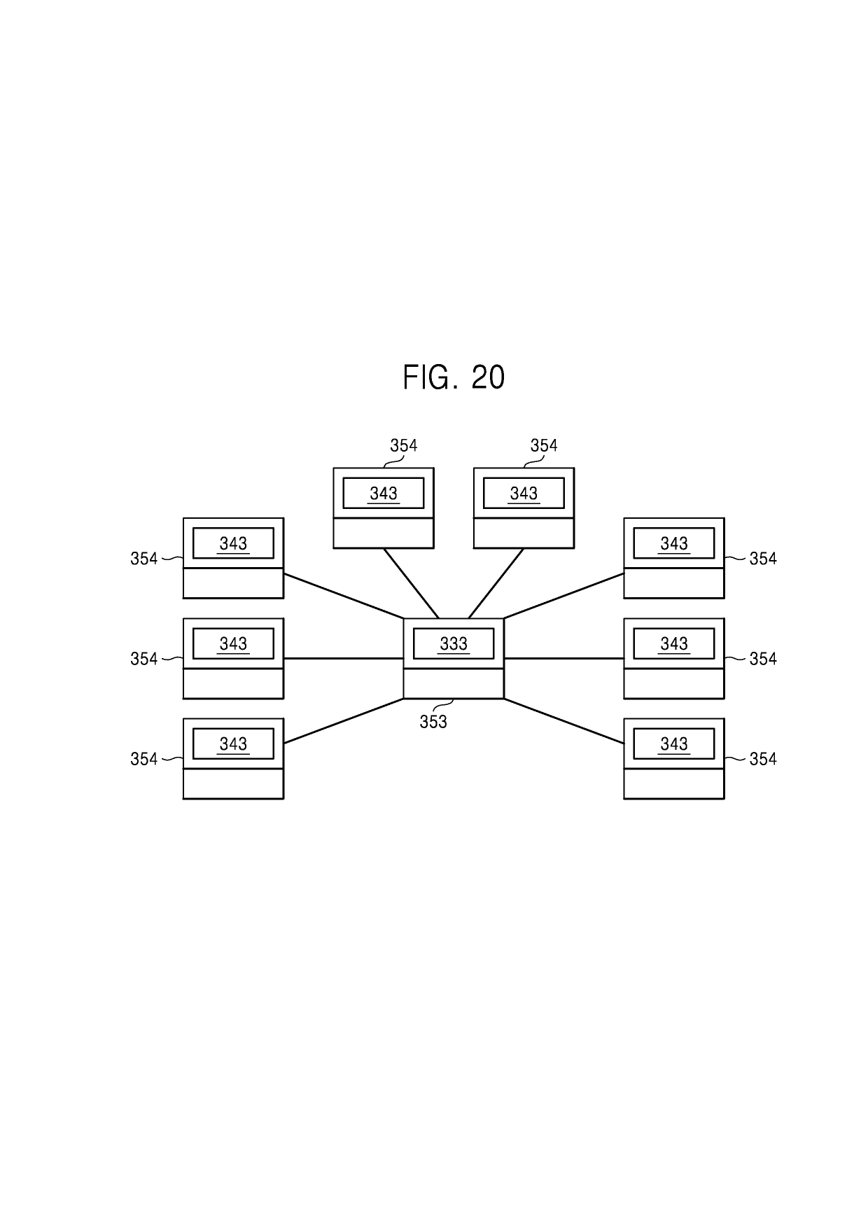

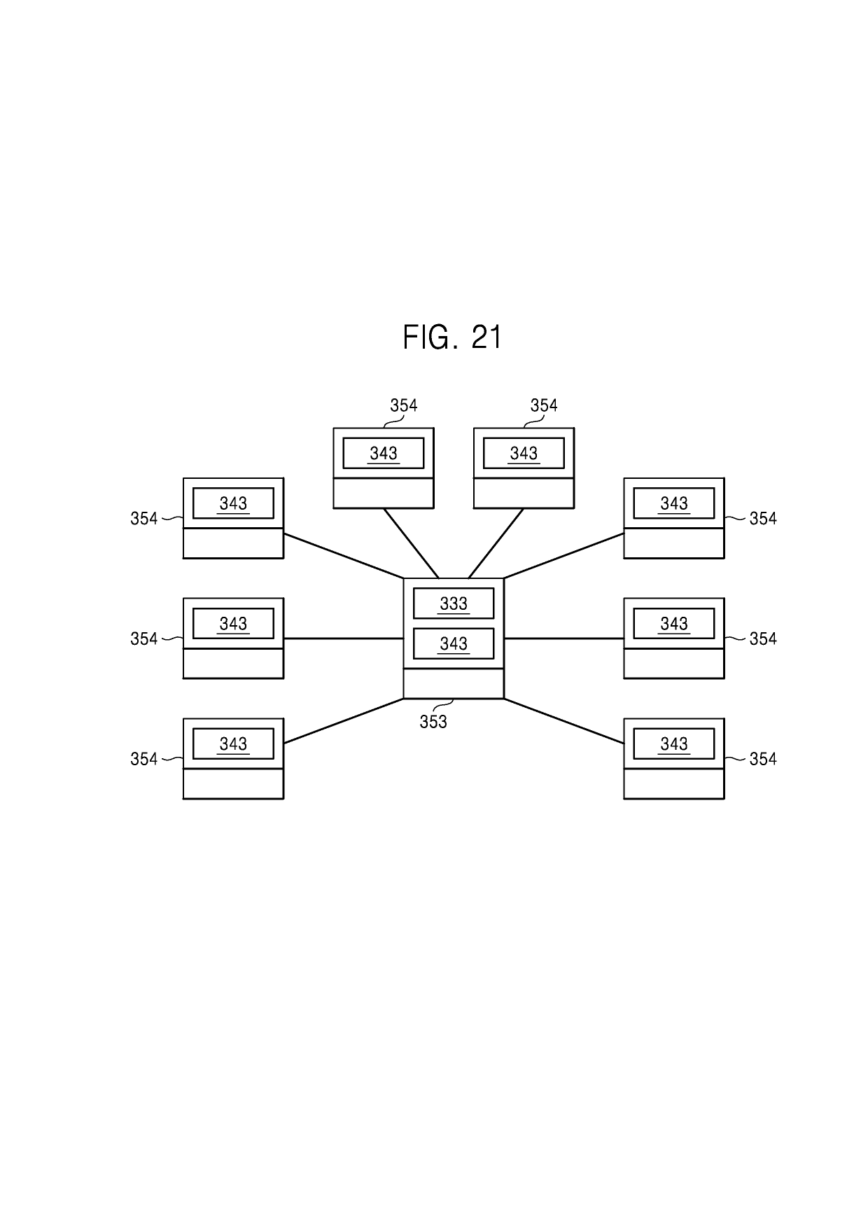

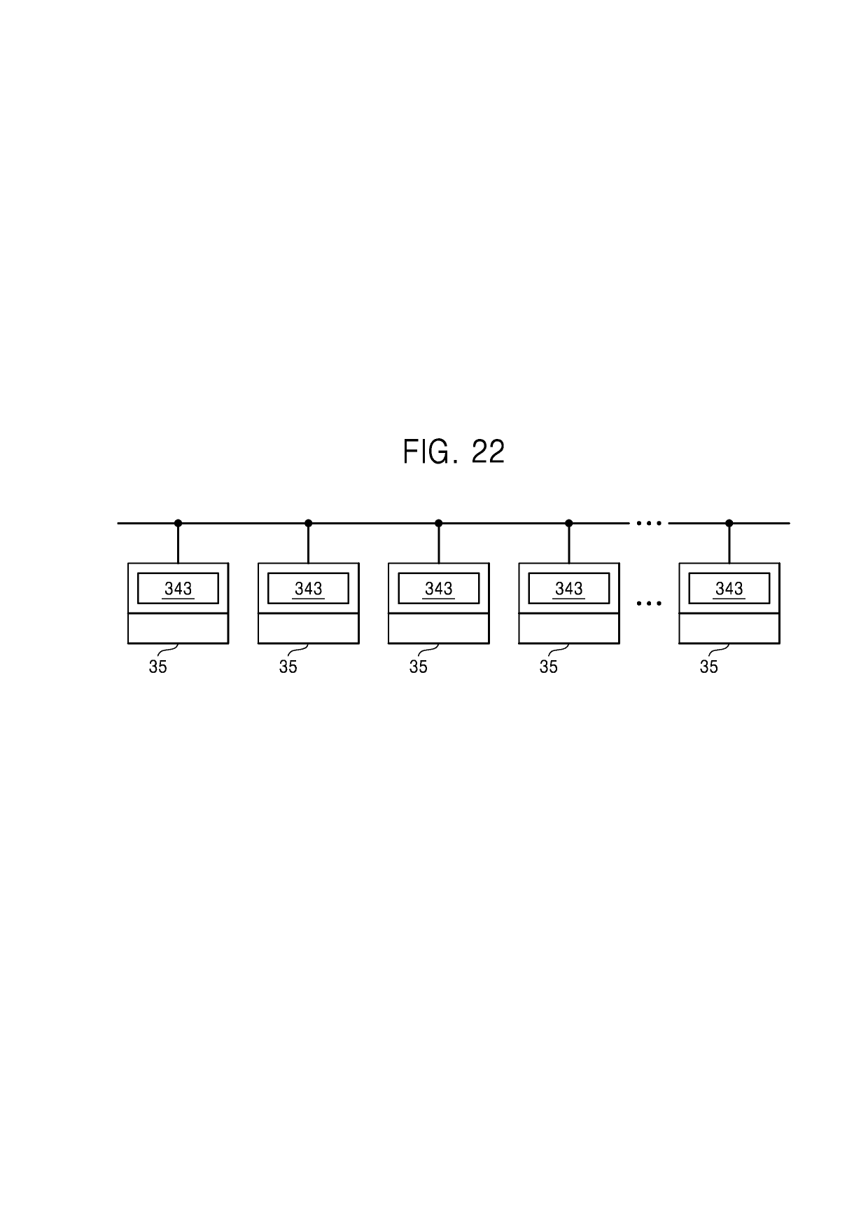

FIG. 20 is a diagram of the logical topology of a network of a plurality of local computers for a simulation using DPE according to some embodiments of the inventive concept. FIG. 21 is a diagram of the logical topology of a network of a plurality of local computers for a simulation using DPE according to other embodiments of the inventive concept. FIG. 22 is a diagram of the logical topology of a network of a plurality of local computers for a simulation using DPE according to further embodiments of the inventive concept. Apart from the logical topologies illustrated in FIGS. 20 through 22, there may be other various logical topologies of a network of local computers. Distributed-processing-based parallel simulation according to some embodiments of the inventive concept can be applied to various logical topologies of a network of local computers.

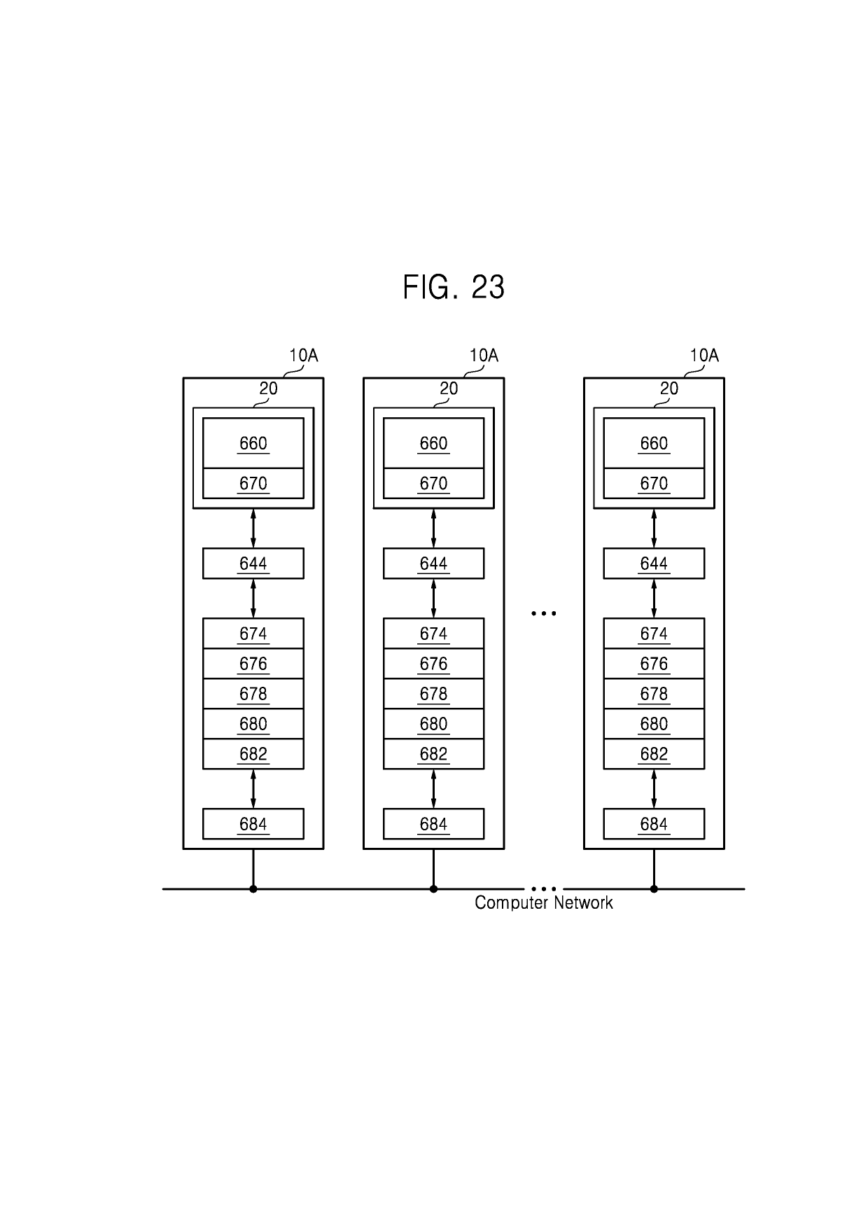

FIG. 23 is a conceptual diagram of a distributed parallel simulation environment in which a distributed parallel simulation is executed using simulators installed in respective computers according to some embodiments of the inventive concept.

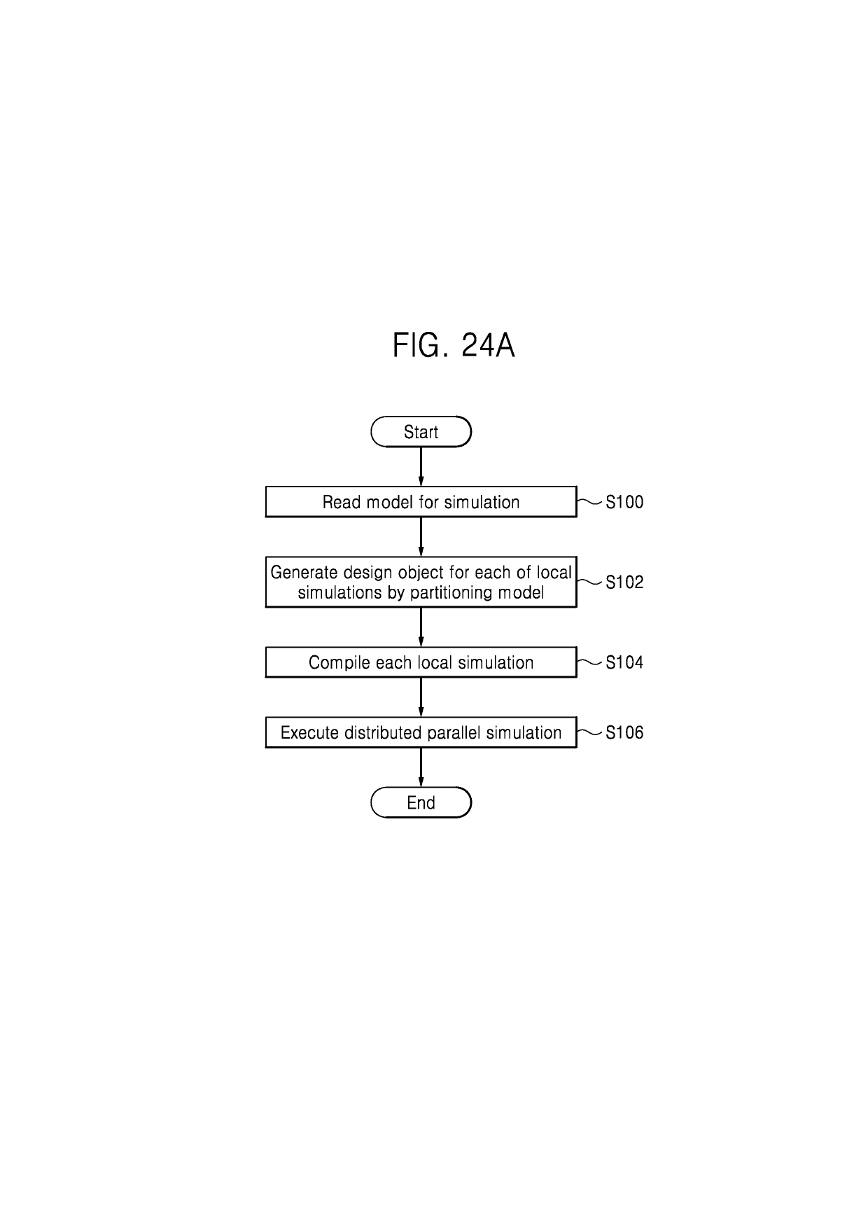

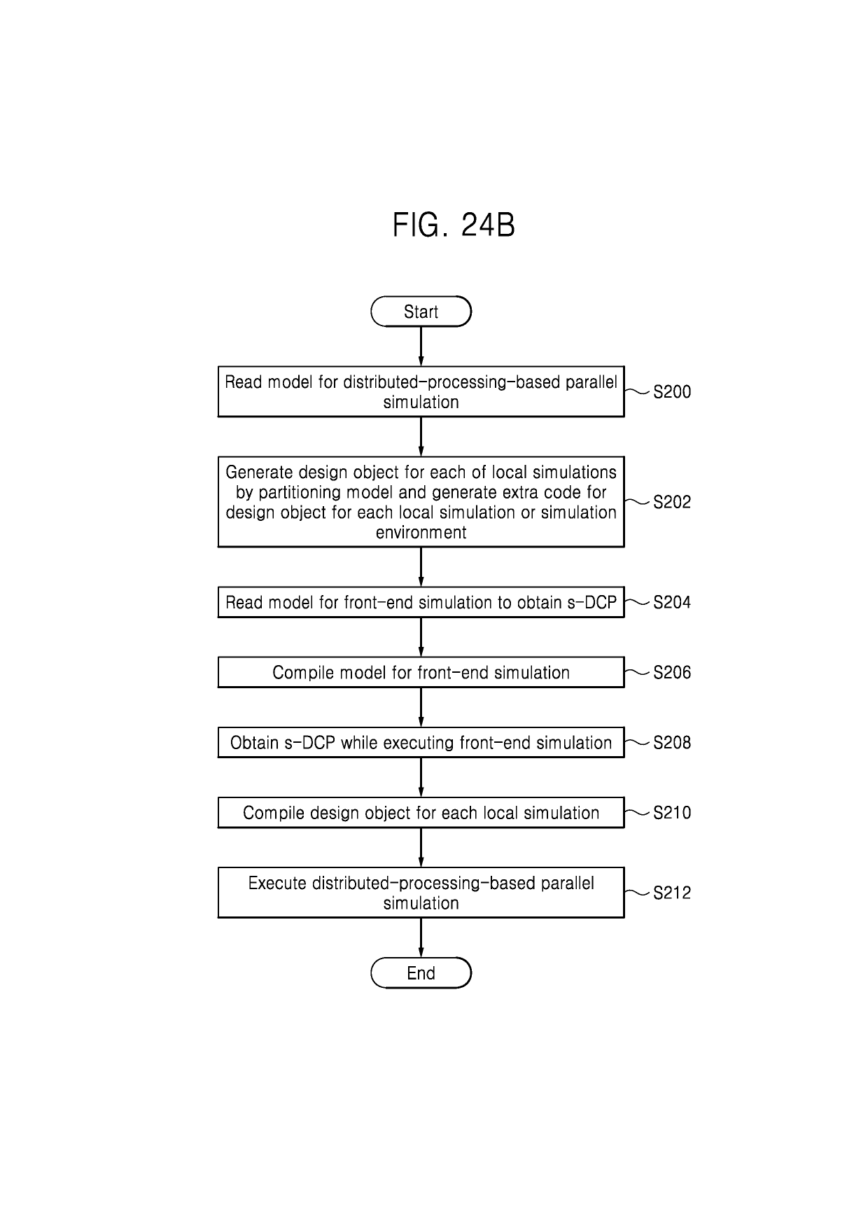

FIG. 24A is a flowchart of a method for distributed parallel simulation according to some embodiments of the inventive concept. FIG. 24B is a flowchart of a method for distributed-processing-based parallel simulation according to some embodiments of the inventive concept.

It can be inferred from FIG. 24B that other flowcharts of the distributed parallel simulation may exist. In addition, the order of operations, e.g., S200 through S212 in FIG. 24B, in the flowchart may be changed and at least two operations may be executed at the same time unless it disturbs the correct execution of the entire simulation.

Referring to FIG. 24B, there are a total of 8 operations excluding a start and an end of the distributed-processing-based parallel simulation. A model for the distributed-processing-based parallel simulation is read in operation S200.

A design object for each of local simulations is generated by partitioning the model and an extra code is generated for the design object for each local simulation or a simulation environment in operation S202. The simulation environment can include an S/W server module 333 in a central computer 353 in the star topology illustrated in FIG. 21)

A model for a front-end simulation is read to obtain an s-DCP in operation S204. The model for the front-end simulation is compiled in operation S206. The s-DCP is obtained while the front-end simulation is being executed in operation S208.

The design object for each local simulation in the distributed-processing-based parallel simulation is compiled in operation S210. At this time, the extra code generated in operation S202 is also compiled. The distributed-processing-based parallel simulation is executed in operation S212.

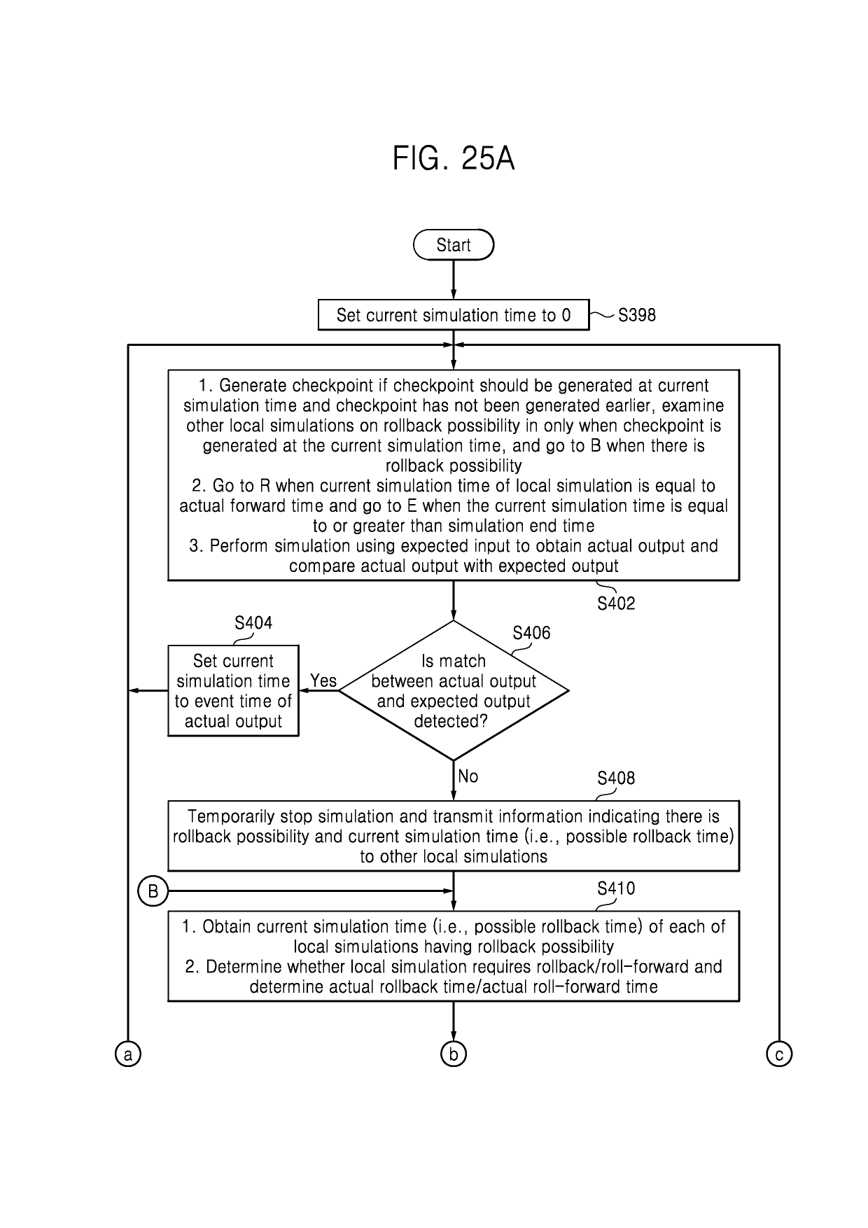

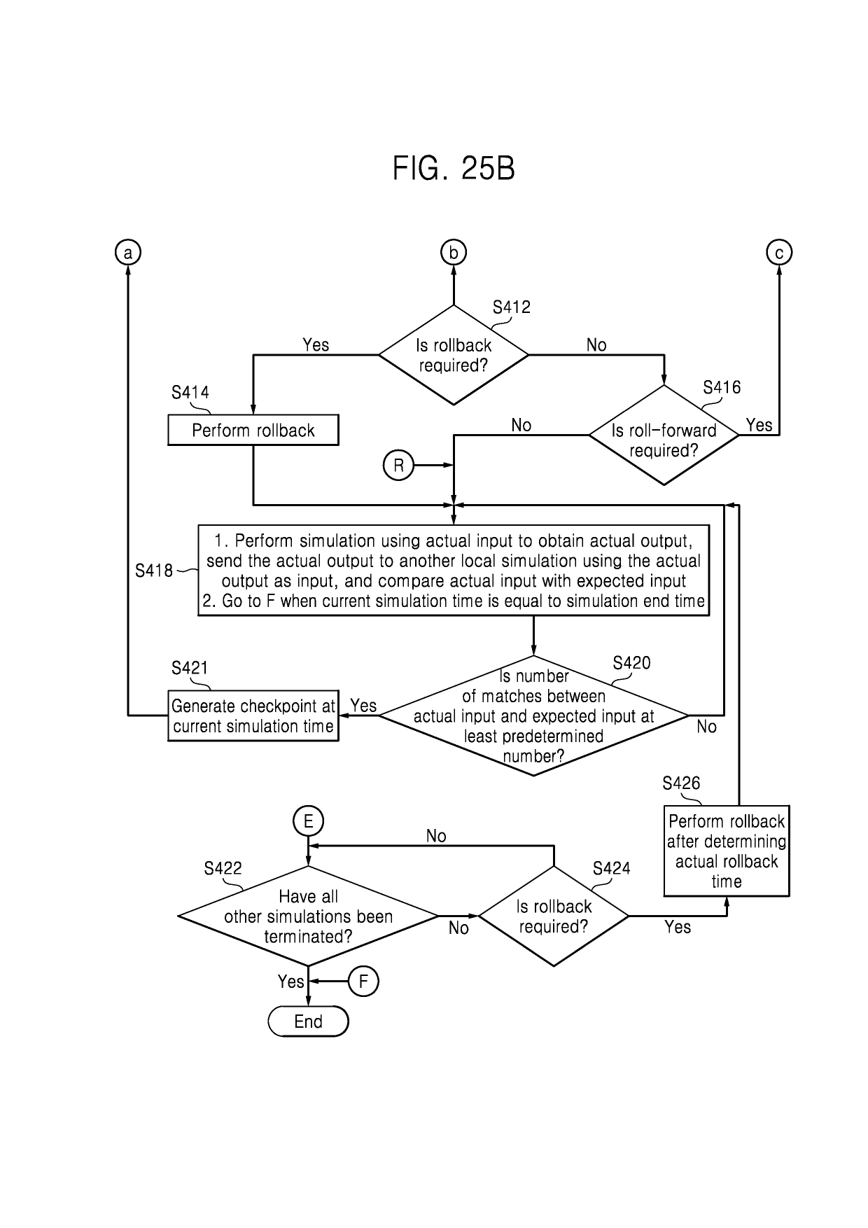

FIGS. 25A and 25B are flowcharts of a local simulation executed in a local simulator for executing a distributed-processing-based parallel simulation according to some embodiments of the inventive concept. These flowcharts schematically show the local simulation executed by each local simulator for the execution of distributed-processing-based parallel simulation, i.e., operation S212 in FIG. 24B.

There may be other various flowcharts for the distributed-processing-based parallel simulation. In addition, the order of operations in the entire flowchart may be changed and at least two operations may be executed at the same time unless it disturbs the correct execution of the entire simulation.

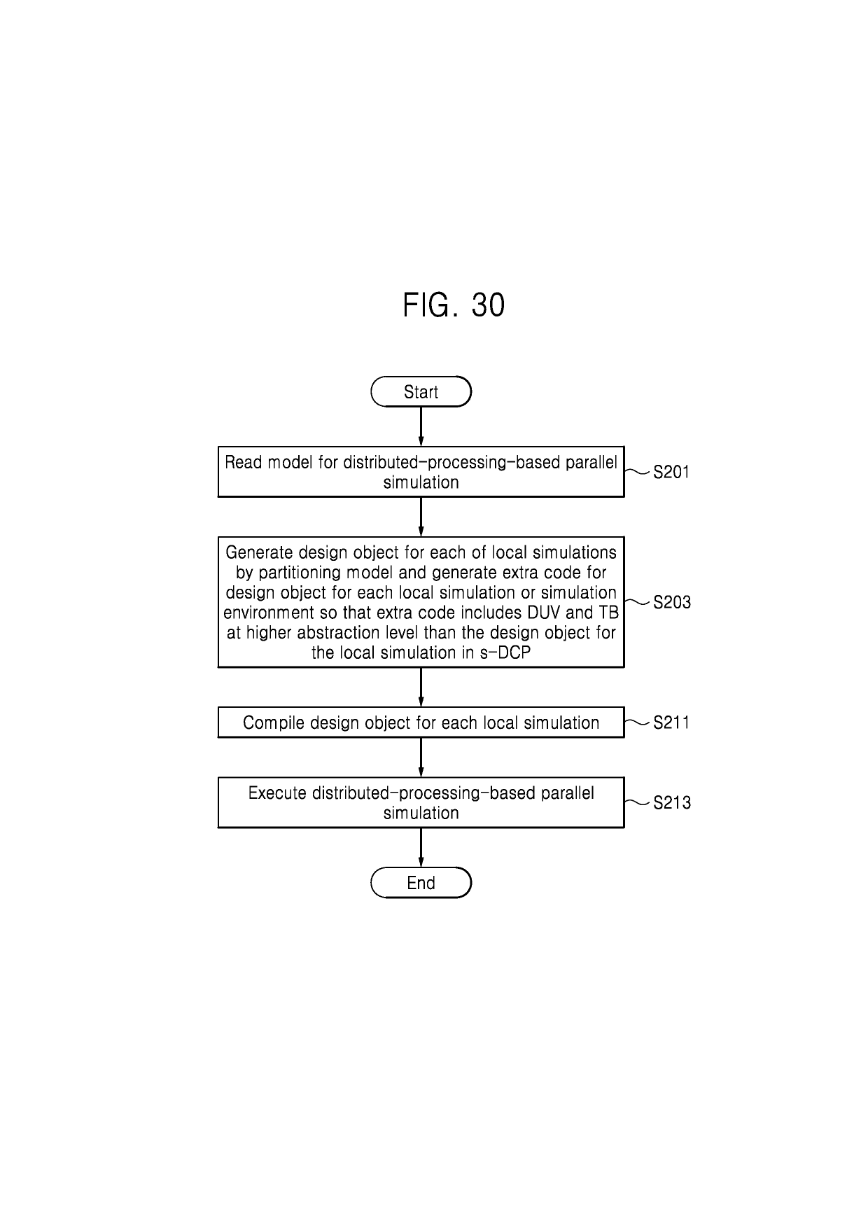

FIG. 30 is a flowchart of a method for distributed-processing-based parallel simulation according to other embodiments of the inventive concept. There may be other various flowcharts for the distributed-processing-based parallel simulation. In addition, the order of operations, e.g., S201, S203, S211, and S213 in FIG. 30, in the entire flowchart may be changed and at least two operations may be executed at the same time unless it disturbs the correct execution of the entire simulation.

Referring to FIG. 30, there are four operations in total excluding a start and an end of the distributed-processing-based parallel simulation. A model for the distributed-processing-based parallel simulation is read in operation S201. A design object for each of local simulations is generated by partitioning the model and an extra code is generated for the design object for each local simulation or a simulation environment in operation S203. This can include the S/W server module 333 in the central computer 353 in the star topology illustrated in FIG. 21.

The extra code generate in operation S203 includes DUV and TB at a higher abstraction level than the design object for the local simulation in an s-DCP. The design object for the local simulation in the distributed-processing-based parallel simulation is compiled in operation S211. At this time, the extra code generated in operation S203 is also compiled. The distributed-processing-based parallel simulation is executed in operation S213.

Referring to FIGS. 25A and 25B, there are fifteen operations in total excluding start and an end of the distributed-processing-based parallel simulation.

A current simulation time is set to 0 in operation S398. When a checkpoint should be generated at the current simulation time of a local simulation and there is no checkpoint generated earlier, a checkpoint is generated at the current simulation time and other local simulations is examined on rollback possibility after the generation of the checkpoint in operation S402. When there is rollback possibility, the method proceeds to operation S410. In otherwise cases, the method proceeds to operation S418 when the current simulation time of the local simulation is equal to an actual roll-forward time. Alternatively, the method proceeds to operation S422 when the current simulation time is greater than or equal to a simulation end time. In other cases, the simulation is run using an expected input to obtain an actual output and the actual output is compared with an expected output in operation S402, and then the method proceeds to operation S406. When the match between the actual output obtained in operation S402 and the expected output is determined in operation S406, the method proceeds to operation S404. When the mismatch therebetween is determined, the method proceeds to operation S408. The event time of the actual output, i.e., time when a change occurs, is set as the current simulation time of the local simulation in operation S404, and the method proceeds to operation S402.

The simulation is stopped temporarily, information indicating there is a rollback possibility and the current simulation time, i.e., a possible rollback time, is transmitted to other local simulations in operation S408, and the method proceeds to operation S410. In operation S410, a current simulation time, or possible rollback time, of each local simulation having rollback possibility is obtained and the necessity of rollback/roll-forward and a rollback/roll-forward time is determined for the local simulation based on the possible rollback times of the local simulations. Then, the method proceeds to operation S412.

Local simulation times T_rb=(t_rb(1), t_rb(2), . . . , t_rb(N−1), t_rb(N)) of the respective local simulations with rollback possibility become possible rollback times, for example, where t_rb(i) is a possible rollback time of local simulation “i” having rollback possibility. An actual rollback time is the least value, i.e., the earliest time T_rb(FINAL)=min(t_rb(1), t_rb(2), . . . , t_rb(N−1), t_rb(N) among the local simulation times t_rb(1), t_rb(2), . . . , t_rb(N−1), and t_rb(N). If a current simulation time t_c(k) of a specific local simulation LP(k), i.e., the current local simulation, is equal to or greater than the earliest time T_rb(FINAL), rollback is required for the local simulation LP(k). If the current simulation time t_c(k) is smaller than the earliest time T_rb(FINAL), roll-forward is required for the local simulation LP(k).

When it is determined that the rollback is required in operation S412, the method proceeds to operation S414. Otherwise, the method proceeds to operation S416. When it is determined that the roll-forward is required in operation S416, the method proceeds back to operation S402. Otherwise, the method proceeds to operation S418. The rollback is performed for the local simulation in operation S414. A simulation is performed using an actual input to obtain an actual output. The actual output is transmitted to another local simulation having the actual output as its input in operation S418. At the same time, the actual input and the expected input are compared with each other. If the current simulation time of the local simulation is equal to the simulation end time, the flow ends. If the current simulation time is not equal to the simulation end time, the method proceeds to operation S420.

In operation S420, it is determined whether the number of matches between the actual input and the expected input made in operation S418 is at least a predetermined number, for example, three. When the number of matches is at least the predetermined number, the method proceeds to operation S421. Otherwise, the method proceeds to operation S418.

In operation S422, when it is determined that all of other local simulations have been terminated, the current local simulation is terminated. Otherwise, the method proceeds to operation S424. It is determined whether the current local simulation requires rollback in operation S424. If the rollback is required, the method proceeds to operation S426. Otherwise, the method proceeds to operation S422. The rollback is performed after the actual roil-back time is determined in operation S426. Subsequently, the method proceeds to operation S418.

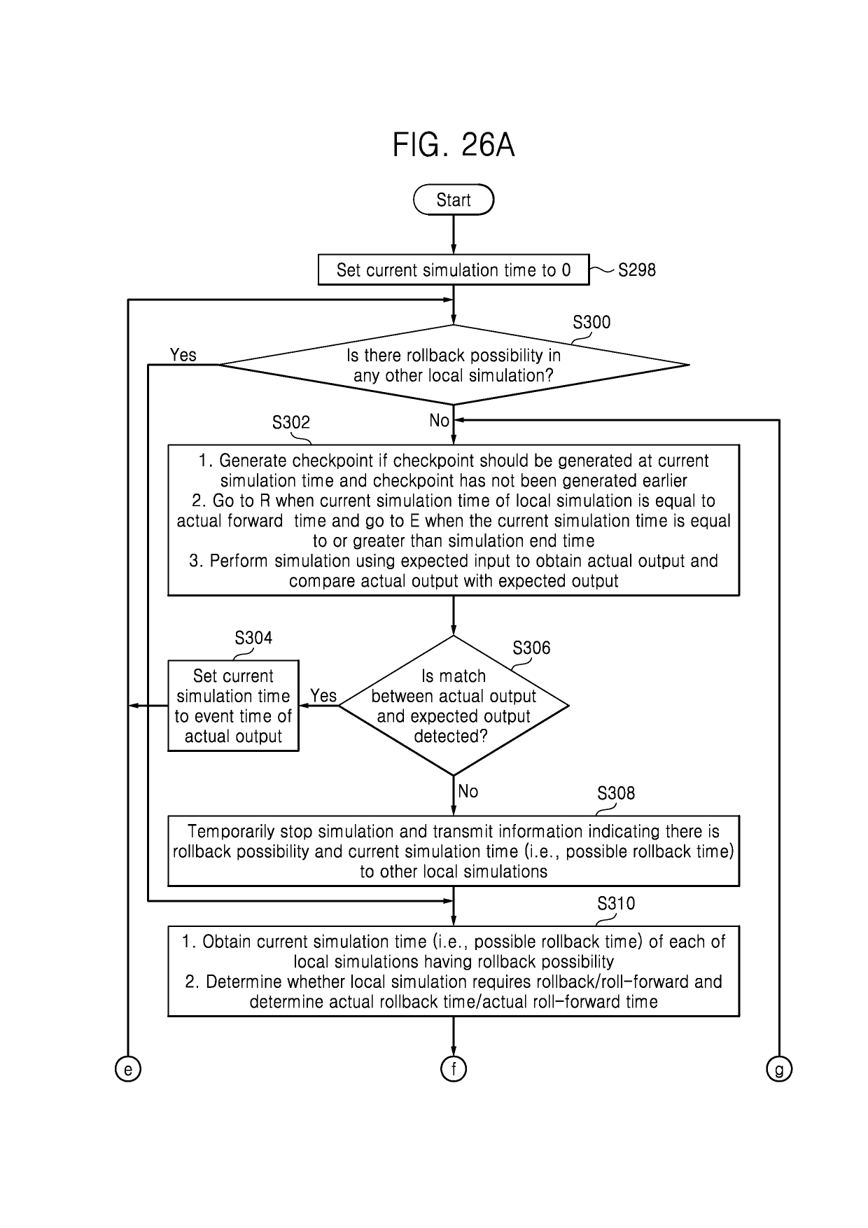

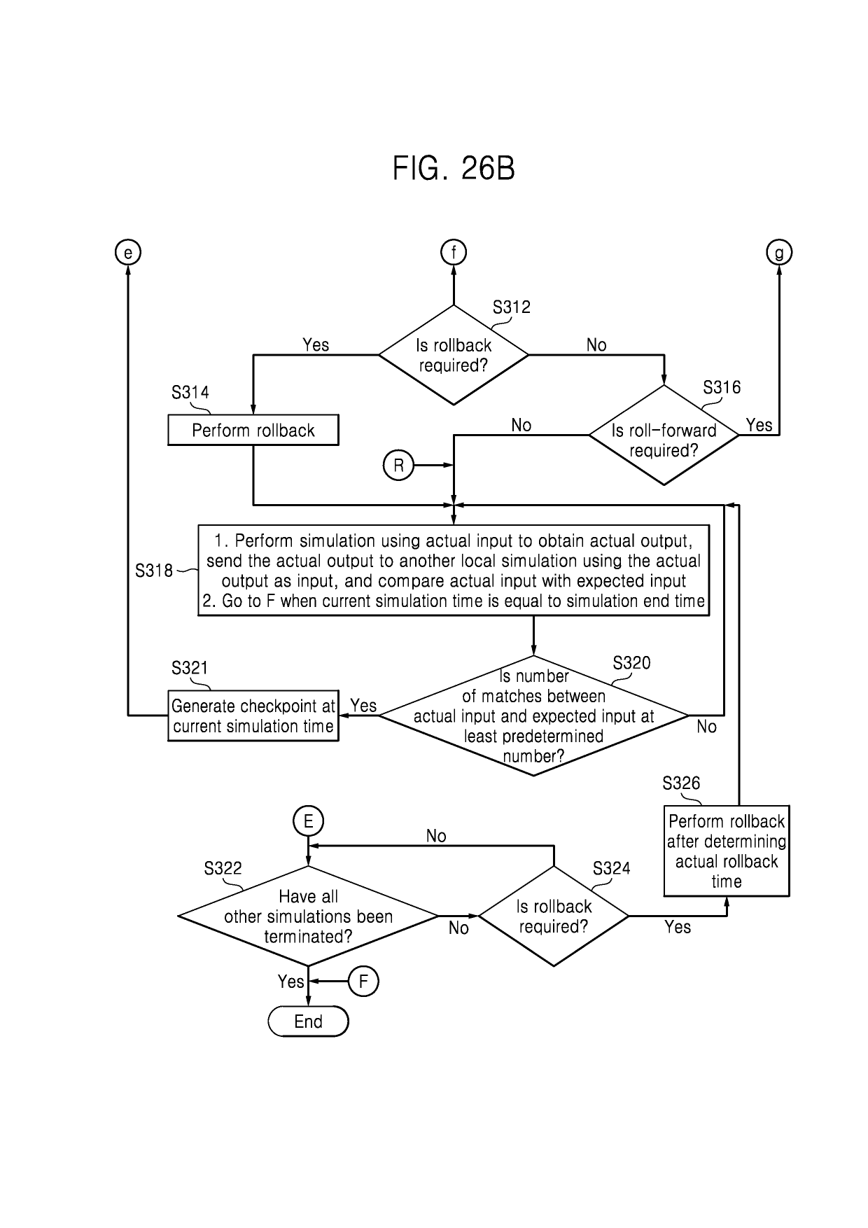

FIGS. 26A and 26B are flowcharts of a local simulation executed by a local simulator for executing a distributed-processing-based parallel simulation according to other embodiments of the inventive concept.

The flowcharts schematically show another example of the local simulation executed by each local simulator for operation S212 illustrated in FIG. 24B. Other various flowcharts for the distributed-processing-based parallel simulation may equally apply. In addition, the order of operations in the entire flowchart may be changed and at least two operations may be executed at the same time unless it disturbs the correct execution of the entire simulation.

Referring to FIGS. 26A and 26B, there are sixteen operations in total excluding a start and an end in the distributed-processing-based parallel simulation.

A current simulation time is set to 0 in operation S298. When information indicating there is rollback possibility is received from any other local simulation in operation S300, the method proceeds to operation S310. Otherwise, the method proceeds to operation S302.

When a checkpoint should be generated at the current simulation time of a local simulation and there is no checkpoint generated earlier, a checkpoint is generated and the method proceeds to operation S318 when the current simulation time of the local simulation is equal to an actual roll-forward time. Alternatively, the method proceeds to operation S322 when the current simulation time is greater than or equal to a simulation end time. In otherwise cases, the simulation is run using an expected input to obtain an actual output and the actual output is compared with an expected output in operation S302. Subsequently, the method proceeds to operation S306.

When the match between the actual output obtained in operation S302 and the expected output is determined in operation S306, the method proceeds to operation S304. When the mismatch therebetween is determined, the method proceeds to operation S308. The event time of the actual output, i.e., time when a change occurs, is set as the current simulation time of the local simulation in operation S304, and the method proceeds back to operation S300.

The simulation can be stopped temporarily, information indicating there is a rollback possibility and the current simulation time, i.e., a possible rollback time, is transmitted to other local simulations in operation S308. Subsequently, the method proceeds to operation S310.

In operation S310, a current simulation time, or possible rollback time, of each local simulation having a rollback possibility is obtained, and the necessity of rollback/roll-forward and an actual rollback time and an actual roll-forward time are determined for the local simulation based on the possible rollback times of the local simulations. Subsequently, the method proceeds to operation S312.

Local simulation times T_rb=(t_rb(1), t_rb(2), . . . , t_rb(N−1), t_rb(N)) of the respective local simulations having a rollback possibility become possible rollback times, i.e., where t_rb(i) is a possible rollback time of local simulation “i” having rollback possibility. An actual rollback time is the least value, i.e., the earliest time T_rb(FINAL)=min(t_rb(1), t_rb(2), . . . , t_rb(N−1), t_rb(N) among the local simulation times t_rb(1), t_rb(2), . . . , t_rb(N−1), and t_rb(N). If a current simulation time t_c(k) of a specific local simulation LP(k), i.e., the current local simulation, is equal to or greater than the earliest time T_rb(FINAL), then a rollback is required for the local simulation LP(k). If the current simulation time t_c(k) is smaller than the earliest time T_rb(FINAL), a roll-forward is required for the local simulation LP(k). When it is determined that the rollback is required in operation S312, the method proceeds to operation S314. Otherwise, the method proceeds to operation S316.

When it is determined that the roll-forward is required in operation S316, the method proceeds back to operation S302. Otherwise, the method proceeds to operation S318. The rollback is performed for the local simulation in operation S314.

A simulation is performed using an actual input to obtain an actual output, and the actual output is sent to another local simulation having the actual output as its input in operation S318. At the same time, the actual input and the expected input are compared with each other, and if the current simulation time of the local simulation is equal to the simulation end time, the flow ends. If the current simulation time is not equal to the simulation end time, then the method proceeds to operation S320.

In operation S320, it is determined whether the number of matches between the actual input and the expected input made in operation S318 is at least a predetermined number (for example, three). When the number of matches is at least the predetermined number, the method proceeds to operation S321. Otherwise, the method proceeds back to operation S318.

In operation S322, when it is determined that all of other local simulations have been terminated, the current local simulation is terminated. Otherwise, the method proceeds to operation S324. It is determined whether the current local simulation requires rollback in operation S324. If the rollback is required, the method proceeds to operation S326. Otherwise, the method proceeds back to operation S322. The rollback is performed after the actual roil-back time is determined in operation S326. Subsequently, the method proceeds to operation S318.

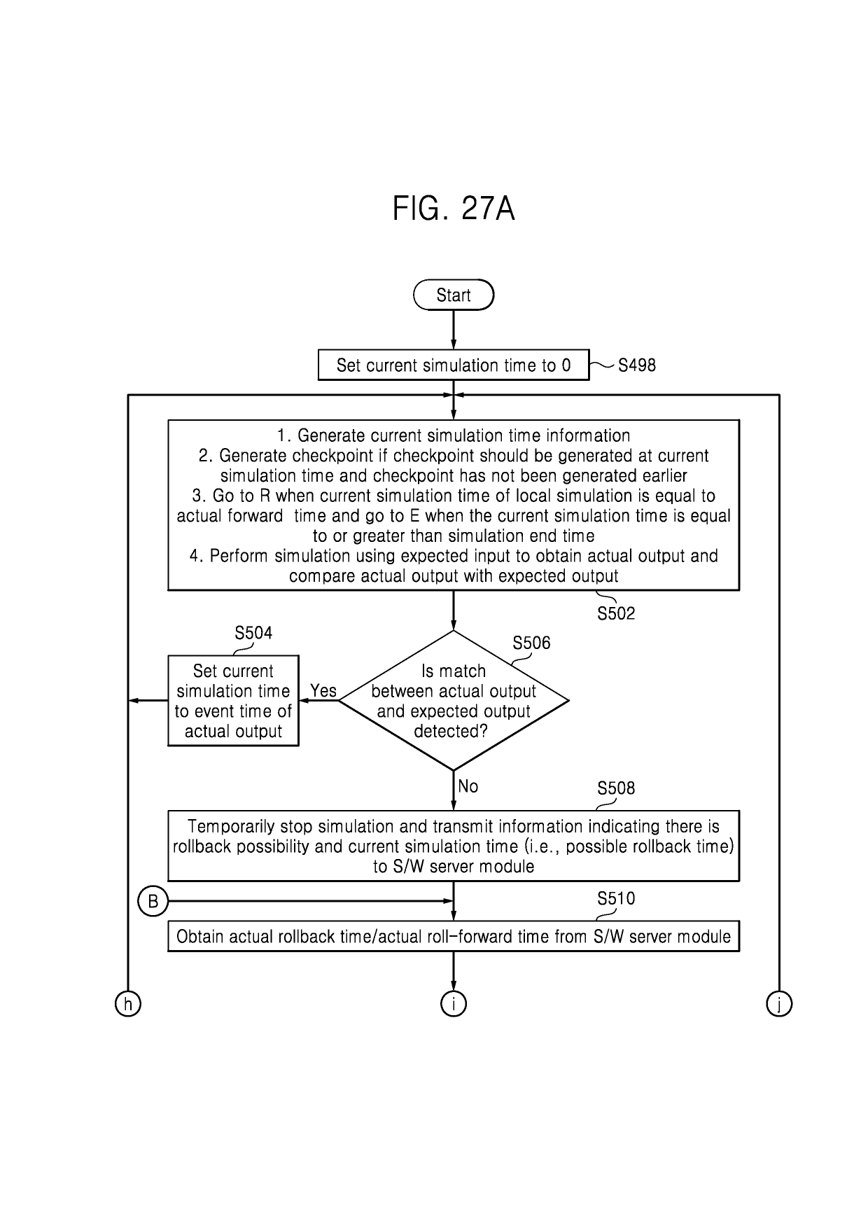

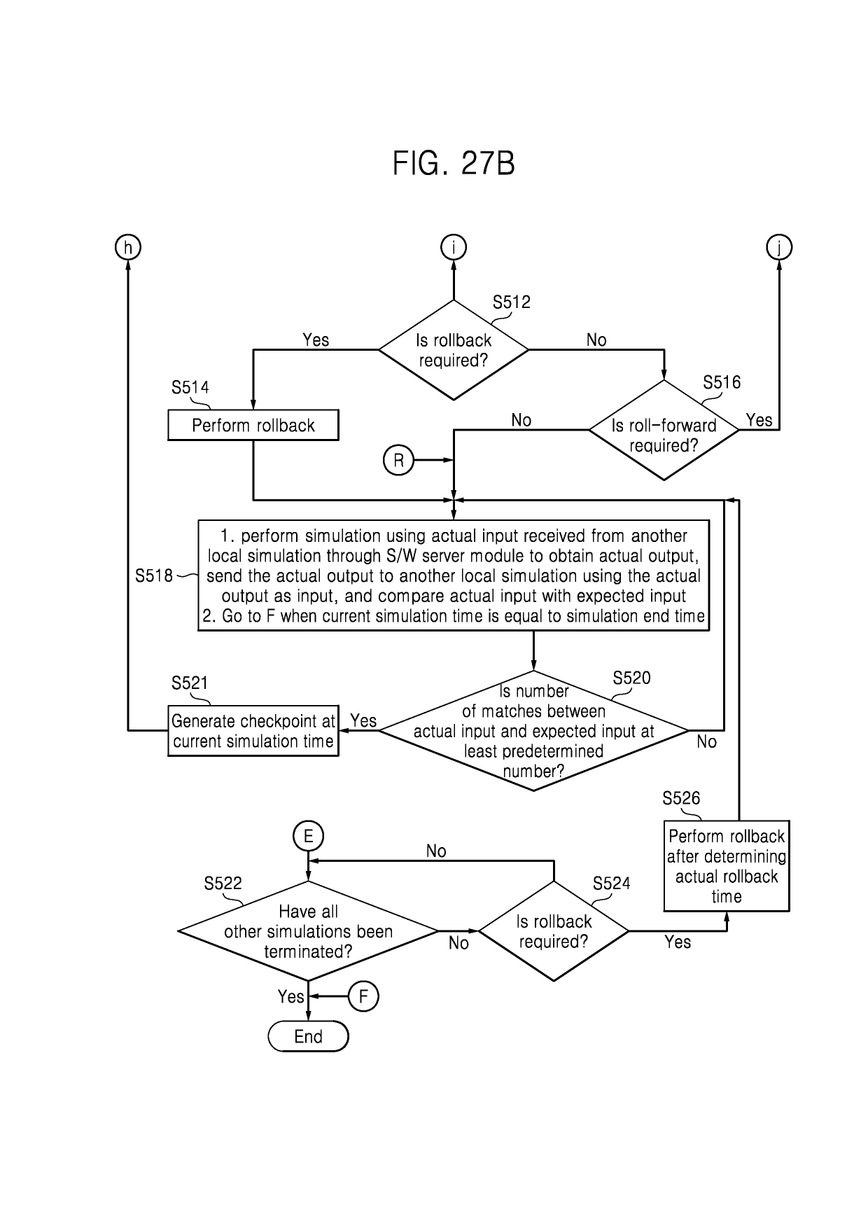

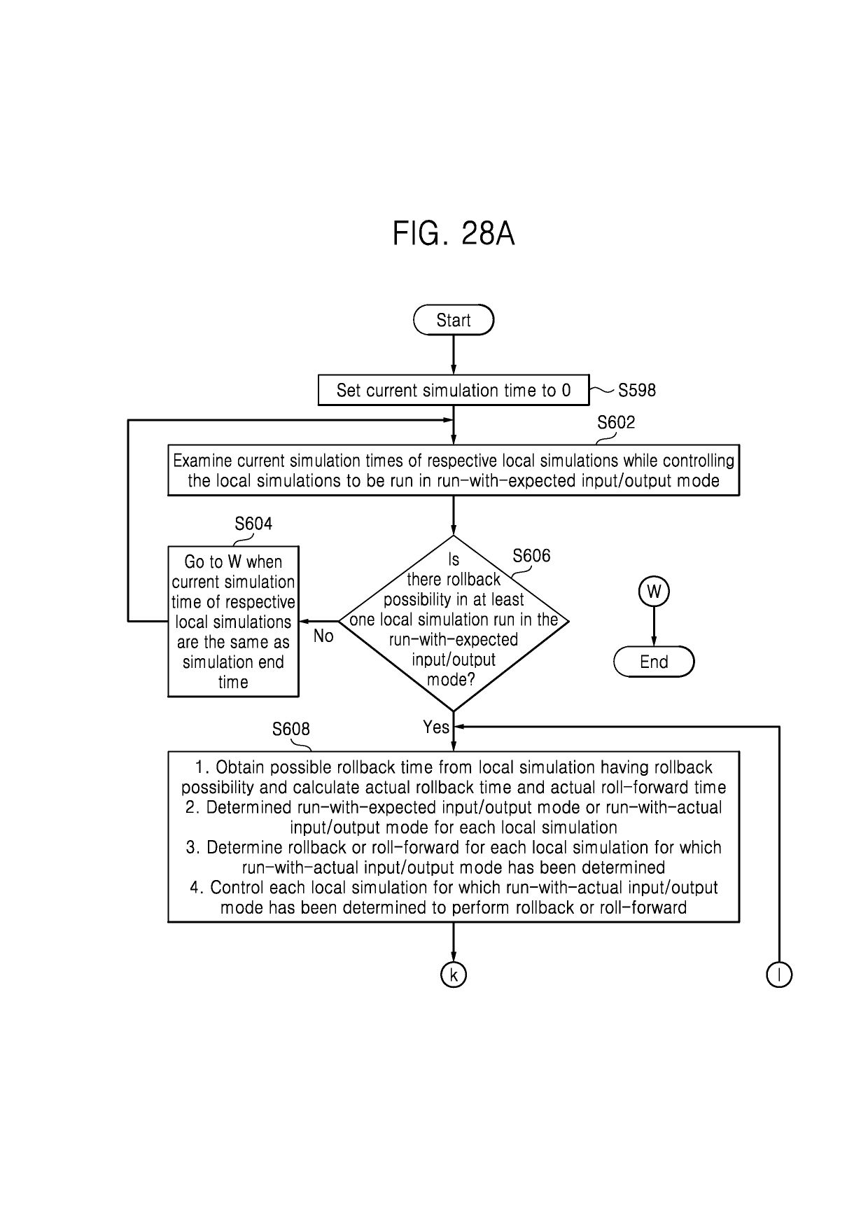

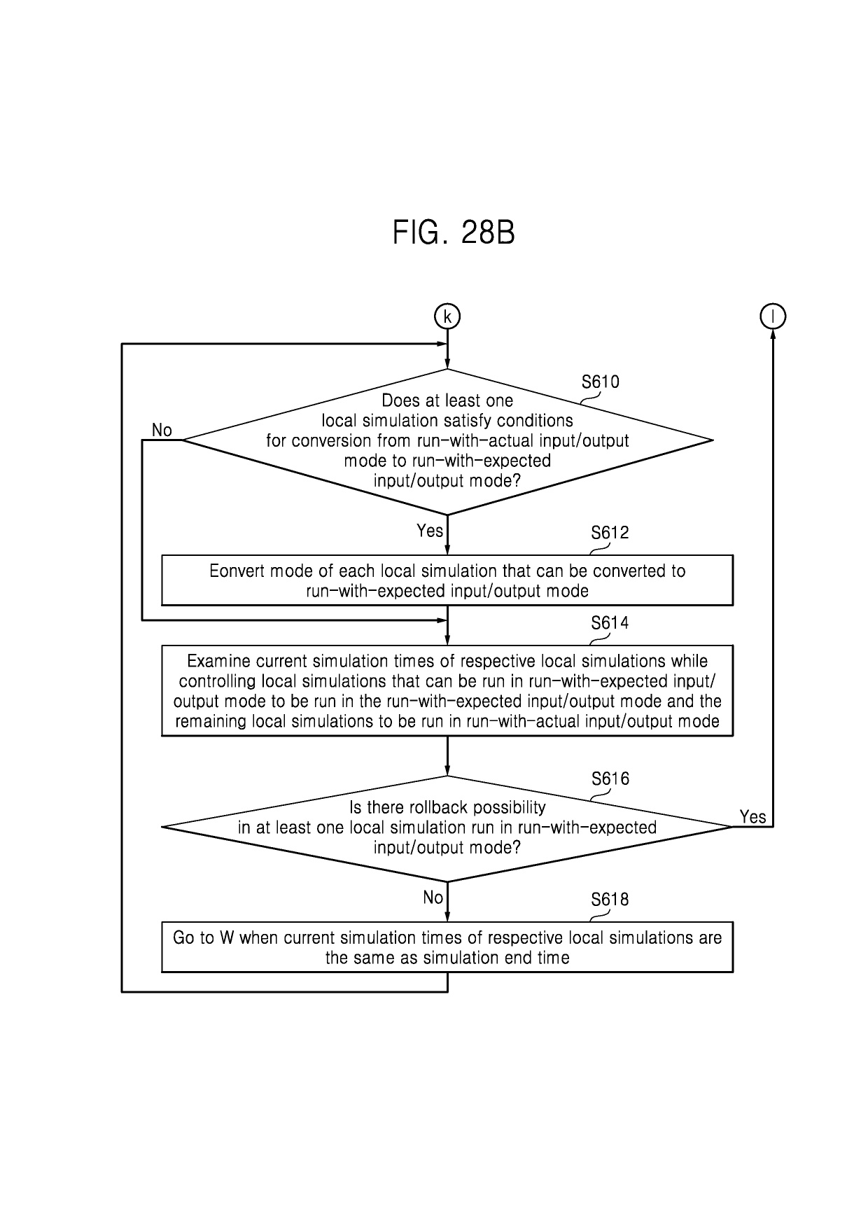

The control and interconnection of local simulations performed in the embodiments illustrated in FIGS. 24A through 26B is not performed using the S/W server module 333, for example, FIG. 20 or 21, included in the central computer 353, but rather is distributed to and performed by local simulation run-time modules, so that the flowcharts are complex. When the control and interconnection of local simulations is performed using the S/W server module included the central computer 353 in distributed parallel simulation executed in the start topology of a network illustrated in FIG. 20 or 21, operation S212, i.e., the execution of distributed-processing-based parallel simulation illustrated in FIG. 24B may be performed as shown in the embodiments illustrated in FIGS. 27A and 27B and FIGS. 28A and 28B.

FIGS. 27A and 27B are flowcharts of a local simulation executed by a local simulator in the star topology of a network according to some embodiments of the inventive concept. FIGS. 28A and 28B are flowcharts of a local simulation executed by a local simulator in the star topology of a network according to other embodiments of the inventive concept.

Referring to FIGS. 27A and 27B, there are fifteen operations in total excluding start and end in the execution of local simulation for the execution of distributed-processing-based parallel simulation.

A current simulation time is set to 0 in operation S498. Current simulation time information of a local simulation is generated in operation S502. In addition, when a checkpoint should be generated at the current simulation time of a local simulation and there is no checkpoint generated earlier, a checkpoint is generated in operation S502 and the method proceeds to operation S518 when the current simulation time of the local simulation is equal to an actual roll-forward time or to operation S522 when the current simulation time is greater than or equal to a simulation end time. In otherwise cases, the simulation is run using an expected input to obtain an actual output and the actual output is compared with an expected output in operation S502, and then the method proceeds to operation S506.

When the match between the actual output obtained in operation S502 and the expected output is determined in operation S506, the flow proceeds to operation S504. When the mismatch therebetween is determined, the method proceeds to operation S508. The event time of the actual output, i.e., time when a change occurs, is set as the current simulation time of the local simulation in operation S504. Subsequently, the method proceeds to operation S502.

The simulation is stopped temporarily and information indicating there is rollback possibility and the current simulation time, i.e., a possible rollback time, is transmitted to an S/W server module in operation S508. Subsequently, the method proceeds to operation S510. In operation S510, an actual rollback time and an actual roll-forward time are obtained from the S/W server module. Subsequently, the method proceeds to operation S512.

When it is determined that the rollback is required in operation S512, the method proceeds to operation S514. Otherwise, the method proceeds to operation S516. When it is determined that the roll-forward is required in operation S516, the method proceeds to operation S502. Otherwise, the method proceeds to operation S518.

The rollback is performed for the local simulation in operation S514. In operation S518, a simulation is performed using an actual input received from another local simulation through the S/W server module to obtain an actual output. The actual output is transmitted via the S/W server module to another local simulation having the actual output as its input. The actual input and the expected input are compared with each other. If the current simulation time of the local simulation is equal to the simulation end time, then the flow ends. If the current simulation time is not equal to the simulation end time, the method proceeds to operation S520.

In operation S520, it is determined whether the number of matches between the actual input and the expected input made in operation S518 is at least a predetermined number, for example, three matches. When the number of matches is at least the predetermined number, the method proceeds to operation S521. Otherwise, the method proceeds to operation S518.

In operation S522, when it is determined that all of other local simulations have been terminated, the current local simulation is terminated. Otherwise, the method proceeds to operation S524. It is determined whether the current local simulation requires rollback in operation S524. If the rollback is required, the method proceeds to operation S526. Otherwise, the method proceeds back to operation S522. The rollback is performed after the actual roil-back time is determined in operation S526, and then the method proceeds to operation S518.

Referring to FIGS. 28A and 28B, there are ten operations in total excluding start and end in the execution of local simulation using a S/W server module, for example S/W server module 333 shown in FIGS. 20 and 21 or S/W server module 644 in FIG. 23 for the execution of a distributed-processing-based parallel simulation.

A current simulation time can be set to 0 in operation S598. A current simulation time of each of local simulations is examined while the local simulations are controlled to execute in the run-with-expected input/output mode in operation S602. It is determined whether there is any rollback possibility in at least one of the local simulations run in the run-with-expected input/output mode in operation S606. When it is determined that there is any rollback possibility, the method proceeds to operation S604. Otherwise, the method proceeds to operation S608.

When the current simulation times of the respective local simulations are the same as a simulation end time in operation S604, the flow ends. Otherwise, the method proceeds to operation S602.

In operation S608, a possible rollback time is obtained from each of the local simulations having rollback possibility and an actual rollback time and an actual roll-forward time are calculated, either the run-with-expected input/output mode or the run-with-actual input/output mode is determined for each local simulation, either rollback or roll-forward is determined for the local simulation for which the run-with-actual input/output mode is determined, and/or the local simulation for which the run-with-actual input/output mode is determined is controlled to perform a rollback or roll-forward.

It is determined whether at least one local simulation satisfies conditions for conversion from the run-with-actual input/output mode to the run-with-expected input/output mode in operation S610. If the conditions are satisfied, the method proceeds to operation S612. Otherwise, the method proceeds to operation S614.

The at least one local simulation is converted to the run-with-expected input/output mode in operation S612. While local simulations that can be run in the run-with-expected input/output mode is being run in the run-with-expected input/output mode and the remaining local simulations are being run in the run-with-actual input/output mode, a current simulation time of each of the local simulations can be examined in operation S614.

It is determined whether there is a possibility of a rollback at least at one local simulation, which can be run in the run-with-expected input/output mode in operation S616. When it is determined that there is a rollback possibility, the method proceeds to operation S608. Otherwise, the method proceeds to S618. When the current simulation times of all local simulations are the same as the simulation end time in operation S618, the flow ends. Otherwise, the method proceeds to operation S610.

In the flowcharts illustrated in FIGS. 28A and 28B, the S/W server module controls the distributed-processing-based parallel simulation so that each of the local simulations can be independently run in the run-with-expected input/output mode or the run-with-actual input/output mode.

However, as described above, in other embodiments, the S/W server module may control the distributed-processing-based parallel simulation such that a local simulation is run in the run-with-expected input/output mode only when all local simulations are run in the run-with-expected input/output mode and all local simulations are run in the run-with-actual input/output mode in other cases. These embodiments may provide an advantage of simple control.

In accordance with the inventive concept, the term “simulation” refers to not only pure simulation using only one or more simulators but also simulation acceleration using one or more simulators and one or more hardware-based verification platform.

Accordingly, each of local simulations forming a distributed-processing-based parallel simulation environment may be executed in a local simulator, may be executed on a hardware-based verification platform using simulation acceleration, or may be executed using both the local simulator and the hardware-based verification platform. Distributed-processing-based parallel simulation proposed in the embodiments of the inventive concept may be used in refinement processes from a transaction level to a GL and other refinement processes involving other levels.

FIG. 29 is a conceptual diagram of components included in extra code added for a distributed-processing-based parallel simulation according to other embodiments of the inventive concept. The embodiments illustrated in FIG. 29 are similar to those illustrated in FIG. 10. However, in the embodiments illustrated in FIG. 29, a design object 53 including both DUV and TB described at a high abstraction level, which is higher than the abstraction level of a local design object executed in a current local simulation, is placed in the s-DCP generation/saving module 60 and is executed in the current local simulation together with the local design object. At this time, the design object 53 may be executed using simulation, simulation acceleration using a hardware-based verification platform, or a combination thereof. Accordingly, an expected input and an expected output necessary to minimize communication overhead and synchronization overhead in the local simulation of the local design object are dynamically generated and used.

The difference between the method illustrated in FIG. 29 and the method illustrated in FIG. 10 is similar to the difference between two methods of automatically comparing simulation results in conventional simulation methods, i.e., a method of using a golden model in which the golden model is simulated together with DUV and a simulation result dynamically obtained from the simulation of the golden model is used, and a method of using a golden vector in which a simulation result obtained from a previous simulation is used.

In other words, in a local simulation in distributed-processing-based parallel simulation according to some embodiments of the inventive concept, an expected input and/or an expected output necessary to minimize communication overhead and synchronization overhead during simulation execution may be obtained from dynamic information collected and saved during a previous simulation or may be dynamically obtained from a model at a high abstraction level while the model at the higher abstraction level than a local design object is executed in a local simulation together with the local design object. In addition, as described herein, instead of the design object 53 including both DUV and TB described at a high abstraction level, a design object including both DUV and TB which are at the same abstraction level as a local design object but are optimized for fast simulation may be used.

To accomplish the fast execution of only simulation of a model at a specific abstraction level, e.g., RTL model, mixed RTL/GL model, mixed TLM/RTL model, or mixed TLM/RTL/GL model, in a distributed-processing-based parallel simulation according to some embodiments of the inventive concept, the abstraction level of the model or at least one design object in the model may be automatically raised. Alternatively, the model or the at least one design object may be optimized for fast simulation. Alternatively, a combination of the two methods may be used to modify the model or the at least one design object into a new model and the new model may be used as an s-DCP or dynamic information obtained from the simulation of the new model may be used as an s-DCP.

According to some embodiments of the inventive concept, a result of the simulation of a model at a high abstraction model may be used when very large scale integration (VLSI) design is carried out at an ESL. In this manner, a model at a low abstraction level can be verified quickly. As a result, entire design verification time is dramatically reduced and verification efficiency is greatly increased. Another feature is that verification can be effectively carried through a progressive refinement process from a system level to a GL while design is being carried out through the progressive refinement process.

Also, a problem is solved with respect to a verification speed decreasing as the progressive refinement process proceeds to a lower abstraction level. Also, an entire design and verification procedure using the progressive refinement process from a high abstraction level to a low abstraction level is systematically and automatically carried out.

Furthermore, consistency among at least two models at different abstraction levels is effectively maintained in a systematic verification method. Based on the model consistency being maintained systematically, a model at a high abstraction level is used as a reference model so that a model at a low abstraction level can be effectively verified through the progressive refinement process.

In addition, synchronization overhead and communication overhead in distributed parallel simulation is effectively reduced, thereby increasing the speed of the distributed parallel simulation. Also, debugging can be provided that removes errors from design using the progressive refinement process. Accordingly, design errors are corrected through fast debugging.

Also, in distributed parallel simulation of a model at a specific abstraction level, an output generated in at least one local simulation at a simulation time “t1” in a partial simulation period of the entire distributed parallel simulation is saved as a previous output, a current output generated at a current simulation time “t2” following the simulation time “t1” during the distributed parallel simulation of the model is compared with the previous output. Instead of the entire current output, only values of the current output different from the previous output and position information of the different values are transmitted to other local simulations through communication.

While the inventive concept has been particularly shown and described with reference to exemplary embodiments thereof, it will be understood by those of ordinary skill in the art that various changes in forms and details may be made therein without departing from the spirit and scope of the inventive concept as defined by the following claims.

What is claimed is:

1. A distributed parallel simulation method, comprising:
executing a plurality of local simulations in parallel for a plurality of local design objects, respectively, wherein the local design objects are included in a model at a specific abstraction level and are spatially distributed;
generating at least one actual output using at least one of the local design objects in a current local simulation of the plurality of local simulations during the distributed parallel simulation is executed;
comparing at least one expected output with the at least one actual output in the current local simulation; and
transmitting values of the at least one actual output and position information of the values from the current local simulation to at least one remaining local simulation of the plurality of local simulations in response to a determination from the comparison that a difference exists between the at least one expected output and the at least one actual output.

2. The method of claim 1, wherein the at least one expected output is obtained using a simulation of a model at an abstraction level higher than the specific abstraction level before the distributed parallel simulation of the model at the specific abstraction level.

3. The method of claim 1, wherein the distributed parallel simulation of the model at the specific abstraction level is performed after change in design and the at least one expected output is obtained using a simulation performed before the change in design.

4. The method of claim 1, further comprising performing the local simulations by a plurality of design verification apparatuses, respectively, connected to each other through a network.

5. The method of claim 4, wherein at least one of the design verification apparatuses includes at least one of a computer, central processing unit core, hardware-based verification platform, and a processor.

6. The method of claim 1, further comprising:
generating one or more inputs from the expected inputs, the values, and the position information of the values; and
executing the at least one remaining local simulation using the one or more inputs.

7. The method of claim 1, wherein generating the at least one actual output comprises generating the at least one actual output based on expected inputs used in a run-with-expected input/output mode or actual inputs used in a run-with-actual input/output mode.

8. The method of claim 7, further comprising switching the current local simulation to the run-with-actual input/output mode using the actual inputs in response to the difference being determined while the current local simulation is executed in the run-with-expected input/output mode using the expected inputs.

9. The method of claim 8, further comprising rolling back the current local simulation to a specific rollback time in response to the specific rollback time for rollback being received.

10. The method of claim 7, further comprising:
detecting a number of matches between the expected inputs and the actual inputs while the current local simulation executes in the run-with-actual input/output mode using the actual inputs; and
switching the current local simulation to the run-with-expected input/output mode using the expected inputs based on a result generated in response to detecting the number of matches.

11. The method of claim 1, further comprising transmitting a current simulation time for rollback from the current local simulation to the at least one remaining local simulation among the plurality of local simulations in response to a mismatch between the expected outputs and the actual outputs.

12. A non-transitory computer readable recording medium for recording a computer program for executing the distributed parallel simulation method of claim 1.

13. A distributed parallel simulation method, comprising:
executing a plurality of local simulations in parallel for a plurality of local design objects, respectively, wherein the local design objects are included in a model at a specific abstraction level and are spatially distributed;
saving a first output generated at a first simulation time in a current local simulation of at least one of the local design objects among the plurality of local simulations;
comparing the first output with a second output generated at a second simulation time following the first simulation time in the current local simulation; and
transmitting values of the second output and position information of the values from the current local simulation to at least one remaining local simulation among the plurality of local simulations in response to a determination of a mismatch between the first output and the second output.

14. The method of claim 13, wherein the local simulations are performed by a plurality of design verification apparatuses, respectively, connected to each other through a network.

15. The method of claim 13, further comprising:
generating an input required at the second simulation time using an input generated at the first simulation time, the values and the position information of the value in the at least one remaining local simulation; and
executing the at least one remaining local simulation using the input generated for the second simulation time.

16. A non-transitory computer readable recording medium for recording a computer program for executing the distributed parallel simulation method of claim 13.

17. A distributed parallel simulation method, comprising:
generating an actual output using a local design object in a current local simulation of a plurality of local simulations;
comparing an expected output with the actual output;
determining a mismatch between the actual output and the expected output; and
transmitting one or more values of the actual output and position information of the one or more values from the current local simulation to a remaining local simulation of the plurality of local simulations in response to the determination of the mismatch.

18. The method of claim 17, wherein the local design object is included in a model at a specific abstraction level.

19. The method of claim 17, further comprising performing the local simulations by a plurality of design verification apparatuses connected to each other through a network.

20. The method of claim 17, further comprising:
generating one or more inputs from at least one of the expected input, the one or more values, and the position information of the one or more values; and
executing the remaining local simulation using the one or more inputs.

21. The method of claim 17, wherein generating the actual output comprises generating the actual output based on expected inputs used in a run-with-expected input/output mode or actual inputs used in a run-with-actual input/output mode.

22. The method of claim 17, further comprising:
detecting a number of matches between the expected input and the actual input while the current local simulation executes in a run-with-actual input/output mode using the actual input; and
switching the current local simulation to a run-with-expected input/output mode using the expected input based on a result generated in response to detecting the number of matches.
